(19) United States
(12) Patent Application Publication
(10) Pub. No.: US 2026/0040123 A1
(43) Pub. Date: Feb. 5, 2026

(54) SIGNALING FOR UE REPORTING OF CHANNEL MEASUREMENTS

(71) Applicant: Samsung Electronics Co., Ltd., Suwon-si (KR)

(72) Inventors: Emad Nader Farag, Flanders, NJ (US); Eko Onggosanusi, Coppell, TX (US); Gilwon Lee, Prosper, TX (US); Md. Saifur Rahman, Plano, TX (US); Dalin Zhu, Allen, TX (US)

(21) Appl. No.: 19/263,387

(22) Filed: Jul. 8, 2025

Related U.S. Application Data
(60) Provisional application No. 63/678,344, filed on Aug. 1, 2024.
(60) Provisional application No. 63/715,457, filed on Nov. 1, 2024.

(51) Int. Cl. H04W 24/10

(52) U.S. Cl. CPC H04W 24/10

(57) ABSTRACT

Methods and apparatuses for signaling for user equipment (UE) reporting of channel measurements. A method of operating a UE includes receiving a configuration related to a channel state information reference signal (CSI-RS) and a first measurement report and measuring the CSI-RS across N sub-bands, where N is a positive integer. The method further includes identifying one or more layers for communication and determining the first measurement report. The first measurement report includes at least one entry. An entry in the at least one entry includes a layer index corresponding to a first reference signal received power (RSRP), a first set of sub-bands corresponding to the first RSRP, and the first RSRP. The method further includes transmitting the first measurement report.

### CROSS-REFERENCE TO RELATED AND CLAIM OF PRIORITY

The present application claims priority under 35 U.S.C. § 119(e) to U.S. Provisional Patent Application No. 63/678,344 filed on Aug. 1, 2024 and U.S. Provisional Patent Application No. 63/715,457 filed on Nov. 1, 2024, which are hereby incorporated by reference in their entirety.

### TECHNICAL FIELD

The present disclosure relates generally to wireless communication systems and, more specifically, the present disclosure relates to methods and apparatuses for signaling for user equipment (UE) reporting of channel measurements.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to signaling for UE reporting of channel measurements.

In one embodiment, a UE is provided. The UE includes a transceiver configured to receive a configuration related to a channel state information reference signal (CSI-RS) and a first measurement report. The UE further includes a processor operably coupled to the transceiver. The processor is configured to measure the CSI-RS across N sub-bands, where N is a positive integer, identify one or more layers for communication, and determine the first measurement report. The first measurement report includes at least one entry. An entry in the at least one entry includes a layer index corresponding to a first reference signal received power (RSRP), a first set of sub-bands corresponding to the first RSRP, and the first RSRP. The transceiver is further configured to transmit the first measurement report.

In another embodiment, a base station (BS) is provided. The BS includes a processor; and a transceiver operably coupled to the transceiver. The transceiver is configured to transmit a configuration related to a CSI-RS and a first measurement report and receive the first measurement report. The first measurement report includes at least one entry based on measurement of CSI-RS across N sub-bands, where N is a positive integer. An entry in the at least one entry includes a layer index corresponding to a RSRP, a first set of sub-bands corresponding to the first RSRP, and the first RSRP.

In yet another embodiment, a method of operating a UE is provided. The method includes receiving a configuration related to a CSI-RS and a first measurement report and measuring the CSI-RS across N sub-bands, where N is a positive integer. The method further includes identifying one or more layers for communication and determining the first measurement report. The first measurement report includes at least one entry. An entry in the at least one entry includes a layer index corresponding to a first RSRP, a first set of sub-bands corresponding to the first RSRP and the first RSRP. The method further includes transmitting the first measurement report.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example UE according to embodiments of the present disclosure;

FIGS. 4A and 4B illustrate an example of a wireless transmit and receive paths according to embodiments of the present disclosure;

FIG. 5A illustrates an example of a wireless system according to embodiments of the present disclosure;

FIG. 5B illustrates an example of a multi-beam operation according to embodiments of the present disclosure;

FIG. 6 illustrates an example of a transmitter structure for beamforming according to embodiments of the present disclosure;

FIG. 7 illustrates a diagram of an example synchronization signal/physical broadcast channel (SS/PBCH) block according to embodiments of the present disclosure;

FIG. 8A illustrates a flowchart of an example contention based random access (CBRA) procedure according to embodiments of the present disclosure;

FIG. 8B illustrates a flowchart of an example contention free random access (CFRA) procedure according to embodiments of the present disclosure;

FIG. 9A illustrates a flowchart of an example CBRA procedure according to embodiments of the present disclosure;

FIG. 9B illustrates a flowchart of an example CFRA procedure according to embodiments of the present disclosure;

FIG. 10 illustrates an example one transmit antenna two receive antennas (1T2R) UE according to embodiments of the present disclosure;

FIG. 11 illustrates an example two transmit antenna and two receive antennas (2T2R) UE according to embodiments of the present disclosure;

FIG. 12 illustrates an example wireless system according to embodiments of the present disclosure;

FIG. 13 illustrates a signal flow of an example procedure for measurement and reporting for UE calibration according to embodiments of the present disclosure;

FIG. 14 illustrates a signal flow of an example procedure for measurement and reporting for UE calibration according to embodiments of the present disclosure;

FIG. 15 illustrates a signal flow of an example procedure for measurement and reporting for UE calibration according to embodiments of the present disclosure;

FIG. 16 illustrates a signal flow of an example procedure for measurement and reporting for UE calibration according to embodiments of the present disclosure;

FIG. 17 illustrates a signal flow of an example procedure for measurement and reporting for UE calibration according to embodiments of the present disclosure;

FIG. 18 illustrates a signal flow of an example procedure for measurement and reporting for UE calibration according to embodiments of the present disclosure;

FIG. 19 illustrates example transmission occasion measurements according to embodiments of the present disclosure;

FIG. 20 illustrates example transmissions of first and second signals according to embodiments of the present disclosure;

FIG. 21 illustrates an example timeline for transmissions of first and second signals according to embodiments of the present disclosure;

FIG. 22 illustrates example transmissions of second signals according to embodiments of the present disclosure;

FIG. 23 illustrates a signal flow of an example procedure for UL transmission according to embodiments of the present disclosure;

FIG. 24 illustrates a signal flow of an example procedure for UL transmission according to embodiments of the present disclosure;

FIG. 25 illustrates a flow diagram of an example procedure for determining sounding reference signal (SRS)/channel state information reference signal (CSI-RS) use according to embodiments of the present disclosure;

FIG. 26 illustrates a signal flow of an example procedure for UL transmission according to embodiments of the present disclosure;

FIGS. 27A, 27B, 27C, and 27D illustrate example two-part UE reports according to embodiments of the present disclosure;

FIGS. 28A, 28B, 28C, and 28D illustrate example UE reports according to embodiments of the present disclosure;

FIGS. 29A, 29B, 29C, 29D, 29E, 29F, 29G, and 29H illustrate example UE reports according to embodiments of the present disclosure;

FIG. 30 illustrates example spatial layers and sub-bands according to embodiments of the present disclosure;

FIGS. 31A and 31B illustrate example entries according to embodiments of the present disclosure;

FIGS. 32A and 32B illustrate diagrams of example entries according to embodiments of the present disclosure;

FIG. 33 illustrates a timeline for UL transmission(s) according to embodiments of the present disclosure;

FIG. 34 illustrates a timeline for UL transmission(s) according to embodiments of the present disclosure;

FIG. 35 illustrates example resource periodicities according to embodiments of the present disclosure;

FIG. 36 illustrates example resource periodicities according to embodiments of the present disclosure;

FIG. 37 illustrates a timeline for UL transmission(s) according to embodiments of the present disclosure;

FIG. 38 illustrates a timeline for UL transmission(s) according to embodiments of the present disclosure;

FIG. 39 illustrates an example UE report according to embodiments of the present disclosure;

FIG. 40 illustrates an example two-part UE report according to embodiments of the present disclosure; and

FIG. 41 illustrates an example two-part UE report according to embodiments of the present disclosure.

### DETAILED DESCRIPTION

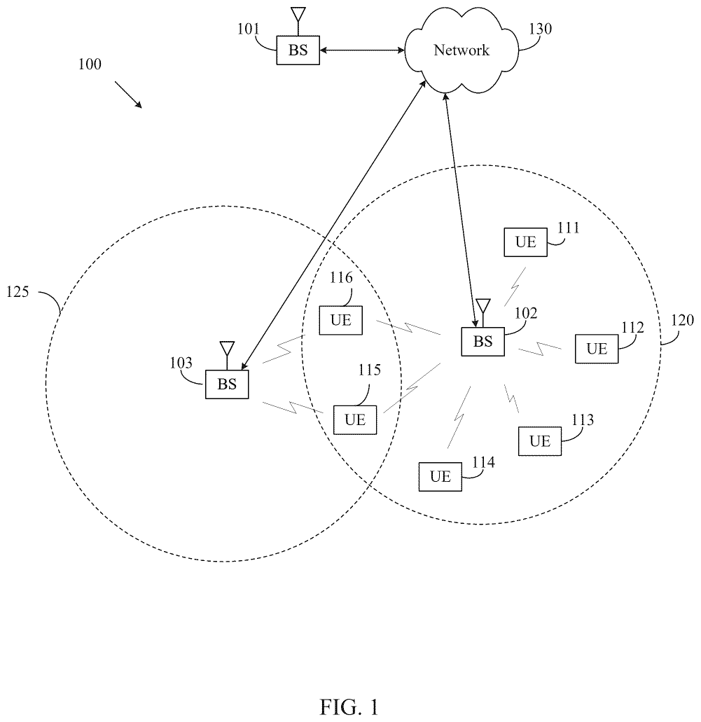

FIGS. 1-41, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: [REF 1] 3GPP TS 38.211 v18.3.0-v18.4.0, “NR; Physical channels and modulation;” [REF 2] 3GPP TS 38.212 v18.3.0-v18.4.0, “NR; Multiplexing and Channel coding;” [REF 3] 3GPP TS 38.213 v18.3.0-v18.4.0, “NR; Physical Layer Procedures for Control;” [REF 4] 3GPP TS 38.214 v18.3.0-v18.4.0, “NR; Physical Layer Procedures for Data;” [REF 5] 3GPP TS 38.321 v18.2.0-v18.3.0, “NR; Medium Access Control (MAC) protocol specification;” and [REF 6] 3GPP TS 38.331 v18.2.0-v18.3.0, “NR; Radio Resource Control (RRC) Protocol Specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103 (collectively forming a BS system). The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for receiving/transmitting signaling for UE antenna calibration and reporting of channel measurements. In certain embodiments, one or more of the gNBs 101-103 include circuitry, programing, or a combination thereof to transmit/receive signaling for UE antenna calibration and reporting of channel measurements.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

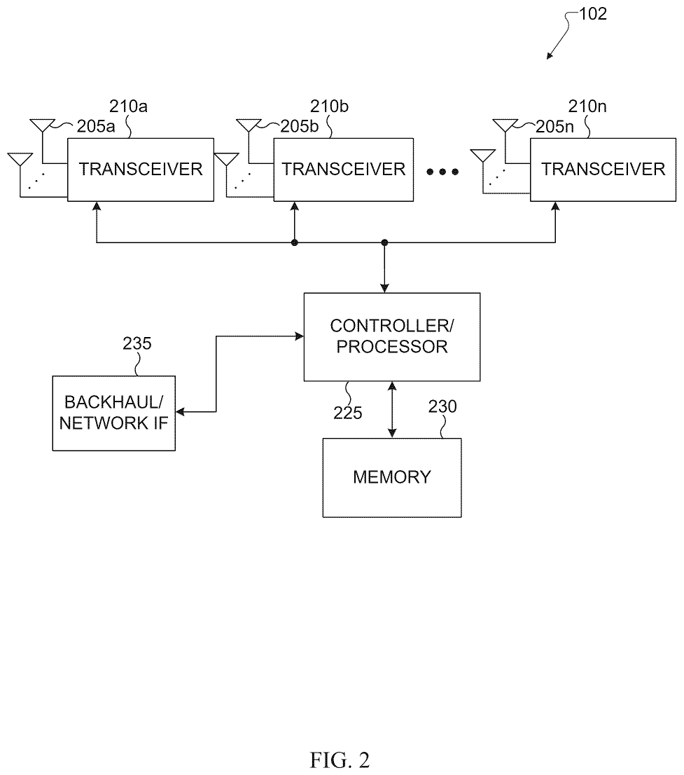

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-convert the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channels or signals and the transmission of downlink (DL) channels or signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as supporting signaling for UE antenna calibration and reporting of channel measurements. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The backhaul or network interface 235 could support communications over any suitable wired or wireless connection(s). For example, when the gNB 102 is implemented as part of a cellular communication system (such as one supporting 5G/NR, LTE, or LTE-A), the backhaul or network interface 235 could allow the gNB 102 to communicate with other gNBs over a wired or wireless backhaul connection. When the gNB 102 is implemented as an access point, the backhaul or network interface 235 could allow the gNB 102 to communicate over a wired or wireless local area network or over a wired or wireless connection to a larger network (such as the Internet). The backhaul or network interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

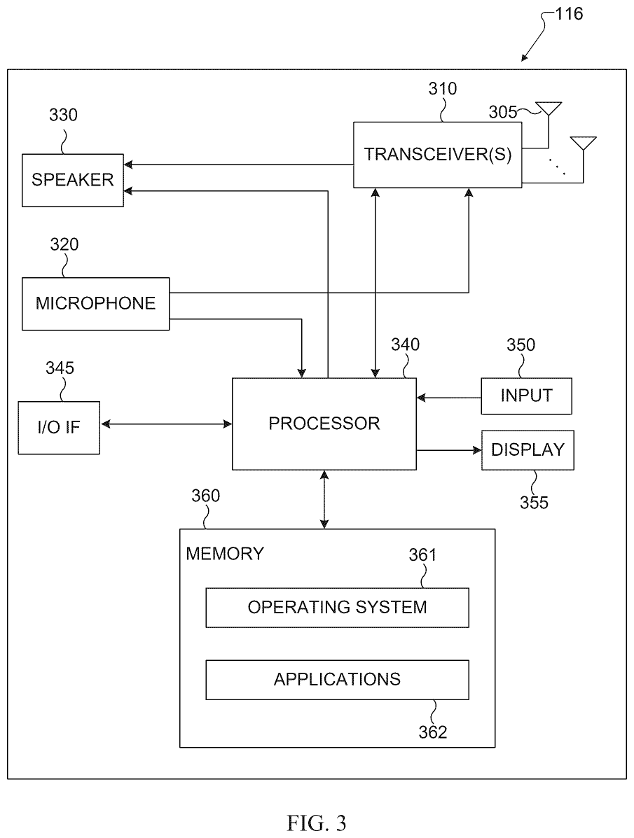

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channels or signals and the transmission of UL channels or signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes to utilize and/or identify signaling for UE antenna calibration and reporting of channel measurements as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

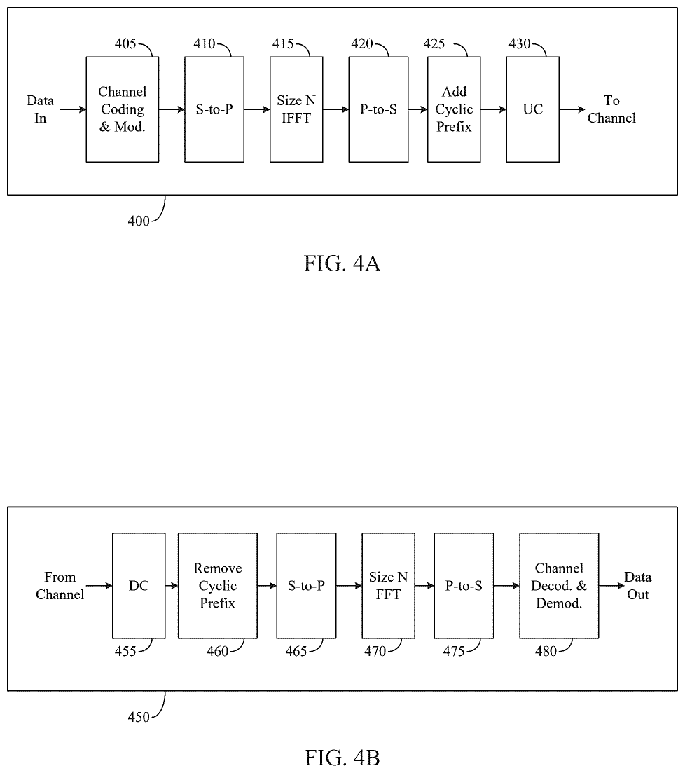

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 and/or the receive path 450 is configured to perform actions for signaling for UE antenna calibration and reporting of channel measurements as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

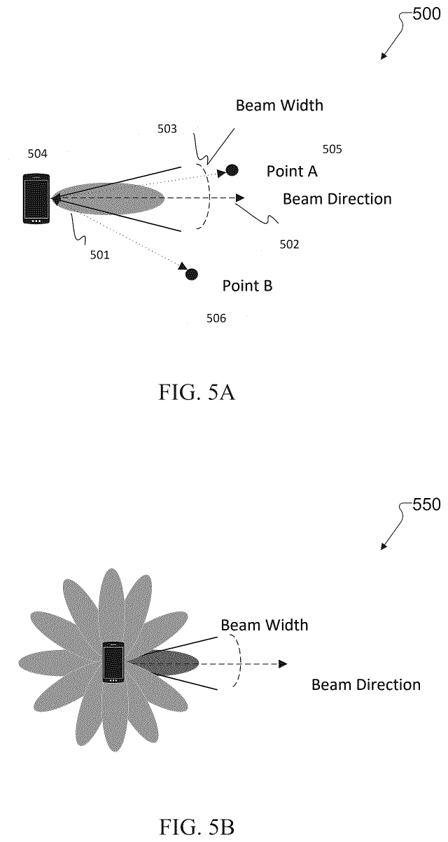

As illustrated in FIG. 5A, in a wireless system 500, a beam 501 for a device 504 can be characterized by a beam direction 502 and a beam width 503. For example, the device 504 (or UE 116) transmits RF energy in a beam direction 502 and within a beam width 503. The device 504 receives RF energy in a beam direction 502 and within a beam width 503. As illustrated in FIG. 5A, a device at point A 505 can receive from and transmit to device 504 as Point A is within a beam width and direction of a beam from device 504. As illustrated in FIG. 5A, a device at point B 506 cannot receive from and transmit to device 504 as Point B 506 is outside a beam width and direction of a beam from device 504. While FIG. 5A, for illustrative purposes, shows a beam in 2-dimensions (2D), it should be apparent to those skilled in the art, that a beam can be in 3-dimensions (3D), where the beam direction and beam width are defined in space.

FIG. 5B illustrates an example of a multi-beam operation 550 according to embodiments of the present disclosure. For example, the multi-beam operation 550 can be utilized by UE 116 of FIG. 3. This example is for illustration only and other embodiments can be used without departing from the scope of the present disclosure.

In a wireless system, a device can transmit and/or receive on multiple beams. This is known as “multi-beam operation”. While in FIG. 5B, for illustrative purposes, a beam is in 2D, it should be apparent to those skilled in the art that a beam can be 3D, where a beam can be transmitted to or received from any direction in space.

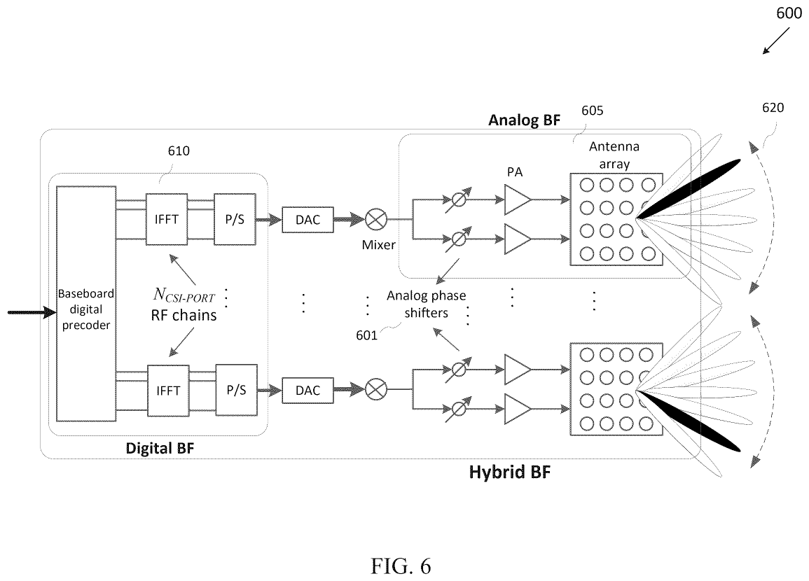

FIG. 6 illustrates an example of a transmitter structure 600 for beamforming according to embodiments of the present disclosure. In certain embodiments, one or more of gNB 102 or UE 116 includes the transmitter structure 600. For example, one or more of antenna 205 and its associated systems or antenna 305 and its associated systems can be included in transmitter structure 600. This example is for illustration only, and other embodiments can be used without departing from the scope of the present disclosure.

Accordingly, embodiments of the present disclosure recognize that Rel-14 LTE and Rel-15 NR support up to 32 channel state information reference signal (CSI-RS) antenna ports which enable an eNB or a gNB to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 6. Then, one CSI-RS port can be mapped onto a large number of antenna elements that can be controlled by a bank of analog phase shifters 601. One CSI-RS port can then correspond to one sub-array which produces a narrow analog beam through analog beamforming 605. This analog beam can be configured to sweep across a wider range of angles 620 by varying the phase shifter bank across symbols or slots/subframes. The number of sub-arrays (equal to the number of RF chains) is the same as the number of CSI-RS ports N_{CSI-PORT}. A digital beamforming unit 610 performs a linear combination across N_{CSI-PORT} analog beams to further increase a precoding gain. While analog beams are wideband (hence not frequency-selective), digital precoding can be varied across frequency sub-bands or resource blocks. Receiver operation can be conceived analogously.

Since the transmitter structure 600 of FIG. 6 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for purposes of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 6 is also applicable to higher frequency bands such as >52.6 GHz. In this case, the system can employ only analog beams. Due to the O₂ absorption loss around 60 GHz frequency (˜10 dB additional loss per 100 m distance), a larger number and narrower analog beams (hence a larger number of radiators in the array) are needed to compensate for the additional path loss.

A time unit for DL signaling, for UL signaling, or for SL signaling on a cell is one symbol. A symbol belongs to a slot that includes a number of symbols such as 14 symbols. A slot can also be used as a time unit. A bandwidth (BW) unit is referred to as a resource block (RB). One RB includes a number of sub-carriers (SCs). For example, a slot can have duration of one millisecond and an RB can have a bandwidth of 180 kHz and include 12 SCs with inter-SC spacing of 15 kHz. As another example, a slot can have a duration of 0.25 milliseconds and include 14 symbols, and an RB can have a BW of 720 kHz and include 12 SCs with SC spacing of 60 kHz. An RB in one symbol of a slot is referred to as physical RB (PRB) and includes a number of resource elements (REs). A slot can be either full DL slot, full UL slot, or hybrid slot similar to a special subframe in time division duplex (TDD) systems (see also REF 1). In addition, a slot can have symbols for SL communications. A UE can be configured one or more bandwidth parts (BWPs) of a system BW for transmissions or receptions of signals or channels.

DL signals include data signals conveying information content, control signals conveying DL control information (DCI), and reference signals (RS) that are also known as pilot signals. A gNB transmits data information or DCI through respective physical DL shared channels (PDSCHs) or physical DL control channels (PDCCHs). A PDSCH or a PDCCH can be transmitted over a variable number of slot symbols including one slot symbol. For brevity, a DCI format scheduling a PDSCH reception by a UE is referred to as a DL DCI format and a DCI format scheduling a physical uplink shared channel (PUSCH) transmission from a UE is referred to as an UL DCI format. A DCI format scheduling PDSCH reception or PUSCH transmission for a single UE, such as a DCI format with cyclic redundancy check (CRC) scrambled by cell-radio network temporary identifier (C-RNTI)/configured scheduling RNTI (CS-RNTI)/modulation and coding scheme (MCS)-C-RNTI as described in [REF 2], are referred for brevity as a unicast DCI format. A DCI format scheduling PDSCH reception for multicast communication, such as a DCI format with CRC scrambled by group RNTI (G-RNTI)/G-CS-RNTI as described in [REF 2], are referred to as multicast DCI format. DCI formats providing various control information to at least a subset of UEs in a serving cell, such as DCI format 2_0 in [REF 2], are referred to as group-common (GC) DCI formats.

A UE can be indicated a spatial setting for a PDCCH reception based on a configuration of a value for a transmission configuration indication state (TCI state) of a control resource set (CORESET) where the UE receives the PDCCH. The UE can be indicated a spatial setting for a PDSCH reception based on a configuration by higher layers or based on an indication by a DCI format scheduling the PDSCH reception of a value for a TCI state. The gNB can configure the UE to receive signals on a cell within a DL bandwidth part (BWP) of the cell DL BW.

A gNB (such as BS 102) transmits one or more of multiple types of RS including channel state information RS (CSI-RS) and demodulation RS (DMRS). A CSI-RS is primarily intended for UEs to perform measurements and provide channel state information (CSI) to a gNB. For channel measurement, non-zero power CSI-RS (NZP CSI-RS) resources are used. For interference measurement reports (IMRs), CSI interference measurement (CSI-IM) resources associated with a zero power CSI-RS (ZP CSI-RS) configuration are used. A CSI process includes NZP CSI-RS and CSI-IM resources. A UE (such as UE 116) can determine CSI-RS transmission parameters through DL control signaling or higher layer signaling, such as radio resource control (RRC) signaling from a gNB. Transmission instances of a CSI-RS can be indicated by DL control signaling or configured by higher layer signaling. A DMRS is transmitted only in the BW of a respective PDCCH or PDSCH and a UE can use the DMRS to demodulate data or control information.

UL signals also include data signals conveying information content, control signals conveying UL control information (UCI), DMRS associated with data or UCI demodulation, sounding RS (SRS) enabling a gNB to perform UL channel measurement, and a random access (RA) preamble enabling a UE to perform random access. A UE transmits data information or UCI through a respective physical UL shared channel (PUSCH) or a physical UL control channel (PUCCH). A PUSCH or a PUCCH can be transmitted over a variable number of slot symbols including one slot symbol. The gNB can configure the UE to transmit signals on a cell within an UL BWP of the cell UL BW.

UCI includes hybrid automatic repeat request acknowledgement (HARQ-ACK) information, indicating correct or incorrect detection of data transport blocks (TBs) in a PDSCH, scheduling request (SR) indicating whether a UE has data in the buffer of UE, link recovery request (LRR) for beam failure recovery, CSI reports enabling a gNB to select appropriate parameters for PDSCH or PDCCH transmissions to a UE, and UE initiated resource indicator (UEI-RI) indicating a request to transmit a UE initiated measurement report. HARQ-ACK information can be configured to be with a smaller granularity than per TB and can be per data code block (CB) or per group of data CBs where a data TB includes a number of data.

A CSI report from a UE can include a channel quality indicator (CQI) informing a gNB of a largest modulation and coding scheme (MCS) for the UE to detect a data TB with a predetermined block error rate (BLER), such as a 10% BLER, of a precoding matrix indicator (PMI) informing a gNB how to combine signals from multiple transmitter antennas in accordance with a multiple input multiple output (MIMO) transmission principle, and of a rank indicator (RI) indicating a transmission rank for a PDSCH. UL RS includes DMRS and SRS. DMRS is transmitted only in a BW of a respective PUSCH or PUCCH transmission. A gNB can use a DMRS to demodulate information in a respective PUSCH or PUCCH. SRS is transmitted by a UE to provide a gNB with an UL CSI and, for a TDD system, an SRS transmission can also provide a PMI for DL transmission. Additionally, in order to establish synchronization or an initial higher layer connection with a gNB, a UE can transmit a physical random-access channel (PRACH).

An antenna port is defined such that the channel over which a symbol on the antenna port is conveyed can be inferred from the channel over which another symbol on the same antenna port is conveyed.

For demodulation reference signal (DM-RS) associated with a PDSCH, the channel over which a PDSCH symbol on one antenna port is conveyed can be inferred from the channel over which a DM-RS symbol on the same antenna port is conveyed only if the two symbols are within the same resource as the scheduled PDSCH, in the same slot, and in the same precoding resource block group (PRG).

For DM-RS associated with a PDCCH, the channel over which a PDCCH symbol on one antenna port is conveyed can be inferred from the channel over which a DM-RS symbol on the same antenna port is conveyed only if the two symbols are within resources for which the UE may expect the same precoding being used.

For DM-RS associated with a physical broadcast channel (PBCH), the channel over which a PBCH symbol on one antenna port is conveyed can be inferred from the channel over which a DM-RS symbol on the same antenna port is conveyed only if the two symbols are within a SS/PBCH block transmitted within the same slot, and with the same block index.

Two antenna ports are said to be quasi co-located if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and spatial Rx parameters.

The UE (such as the UE 116) may expect that synchronization signal (SS)/PBCH block (also denoted as synchronization signal blocks (SSBs)) transmitted with the same block index on the same center frequency location are quasi co-located with respect to Doppler spread, Doppler shift, average gain, average delay, delay spread, and, when applicable, spatial Rx parameters. The UE may not expect quasi co-location for any other synchronization signal SS/PBCH block transmissions.

In absence of CSI-RS configuration, and unless otherwise configured, the UE may expect PDSCH DM-RS and SSB to be quasi co-located with respect to Doppler shift, Doppler spread, average delay, delay spread, and, when applicable, spatial Rx parameters. The UE may expect that the PDSCH DM-RS within the same code division multiplexing (CDM) group is quasi co-located with respect to Doppler shift, Doppler spread, average delay, delay spread, and spatial Rx. The UE may also expect that DM-RS ports associated with a PDSCH are quasi co-location (QCL) with QCL type A, type D (when applicable) and average gain. The UE may further expect that no DM-RS collides with the SS/PBCH block.

The UE can be configured with a list of up to M transmission configuration indication (TCI) State configurations within the higher layer parameter PDSCH-Config to decode PDSCH according to a detected PDCCH with DCI intended for the UE and the given serving cell, where M depends on the UE capability maxNumberConfiguredTCIstatesPerCC. Each TCI-State contains parameters for configuring a quasi-colocation (QCL) relationship between one or two downlink reference signals and the DM-RS ports of the PDSCH, the DM-RS port of PDCCH or the CSI-RS port(s) of a CSI-RS resource.

The quasi-co-location relationship is configured by the higher layer parameter qcl-Type1 for the first DL RS, and qcl-Type2 for the second DL RS (if configured). For the case of two DL RSs, the QCL types may not be the same, regardless of whether the references are to the same DL RS or different DL RSs. The quasi-co-location types corresponding to each DL RS are given by the higher layer parameter qcl-Type in QCL-Info and may take one of the following values: QCL-TypeA: {Doppler shift, Doppler spread, average delay, delay spread}; QCL-TypeB: {Doppler shift, Doppler spread}; QCL-TypeC: {Doppler shift, average delay}; and QCL-TypeD: {Spatial Rx parameter}.

The UE receives a MAC-control element (CE) activation command to map up to [N] (e.g., N=8) TCI states to the codepoints of the DCI field “Transmission Configuration Indication.” When the HARQ-ACK corresponding to the PDSCH carrying the activation command is transmitted in slot n, the indicated mapping between TCI states and codepoints of the DCI field “Transmission Configuration Indication” may be applied after a MAC-CE application time, e.g., starting from the first slot that is after slot

$$( n + 3 {N}_{slot}^{subframe , μ} ) .$$

In this disclosure, a beam can be determined by any of;
A TCI state, that establishes a quasi-colocation (QCL) relationship or spatial relation between a source reference signal (e.g. SSB and/or CSI-RS) and a target reference signal
A spatial relation information that establishes an association to a source reference signal, such as SSB or CSI-RS or SRS.

In either case, the ID of the source reference signal or TCI state or spatial relation identifies the beam.

The TCI state and/or the spatial relation reference RS can determine a spatial Rx filter for reception of downlink channels at the UE, or a spatial Tx filter for transmission of uplink channels from the UE. The TCI state and/or the spatial relation reference RS can determine a spatial Tx filter for transmission of downlink channels from the gNB, or a spatial Rx filter for reception of uplink channels at the gNB.

Rel-17 introduced the unified TCI framework, where a unified or master or main or indicated TCI state is signaled to the UE. The unified or master or main or indicated TCI state can be one of:
1. In case of joint TCI state indication, wherein a same beam is used for DL and UL channels, a joint TCI state that can be used at least for UE-dedicated DL channels and UE-dedicated UL channels.
2. In case of separate TCI state indication, wherein different beams are used for DL and UL channels, a DL TCI state that can be used at least for UE-dedicated DL channels.
3. In case of separate TCI state indication, wherein different beams are used for DL and UL channels, a UL TCI state that can be used at least for UE-dedicated UL channels.

The unified (master or main or indicated) TCI state is TCI state of UE-dedicated reception on PDSCH/PDCCH or dynamic-grant/configured-grant based PUSCH and dedicated PUCCH resources.

The unified TCI framework applies to intra-cell beam management, wherein, the TCI states have a source RS that is directly or indirectly associated, through a quasi-co-location relation, e.g., spatial relation, with an SSB of a serving cell (e.g., the TCI state is associated with a TRP of a serving cell). The unified TCI state framework also applies to inter-cell beam management, wherein a TCI state can have a source RS that is directly or indirectly associated, through a quasi-co-location relation, e.g., spatial relation, with an SSB of cell that has a physical cell identity (PCI) different from the PCI of the serving cell (e.g., the TCI state can be associated with a TRP of a cell having a PCI different from the PCI of the serving cell).

Quasi-co-location (QCL) relation, can be quasi-location with respect to one or more of the following relations [[REF 4]-section 5.1.5]:
Type A, {Doppler shift, Doppler spread, average delay, delay spread}
Type B, {Doppler shift, Doppler spread}
Type C, {Doppler shift, average delay}
Type D, {Spatial Rx parameter}

In addition, quasi-co-location relation and source reference signal can also provide a spatial relation for UL channels, e.g., a DL source reference signal provides information on the spatial domain filter to be used for UL transmissions, or the UL source reference signal provides the spatial domain filter to be used for UL transmissions, e.g., same spatial domain filter for UL source reference signal and UL transmissions.

The unified (master or main or indicated) TCI state applies at least to UE dedicated DL and UL channels. The unified (master or main or indicated) TCI can also apply to other DL and/or UL channels and/or signals e.g. non-UE dedicated channel and sounding reference signal (SRS).

A UE is indicated a TCI state by MAC CE when the MAC CE activates one TCI state code point. The UE applies the TCI state code point after a beam application time from the corresponding HARQ-ACK feedback. A UE is indicated a TCI state by a DL related DCI format (e.g., DCI Format 1_1, or DCI format 1_2), wherein the DCI format includes a “transmission configuration indication” field that includes a TCI state code point out of the TCI state code points activated by a MAC CE. A DL related DCI format can be used to indicate a TCI state when the UE is activated with more than one TCI state code points. The DL related DCI format can be with a DL assignment for PDSCH reception or without a DL assignment. A TCI state can also be indicated in a purpose designed channel or DCI Format for TCI state indication. A TCI state (TCI state code point) indicated in a DL related DCI format or purpose design channel or DCI Format for TCI state indication is applied after a beam application time from the corresponding HARQ-ACK feedback.

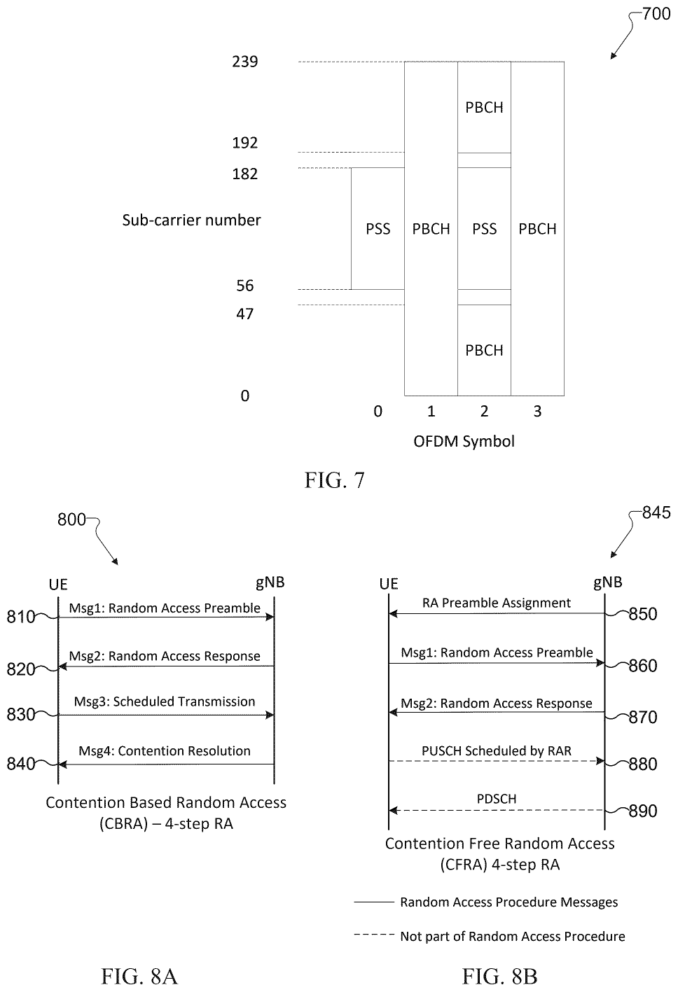

FIG. 7 illustrates a diagram of an example SS/PBCH block 700 according to embodiments of the present disclosure. For example, SS/PBCH block 700 can be utilized by any of the UEs 111-116 of FIG. 1. This example is for illustration only and other embodiments can be used without departing from the scope of the present disclosure.

In 5G/NR, a UE performs the cell search procedure to acquire time and frequency synchronization with a cell and to detect the physical layer Cell ID of the cell. To perform cell search, the UE receives the following signals and channel: (1) the primary synchronization signal (PSS), (2) the secondary synchronization signal (SSS) and (3) the physical broadcast channel (PBCH). A PSS/SSS/PBCH block (SS/PBCH block) is referred to as SSB and includes 4 consecutive symbols, and 20 resource blocks (RBs) (240 subcarriers), as illustrated in FIG. 7.

SSBs are organized in groups or bursts of N SSBs, transmitted within half a frame, each SSB within the group or burst has an index i, where i=0, 1, . . . , N−1, within each group of SSBs, the SSBs are time-division multiplexed and arranged in increasing order of i, with increasing time. For carrier frequencies less than or equal to 3 GHz, N=4. For carrier frequencies in FR1 that are larger than 3 GHz, N=8. For carrier frequencies in FR2, N=64. The SSB indices actually transmitted are provided by ssb-PositionsInBurst in system information block one (SIB1) or in ServingCellConfigCommon or in SSB-MTC-AdditionalPCI or in LIM-SSB-Config.

SSBs are transmitted periodically, where the allowed periodicities are {5, 10, 20, 40, 80, 160} ms. In addition to cell search, SSBs can also be used for beam management related procedures, such as new beam acquisition, beam measurements, and beam failure detection and recovery. Each SSB with index i can be associated with a spatial domain filter (or beam).

NR introduced a physical random access channel (PRACH) to be used, among other cases, when the UE wants to communicate with the network and doesn't have uplink resources. For example, the physical random access channel can be used during initial access. The PRACH includes a preamble format comprising one or more preamble sequences transmitted in a PRACH Occasion (RO).

NR supports four different preamble sequence lengths:
Sequence length 839 used with sub-carrier spacings 1.25 kHz and 5 kHz with unrestricted or restricted sets.
Sequence length 139 used with sub-carrier spacings 15 kHz, 30 kHz, 60 kHz and 120 kHz with unrestricted sets.
Sequence length 571 used with sub-carrier spacing 30 kHz with unrestricted sets.
Sequence length 1151 used with sub-carrier spacing 15 kHz with unrestricted sets.

RACH preambles are transmitted in time-frequency resources PRACH Occasions (ROs). Each RO determines the time and frequency resources in which a preamble is transmitted, the resources allocated to an RO in the frequency domain (e.g., number of RBs) and the resource allocated to an RO in the time domain (e.g., number of OFDMA symbols or number of slots), depend on the preamble sequence length, sub-carrier spacing of the preamble, sub-carrier spacing of the PUSCH in the UL BWP, and the preamble format. Multiple PRACH Occasions can be FDMed in one time instance. This is indicated by higher layer parameter msg1-FDM. The time instances of the PRACH Occasions are determined by the higher layer parameter prach-ConfigurationIndex, and Tables 6.3.3.2-2, 6.3.3.2-3, and 6.3.3.2-4 of [REF 1] v18.1.0.

SSBs are associated with ROs. The number of SSBs associated with one RO can be indicated by higher layer parameters such as ssb-perRACH-OccasionAndCB-PreamblesPerSSB and ssb-perRACH-Occasion. The number of SSBs per RO can be {⅛, ¼, ½, 1, 2, 4, 8, 16}. When the number of SSBs per RO is less than 1, multiple ROs are associated with the same SSB index. SS/PBCH block indexes provided by ssb-PositionsInBurst in SIB1 or in ServingCellConfigCommon are mapped to valid PRACH occasions in the following order [REF 3] v18.1.0:
First, in increasing order of preamble indexes within a single PRACH occasion.
Second, in increasing order of frequency resource indexes for frequency multiplexed PRACH occasions.
Third, in increasing order of time resource indexes for time multiplexed PRACH occasions within a PRACH slot.
Fourth, in increasing order of indexes for PRACH slots.

The association period starts from frame 0 for mapping SS/PBCH block indexes to PRACH Occasions.

FIG. 8A illustrates a flowchart of an example contention-based random access (CBRA) procedure 800 according to embodiments of the present disclosure. For example, CBRA procedure 800 can be performed by the UE 116 and the gNB 102 and/or network 130 in the wireless network 100 of FIG. 1. This example is for illustration only and other embodiments can be used without departing from the scope of the present disclosure.

The procedure begins in 810, a UE transmits a Msg1: random access preamble to a gNB. In 820, the gNB transmits a Msg2: random access response to the UE. In 830, the UE transmits a Msg3: scheduled transmission to the gNB. In 840, the gNB transmits Msg4: content resolution to the UE.

FIG. 8B illustrates a flowchart of an example contention-free random access (CFRA) procedure 845 according to embodiments of the present disclosure. For example, CFRA procedure 845 can be performed by the UE 116 and the gNB 103 and/or network 130 in the wireless network 100 of FIG. 1. This example is for illustration only and other embodiments can be used without departing from the scope of the present disclosure.

The procedure begins in 850, a gNB transmits a RA preamble assignment to a UE. In 860, the UE transmits a Msg1: random access preamble to the gNB. In 870, the gNB transmits a Msg2: random access response to the UE. In 880, the UE may transmit a PUSCH scheduled by random access response (RAR) to the gNB. In 890, gNB may transmit PDSCH to the UE.

A random access procedure can be initiated by a PDCCH order, by the MAC entity, or by RRC.

There are two types of random access procedures, type-1 random access procedure and type-2 random access procedure.

Type-1 random access procedure also known as four-step random access procedure (4-step RACH), is as illustrated in FIG. 8;
In step 1, the UE transmits a random access preamble, also known as Msg1, to the gNB. The gNB attempts to receive and detect the preamble.
In step 2, the gNB upon receiving the preamble transmits a random access response (RAR), also known as Msg2, to the UE including, among other fields, a time adjustment (TA) command and a RAR uplink grant for a subsequent PUSCH transmission.
In step 3, the UE after receiving the RAR, transmits a PUSCH transmission scheduled by the grant of the RAR and time adjusted according to the TA received in the RAR. Msg3 or the PUSCH scheduled by the RAR UL grant can include the RRC setup request message.
In step 4, the gNB upon receiving the RRC setup message, allocates downlink and uplink resources that are transmitted in a downlink PDSCH transmission to the UE.

After the last step, the UE can proceed with reception and transmission of data traffic.

Type-1 random access procedure (4-step RACH) can be contention based random access (CBRA) or contention free random access (CFRA). The CFRA procedure ends after the random access response, the following messages are not part of the random access procedure. For CFRA, in step 0, the gNB indicates to the UE the preamble(s) to use.

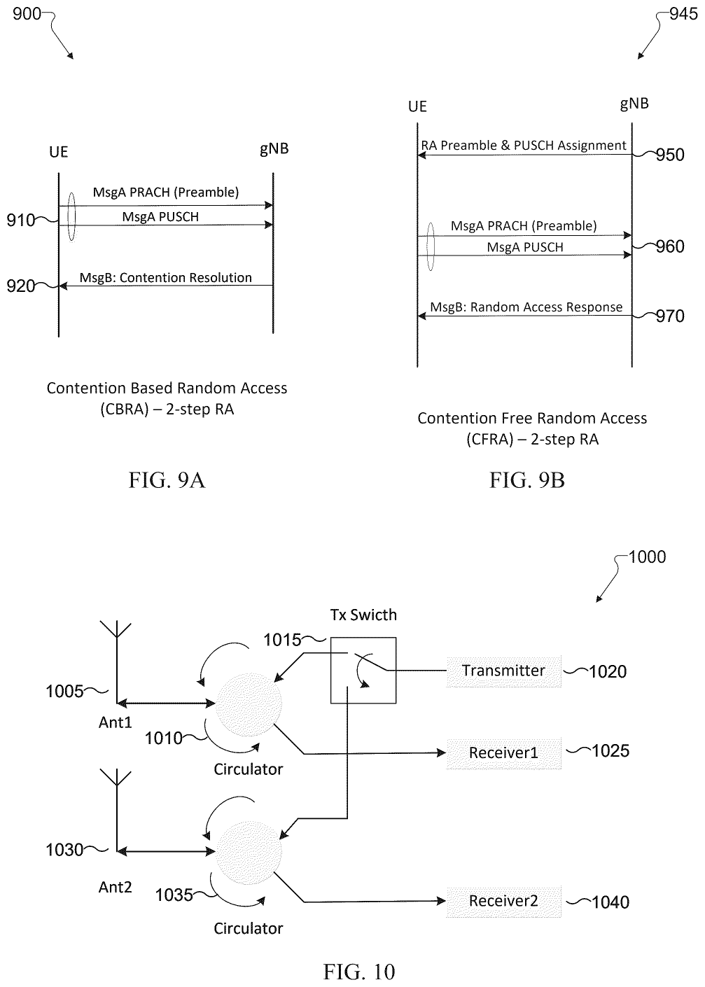

FIG. 9A illustrates a flowchart of an example CBRA procedure 900 according to embodiments of the present disclosure. For example, CBRA procedure 900 can be performed by the UE 115 and the gNB 102 and/or network 130 in the wireless network 100 of FIG. 1. This example is for illustration only and other embodiments can be used without departing from the scope of the present disclosure.

The procedure begins in 910, a UE transmits MsgA PRACH (preamble) and MsgA PUSCH to a gNB. In 920, the gNB transmits MsgB: contention resolution to the UE.

FIG. 9B illustrates a flowchart of an example CFRA procedure 945 according to embodiments of the present disclosure. For example, CFRA procedure 945 can be performed by the UE 115 and the gNB 103 and/or network 130 in the wireless network 100 of FIG. 1. This example is for illustration only and other embodiments can be used without departing from the scope of the present disclosure.

The procedure begins in 950, a gNB transmits a RA preamble and PUSCH assignment to a UE. In 960, the UE transmits MsgA PRACH (preamble) and MsgA PUSCH to the gNB. In 970, the gNB transmits MsgB: random access response to the UE.

Rel-16, introduced a new random access procedure; Type-2 random access procedure, also known as 2-step random access procedure (2-step RACH), is as illustrated in FIG. 9, that combines the preamble and PUSCH transmission into a single transmission from the UE to the gNB, which is known as MsgA. Similarly, the RAR and the PDSCH transmission (e.g. Msg4) are combined into a single downlink transmission from the gNB to the UE, which is known as MsgB.

A random access procedure can be triggered for initial access from the RRC IDLE state. During this procedure, a UE identifies an SS/PBCH block with index i and with a reference signal received power (RSRP) that exceeds a threshold. The RSRP threshold for SSB selection for RACH resource association is indicated/configured by the network. The UE selects a RO and a preamble within the RO associated with SS/PBCH block index i. The UE transmits a PRACH using the selected RO/preamble. The UE monitors and receives the random access response (RAR), by attempting to detect a DCI format 1_0 with CRC scrambled by a corresponding random access RNTI (RA-RNTI) during a window controlled by higher layers. If the UE does not detect the DCI format 1_0 with CRC scrambled by the corresponding RA-RNTI within the RAR window, the UE may retransmit PRACH. If the UE detects the DCI format 1_0 with CRC scrambled by the corresponding RA-RNTI, the UE receives a RAR UL grant for the scheduling of a PUSCH. The UE transmits the PUSCH according to the RAR UL grant. In response to the PUSCH transmission scheduled by a RAR UL grant, when a UE has not been provided a C-RNTI, the UE attempts to detect a DCI format 1_0 with CRC scrambled by a corresponding temporary cell-radio network temporary identifier (TC-RNTI) scheduling a PDSCH that includes a UE contention resolution identity. The spatial domain filters (beams) identified during initial access, are used for subsequent transmissions and receptions to/from the UE until a single TCI state is configured or activated or indicated to the UE. For downlink receptions when a UE does not have the TCI state, the spatial domain filter is that associated with the SS/PBCH block index identified during initial access. For uplink transmissions when a UE does not have the TCI state, the spatial domain filter is that used for PUSCH scheduled by the RAR UL grant.

Sounding reference signal is an uplink reference signal that is used for sounding (i.e., channel state or quality estimation) the uplink channel between the UE and the gNB. In case of reciprocity between UL and DL, the channel sounding of the uplink channel can also be used for link adaptation and precoding on the downlink channel from the gNB to the UE. SRS is transmitted independent of data transmissions on the uplink. The SRS usage can be one of: beamManagement, codebook, nonCodebook, antennaSwitching, this is in addition to SRS for positioning.

In NR SRS resources are configured by the network, for example as part of RRC setup or RRC reconfiguration. SRS resources are configured in SRS resource set. An SRS resource set includes a set of SRS resource, and defines the following parameters: (1) resourceType, which determine the time domain behavior of SRS, SRS can be aperiodic, semi-persistent or periodic. (2) usage, which can be one of: beamManagement, codebook, nonCodebook or antennaSwitching. (3) information related to power control and TCI state.

The configuration of the SRS resource includes the following: (1) information related to the transmission comb, including comb size, comb offset and cyclic shift. (2) Information related to time domain resource mapping including starting symbol within a slot, number of SRS symbols and repetition factor. (3) information related to frequency domain including freqDomainPosition N_RRC, freqDomainShift n_shift, and frequency hopping parameters c-SRS, b-SRS, and b-hop. (4) Information related to group or sequence hopping, whether one of them or neither is enabled. (5) for periodic and semi-persistent SRS, the periodicity and offset of the SRS resource. (6) Sequence ID. (7) Information related to the TCI state or spatial relation info.

In 5G NR, a UE (e.g., the UE 116) can transmit a sounding reference signal (SRS). A SRS resource is configured by higher layer IE SRS-Resource.

The SRS sequence is a low peak-to-average power ratio (PAPR) sequence of length

$${N}_{ZC} = {M}_{sc , b}^{SRS}$$

given by:

$${r}^{( p )} ( n , {l}^{′} ) = {r}_{u , v}^{( α , δ )} ( n ) = {e}^{j α n} {r}_{u , v} ( n ) , 0 \leq n < {M}_{ZC}$$

where

$${M}_{ZC} = {mN}_{sc}^{RB} / {2}^{δ} , δ = log ( {K}_{TC} ) ,$$

with K_{TC} being the transmission comb number is provided in higher layer IE transmissionComb, K_{TC}∈{2, 4, 8}. l′ is the SRS symbol within a SRS resource of a slot

$${l}^{′} ∈ \{ 0 , 1 , … , {N}_{symb}^{SRS} - 1 \} , {N}_{symb}^{SRS}$$

is the number of SRS symbols in a slot. The cyclic shift αᵢ for antenna port pᵢ is given by

$${α}_{i} = 2 π \frac{{n}_{S R S}^{cs , i}}{{n}_{S R S}^{cs , max}} , and {n}_{S R S}^{cs , i} = ( {n}_{S R S}^{c s} + \frac{{n}_{S R S}^{cs , max} ( {p}_{i} - 1000 )}{{N}_{a p}^{S R S}} ) mod {n}_{S R S}^{cs , max}$$

with

$${n}_{S R S}^{c s}$$

being provided by higher layer in IE transmissionComb,

$${n}_{S R S}^{cs , max}$$

depends on K_{TC} as illustrated in Table 1.

TABLE 1

| K_{TC} | ${n}_{SRS}^{cs , max}$ |
|---|---|
| 2 | 8 |
| 4 | 12 |
| 8 | 6 |

u is the group number u∈{0, 1, . . . , 29}, v is the base sequence number, with v∈{0}, if 6≤N_{ZC}≤60 and ∈{0, 1}, if 60<N_{ZC}. The base sequence, r̅_{u,v}(n), is generated as follows:
1. For N_{ZC}∈{6, 12, 18, 24}, r̅_{u,v}(n)=e^{jϕ(n)π/4}, with 0≤n<M_{ZC}−1. ϕ(n) is given by Tables 5.2.2.2-1 to 5.2.2.2-4 of [REF 1].
2. For N_{ZC}=30,

$${\overline{r}}_{u , v} ( n ) = {e}^{- j \frac{π ( u + 1 ) ( n + 1 ) ( n + 2 )}{31}} ,$$

with 0≤n<M_{ZC}−1.
3. For N_{ZC}≥30, r̅_{u,v}(n)=x_{q}(n mod N_{ZC}),

$${x}_{q} ( n ) = {e}^{- j \frac{π q m ( m + 1 )}{{N}_{ZC}}} .$$

N_{ZC} is the largest prime number less than

$${M}_{ZC} . q = ⌊ \overline{q} + 1 / 2 ⌋ + v \cdot {( - 1 )}^{⌊ 2 \overline{q} ⌋} . \overline{q} = {N}_{ZC} \frac{u + 1}{31} .$$

The sequence group u is given by:

$$u = ( {f}_{g h} ( {n}_{s , f}^{μ} , {l}^{′} ) + {n}_{I D}^{S R S} ) .$$

### Where

$${n}_{I D}^{S R S}$$

is provided by higher layer parameter sequenceID, with

$${n}_{I D}^{S R S}$$

∈{0, 1, . . . 65535}. Higher layer parameter groupOrSequenceHopping determines the values of u and v:
if groupOrSequenceHopping equals ‘neither’, neither group, nor sequence hopping shall be used and

$${f}_{g h} ( {n}_{s , f}^{μ} , {l}^{′} ) = 0 ,$$

and v=0.
if groupOrSequenceHopping equals ‘groupHopping’, group hopping but not sequence hopping is used and v=0, and

$${f}_{g h} ( {n}_{s , f}^{μ} , {l}^{l} ) = ( {\sum }_{m = 0}^{7} c ( 8 ( {n}_{s , f}^{μ} {N}_{s y m b}^{slot} + {l}_{0} + {l}^{′} ) + m ) \cdot {2}^{m} ) mod 30 , {N}_{s y m b}^{slot}$$

is the number of symbols in a slots, l₀ is the first SRS symbols in the slot, and c(n) a length-31 Gold sequence defined as c(n)=(x₁(n+N_{c})+x₂(n+N_{c}))mod 2, with N_{c}=1600, x₁(n+31)=(x₁(n+3)+x₁(n)mod 2, x₂(n+31)=(x₂(n+3)+x₂(n+2)+x₂(n+1)+x₂(n))mod 2, the first m-sequence is initialized with x₁(0)=1, and x₁(n)=0, for n=1 . . . 30. The second m-sequence is initialized with cᵢₙᵢₜ, where

$${c}_{i n i t} = {n}_{I D}^{S R S}$$

if groupOrSequenceHopping equals ‘sequenceHopping’, sequence hopping but not group hopping is used

$${f}_{g h} ( {n}_{s , f}^{μ} , {l}^{′} ) = 0 and$$

$$v = \{ \begin{matrix}c ( {n}_{s , f}^{μ} {N}_{s y m b}^{slot} + {l}_{0} + {l}^{′} ) & {M}_{sc , b}^{S R S} \geq 6 {N}_{sc}^{R B} \\ 0 & otherwise\end{matrix}$$

$${N}_{s y m b}^{slot}$$

is the number of symbols in a slots, l₀ is the first SRS symbols in the slot, and c(n) a the length-31 Gold sequence as previously defined.

The SRS sequence, r^{(p)}(n, l′), is mapped to resource elements

$${a}_{k , l}^{( p )}$$

within a slot, where k is the sub-carrier frequency, l is the symbol number within the slot and p is the antenna port, where for SRS there is one antenna port, given by

$${a}_{k , l}^{( p )} = {β}_{SRS} {r}^{( p )} ( {k}^{′} , {l}^{′} )$$

$$l = {l}^{′} + {l}_{0}$$

### Where,

β_{SRS} is a scaling factor,

$${k}^{′} = 0 , 1 , … , {M}_{sc , b}^{SRS} - 1 , {M}_{sc , b}^{SRS} = {m}_{SRS , b} {N}_{sc}^{RB} / {K}_{TC} , {m}_{SRS , b}$$

is provided by Table 6.4.14.3-1 of [REF 1], and l′=0, 1, . . . ,

$${N}_{symb}^{SRS} - 1 .$$

l=l′+l₀, with l₀ the first SRS symbols in the slot, where l₀∈{0, 1, . . . , 13}.

$$k = {K}_{TC} {k}^{′} + {k}_{0}^{( {p}_{i} )} ,$$

K_{TC} is the transmission comb number as previously described,

$${k}_{0}^{( p )} = {\overline{k}}_{0}^{( p )} + {\sum }_{b = 0}^{{B}_{SRS}} {K}_{TC} {M}_{sc , b}^{SRS} {n}_{b} , {\overline{k}}_{0}^{( {p}_{i} )} = {n}_{shift} {N}_{s c}^{RB} + ( {k}_{TC}^{( {p}_{i} )} + {k}_{offset}^{{l}^{′}} ) mod {K}_{TC} ,$$

$${k}_{TC}^{( {p}_{i} )} = \{ \begin{matrix}{\overline{k}}_{TC} + {K}_{TC} / 2 ) mod {K}_{TC} & if \begin{matrix}{n}_{SRS}^{cs} ∈ \{ \frac{{n}_{SRS}^{cs , max}}{2} , … , {n}_{SRS}^{cs , max} - 1 \} \\ and {N}_{ap}^{SRS} = 4\end{matrix} \\ {\overline{k}}_{TC} & otherwise\end{matrix}$$

and pᵢ∈{1001, 1003} k̅_{TC} is the transmission comb offset included within higher layer IE transmissionComb, with k̅_{TC}∈{0, 1, . . . , K_{TC}−1},

$${k}_{offset}^{{l}^{′}}$$

is a symbol dependent sub-carrier offset given by Table 2, n_{shift} is given by higher layer parameter freqDomainShift and it adjusts the frequency allocation with respect to a reference point. If

$${N}_{BWP}^{start} \leq {n}_{shift}$$

the reference point for

$${k}_{0}^{( p )}$$

is sub-carrier 0 in common resource block 0, otherwise the reference point is the lowest subcarrier of the BWP. n_{b} is a frequency positioning index. n_{b} is given by:

$${n}_{b} = ⌊ \frac{4 {n}_{RRC}}{{m}_{SRS , b}} ⌋ mod {N}_{b}$$

n_{RRC} is given by higher layer parameter freqDomainPosition, and m_{SRS,b} and N_{b} are determined by Table 6.4.14.3-1 of [REF 1] with b=BARS and the configured value of C_{SRS}.

TABLE 2

| | ${k}_{offset}^{0} , {k}_{offset}^{1} , … , {k}_{offset}^{{N}_{symb}^{SRS} - 1}$ | | | | |
|---|---|---|---|---|---|
| K_{TC} | ${N}_{symb}^{SRS} = 1$ | ${N}_{symb}^{SRS} = 2$ | ${N}_{symb}^{SRS} = 4$ | ${N}_{symb}^{SRS} = 8$ | ${N}_{symb}^{SRS} = 12$ |
| 2 | 0 | 0, 1 | 0, 1, 0, 1 | — | — |
| 4 | — | 0, 2 | 0, 2, 1, 3 | 0, 2, 1, 3, 0, 2, 1, 3 | 0, 2, 1, 3, 0, 2, 1, 3, 0, 2, 1, 3 |
| 8 | — | — | 0, 4, 2, 6 | 0, 4, 2, 6, 1, 5, 3, 7 | 0, 4, 2, 6, 1, 5, 3, 7, 0, 4, 2, 6 |

FIG. 10 illustrates an example 1T2R UE 1000 according to embodiments of the present disclosure. For example, 1T2R UE 1000 can be implemented in the wireless network 100 of FIG. 1. This example is for illustration only and can be used without departing from the scope of the present disclosure.

As shown in FIG. 10, the 1T2R UE 1000 includes a first antenna 1005, a first circulator 1010, a TX switch 1015, a transmitter 1020, a first receiver 1025, a second antenna 1030, a second circulator 1035, and a second receiver 1040.

SRS is an uplink signal transmitted by the UE and received by the gNB (e.g., the BS 102). SRS can be transmitted anywhere in the UL BWP part independent of the scheduling bandwidth of PUSCH and PUSCH. SRS is used to estimate the UL channel quality and/or state. In case of reciprocity between DL channels and UL channels, for example, in case of TDD, SRS measurements can be used to estimate the DL channel quality and/or state (e.g., DL channel state information (CSI)), by reciprocity from the uplink channel quality and/or state estimate. To use SRS for estimation of DL CSI, every receive antenna at the UE is expected to correspond to a transmit antenna at the UE that can be used to transmit the SRS in the uplink to get the channel state information for the corresponding DL channel at the receive antenna. In a typical UE, the number of transmit antennas is usually less than the number of receive antennas, there are more receive chains in the UE than transmit chains. Hence, not every antenna used for reception of DL channels is used for transmission of UL channels. For example, a UE can be 1T2R, where there are two receive chains in the DL and one transmit chain in the UL, with one SRS transmitted from one antenna, may not get the channel quality estimate corresponding to the two receive antennas.

To address this issue, 3GPP introduced a usage for SRS known as antenna-switching, whereby for the SRS the transmission path can switch between the two antennas as illustrated in FIG. 10. When the SRS is transmitted using antenna 1 (in one example, antenna 1 can be the antenna used by the UE for uplink channels and signals), it can be used to sound the uplink channel between antenna 1 and gNB and hence the corresponding DL channel between the gNB and antenna 1 by reciprocity. When SRS is switched to be transmitted using antenna 2 (in one example, only SRS can be transmitted on antenna 2), it can be used to sound the uplink channel between antenna 2 and gNB and hence the corresponding DL channel between the gNB and antenna 2 by reciprocity.

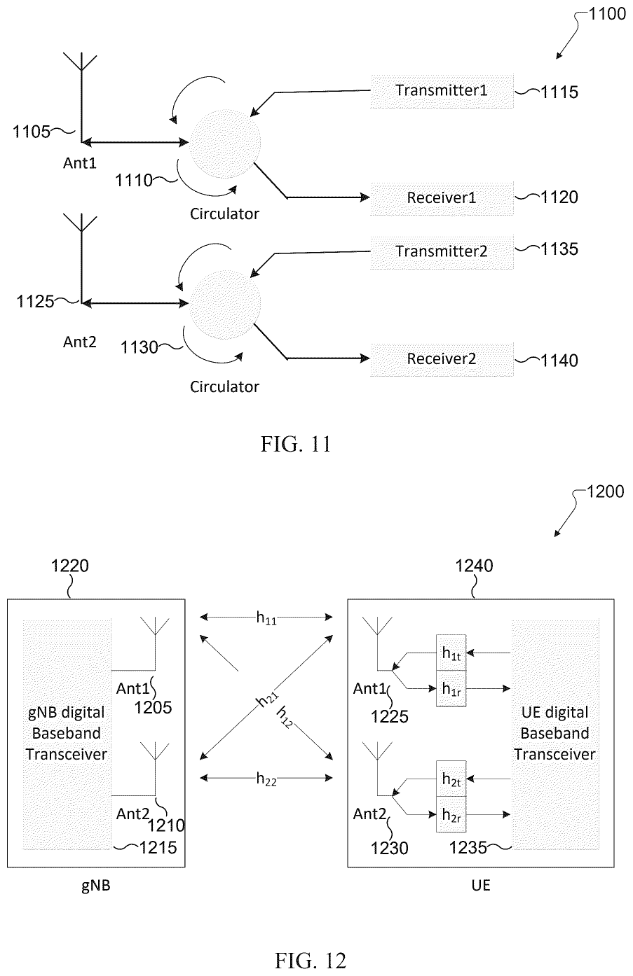

FIG. 11 illustrates an example 2T2R UE 1100 according to embodiments of the present disclosure. For example, 2T2R UE 1100 can be implemented in the wireless network 100 of FIG. 1. This example is for illustration only and can be used without departing from the scope of the present disclosure.

As shown in FIG. 11, the 2T2R UE 1100 includes a first antenna 1105, a first circulator 1110, a first transmitter 1115, a first receiver 1120, a second antenna 1125, a second circulator 1130, a second transmitter 1135, and a second receiver 1140.

Switching between antenna 1 and antenna 2 can lead to small insertion loss difference between the transmission path when connected to antenna 1 and the transmission path when connected to antenna 2. Insertion loss difference between transmission path can also occur without antenna switching, as illustrated in FIG. 11 due to variations between transmit paths and can vary over time based on the usage of the UE. Variation in insertion loss of different transmit path, when the variation is different than that of the corresponding receive path, breaks reciprocity between uplink and downlink channels, hence impacting the ability of SRS to be used for estimating the channel state information of DL channels.

In this disclosure, methods are presented to mitigate the effect of the imbalance between the UE's transmit antennas (or receive antennas) on the use of SRS to estimate the downlink channel state information. In one example, a downlink signal is transmitted from the gNB and is measured at each receive antenna of the UE, the measurement is reported back to the gNB, the gNB compares the DL measurements against the corresponding uplink measurements from SRS and determines the imbalance at the UE antennas, and applies a correction factor based on that imbalance to the SRS measurements when estimating the DL channel state information. In another example, a downlink signal is transmitted from the gNB and is measured at each receive antenna of the UE, the gNB provides corresponding SRS measurements to the UE, the UE compares the DL measurements against the corresponding uplink measurements from SRS and determines the imbalance at the UE antennas. In one example, the UE reports the imbalance to the network. In another example, future SRS transmissions are compensated to remove the effect of the imbalance. The gNB measures the compensated SRS and uses the measurement to estimate the DL channel state information based on reciprocity.

FIG. 12 illustrates an example wireless system 1200 according to embodiments of the present disclosure. For example, system 1200 can be implemented in the wireless network 100 of FIG. 1. This example is for illustration only and can be used without departing from the scope of the present disclosure.

As shown in FIG. 12, the system 1200 includes a gNB 1220 and a 2T2R UE 1240. The gNB 1220 includes a first antenna 1205, a second antenna 1210, and a digital baseband transceiver 1215. The 2T2R UE 1240 includes a first antenna 1225, a second antenna 1230, and a digital baseband transceiver 1235.

Without loss of generality, a 2T2R UE is provided with two transmit antennas and two receive antennas and receive chains. However, this can apply to a UE with any number of antennas, and different number of antennas used for reception and transmission, where SRS antenna switching can be applied to transmit SRS from a receive antenna. A mismatch can be between any pairs of antennas. For a first antenna, a first receive chain introduces a gain h₁ᵣ as illustrated in FIG. 12. For the first antenna, a first transmit chain introduces a gain h₁ₜ as illustrated in FIG. 12. For a second antenna, a second receive chain introduces a gain h₂ᵣ as illustrated in FIG. 12. For the second antenna, a second transmit chain introduces a gain h₂ₜ as illustrated in FIG. 12. If the absolute value of h₁ᵣ or h₁ₜ or h₂ᵣ or h₂ₜ is less than one, the corresponding chain introduces attenuation, while if the absolute value of h₁ᵣ or h₁ₜ or h₂ᵣ or h₂ₜ is greater than one, the corresponding chain introduces gain. If h₁ᵣ or h₁ₜ or h₂ᵣ or h₂ₜ is complex or negative, the corresponding chain introduces a phase shift between the antenna and the digital transceiver. In one example, h₁ᵣ=1 and/or h₂ᵣ=1. In one example, there is no mismatch between the receive antennas, e.g., h₁ᵣ=h₂ᵣ. In one example h₁ₜ and/or h₂ₜ are real. In one example h₁ₜ and/or h₂ₜ are real and positive. In one example h₁ᵣ and/or h₂ᵣ are real. In one example h₁ᵣ and/or h₂ᵣ are real and positive.

The over-the-air channel can be reciprocal between the antennas of the gNB and the antennas of the UE. The uplink and downlink channels between Ant1 of the gNB and Ant1 of the UE can be given by h₁₁. Similarly, the uplink and downlink channels between Ant1 of the gNB and Ant2 of the UE can be given by h₁₂, the uplink and downlink channels between Ant2 of the gNB and Ant1 of the UE can be given by h₂₁, and the uplink and downlink channels between Ant2 of the gNB and Ant2 of the UE can be given by h₂₂.

For a reference signal transmitted from the UE's digital baseband transceiver, the channel between UE's digital transceiver and the gNB's antennas for each UE antenna (uplink channels) are shown in Table 3. Similarly, the downlink channels between the gNB's antennas and the UE's digital transceiver for each UE antenna (downlink channels) are shown in Table 3. When there is a mismatch between the UE's transmit path (i.e., h₁ₜ≠h₂ₜ), or there is a mismatch between the UE's receive path (i.e., h₁ᵣ≠h₂ᵣ), or a mismatch between the transmit and receive gains, (i.e., h₁ₜ≠h₁ᵣ, and/or h₂ₜ≠h₂ᵣ) there is no reciprocity between the uplink channels and the downlink channels, and SRS can't be used to estimate the downlink channel state information.

TABLE 3

| | | Channel between UE's | Channel between gNB |
|---|---|---|---|
| gNB | UE | transceiver and gNB | antenna's and UE's |
| Antenna | Antenna | antennas (UL channel) | transceiver (DL channel) |
| Ant1 | Ant1 | h₁₁ · h₁ᵣ | h₁₁ · h₁ₜ |
| Ant1 | Ant2 | h₁₂ · h₂ᵣ | h₁₂ · h₂ₜ |
| Ant2 | Ant1 | h₂₁ · h₁ᵣ | h₂₁ · h₁ₜ |
| Ant2 | Ant2 | h₂₂ · h₂ᵣ | h₂₂ · h₂ₜ |

For antenna i of the gNB, and antenna j of the UE, the channel sounded by SRS, i.e., uplink channel between the UE's digital transceiver and the gNB antenna i for UE's antenna j is given by:

$$SRS sounded uplink channel ( i , j ) = {h}_{ij} {h}_{jt}$$

Wherein, i=0, 1, . . . , N−1, and N is the number of gNB antennas, and j=0, 1, . . . , M−1, and M is the number of UE antennas.

The downlink channel between gNB antenna i and the UE's digital transceiver for UE antenna j is given by

$$Downlink channel ( i , j ) = {h}_{ij} {h}_{jr}$$

Therefore,

$$Downlink channel ( i , j ) = SRS sound uplink channel ( i , j ) \frac{{h}_{jr}}{{h}_{jt}}$$

Therefore, by estimating the ratio

$$\frac{{h}_{jr}}{{h}_{jt}}$$

for each UE receive/transmit path j corresponding to UE antenna j, downlink channel state information can be obtained from uplink channel state information (e.g., the uplink channel state information obtained from SRS). Where, j=0, 1, . . . , M−1, and M is the number of UE antennas.

The UE transmits SRS from each UE antenna j. The gNB receives SRS on antenna i. The gNB can estimate the uplink channel between the UE's digital transceiver and gNB's antenna i, for each UE antenna j, as hᵢⱼhⱼₜ, for j=0, 1, . . . , M−1.

The gNB transmits a downlink signal from gNB antenna i, the UE receives the downlink signal at the digital transceiver through each UE antenna j, the UE can estimate the downlink channel between gNB antenna i and the UE's digital transceiver for each UE antenna j as hᵢⱼhⱼᵣ, for j=0, 1, . . . , M−1.

Embodiments of the present disclosure recognize that, by using the two measurements mentioned herein, i.e., estimate of the uplink channel between the UE's digital transceiver and gNB's antenna i, and estimate of the downlink channel between gNB antenna i and the UE's digital transceiver for each UE antenna j, the ratio

$$\frac{{h}_{jr}}{{h}_{jt}}$$

can be estimated and used for future estimation of downlink channel state information from uplink SRS measurements.

In one example of this disclosure, the gNB transmits a DL signal, and the UE performs a first measurement of the downlink signal on each UE antenna. In one example, the UE transmits uplink SRS from each UE antenna, the gNB performs a second measurement of the SRS from each UE antenna.

In one example, the UE reports the first measurement to the gNB, the gNB uses the first measurement and second measurement to determine a factor to apply to SRS measurements to obtain downlink channel state information from SRS measurements.

In one example, the gNB reports the second measurement to the UE, the UE uses the first and second measurements to determine the imbalance between the transmit and/or receive paths of UE antennas. In one example, the UE reports the determined imbalance to the gNB, and the gNB applies the imbalance to the SRS measurements to obtain downlink channel state information. In another example, the UE applies a factor to a second SRS transmission from the UEs antennas to mitigate the imbalance. The gNB measures the second SRS and determines the downlink channel state information from the measurements.

The present disclosure relates to a 5G/NR and/or 6G communication system.

This disclosure provides aspects related to determining imbalance between UE's transmit and receive antennas and applying this to SRS and SRS measurements to obtain DL channel state information. This disclosure includes the following:
Transmitting DL signal to assist in determining imbalance.
Reporting of SRS measurements to UE for UE to determine imbalance
Applying a compensation factor to SRS transmissions to mitigate imbalance
gNB applying imbalance to SRS measurements to obtain DL CSI.

In the following, both frequency division duplexing (FDD) and time division duplexing (TDD) are regarded as a duplex method for DL and UL signaling. In addition, full duplex (XDD) operation is possible, e.g., sub-band full duplex (SBFD) or single frequency full duplex (SFFD).

Although exemplary descriptions and embodiments to follow expect orthogonal frequency division multiplexing (OFDM) or orthogonal frequency division multiple access (OFDMA), this disclosure can be extended to other OFDM-based transmission waveforms or multiple access schemes such as filtered OFDM (F-OFDM).

This disclosure provides several components that can be used in conjunction or in combination with one another, or can operate as standalone schemes.

In this disclosure, RRC signaling (e.g., configuration by RRC signaling) includes (1) common information provided by common signaling, e.g., this can be system information block (SIB)-based signaling (e.g., SIB1 or other SIB) or (2) RRC dedicated signaling that is sent to a specific UE wherein the information can be common/cell-specific information or dedicated/UE-specific information or (3) UE-group RRC signaling.

In this disclosure MAC CE signaling can be UE-specific e.g., to one UE or can be UE common (e.g., to a group of UEs or all UEs in a cell). MAC CE signaling can be DL MAC CE signaling or UL MAC CE signaling.

In this disclosure L1 control signaling includes: (1) DL control information (e.g., DCI on PDCCH or DL control information on PDSCH) and/or (2) UL control information (e.g., UCI on PUCCH or PUSCH). L1 control signaling can be UE-specific e.g., to one UE or can be UE common (e.g., to a group of UEs or all UEs in a cell).

In this disclosure, configuration can refer to configuration by semi-static signaling (e.g., RRC or SIB signaling). In one example, a configuration can be applicable to multiple transmission instances, until a new configuration is received and applied.

In this disclosure, indication can refer to indication by dynamic signaling (e.g., L1 control (e.g., DCI Format) or MAC CE signaling). In one example, an indication can be for an associated occasion(s) (e.g., an occasion or multiple occasions associated with the indication).

In this disclosure a list with N elements can be denoted as L(i), where i can take N values, and L(i) can correspond to the element or entry associated with index i. In one example, i can take N arbitrary values. In one example, i=0, 1, . . . , N−1. In one example, i=1, 2, . . . , N. In one example, i is an identity of an element in the list.

In the present disclosure, the term “activation” describes an operation wherein a UE receives and decodes first information provided by a first signal from the network (or gNB) and, based on the first information, the UE determines a starting point in time. The starting point can be a present or a future slot/subframe or symbol and the exact location is either implicitly or explicitly indicated, or is otherwise defined in the system operation or is configured by higher layers. Upon successfully decoding the first information, the UE responds according to an indication provided by the first information. The term “deactivation” describes an operation wherein a UE receives and decodes second information provided by a second signal from the network (or gNB) and, based on the second information from the signal, the UE determines a stopping point in time. The stopping point can be a present or a future slot/subframe or symbol and the exact location is either implicitly or explicitly indicated, or is otherwise defined in the system operation or is configured by higher layers. Upon successfully decoding the second information, the UE responds according to an indication provided by the second information. The first signal can be same as the second signal or the first information can be same as the second information, wherein a first part of the information can be associated with an “activation” operation and with first UEs or with first parameters for transmissions/receptions by a UE, and a second part of the information can be associated with a “deactivation” operation and with second UEs or with second parameters for transmissions/receptions by the UE. For example, the second information can be absent, and deactivation can be implicitly derived. For example, when a UE has received an activation information in a previous indication, and is not included among UEs with activation information in a next indication, the UE can determine the latter indication as an implicit deactivation indication.

Terminology such as TCI, TCI states, SpatialRelationInfo, target RS, reference RS, and other terms is used for illustrative purposes and is therefore not normative. Other terms that refer to same functions can also be used.

A “reference RS” (e.g., reference source RS) corresponds to a set of characteristics of a DL beam or an UL TX beam, such as a direction, a precoding/beamforming, a number of ports, and so on. For instance, the UE can receive a source RS index/ID in a TCI state assigned to (or associated with) a DL transmission (and/or UL transmission), the UE applies the known characteristics of the source RS to the assigned DL transmission (and/or UL transmission). The source RS can be received and measured by the UE (in this case, the source RS is a downlink measurement signal such as NZP CSI-RS and/or SSB) with the result of the measurement used for calculating a beam report (e.g., including at least one L1-RSRP/L1-signal-to-interference-plus-noise ratio (SINR) accompanied by at least one CSI-RS resource indicator (CRI) or SSB resource indicator (SSBRI)). As the NW/gNB receives the beam report, the NW can be better equipped with information to assign a particular DL (and/or UL) TX beam to the UE. Optionally or alternatively, the source RS can be transmitted by the UE (in this case, the source RS is an uplink measurement signal such as SRS). As the NW/gNB receives the source RS, the NW/gNB can measure and calculate the needed information to assign a particular DL (or/and UL) TX beam to the UE, for example in case of channel reciprocity.

In this disclosure, DCI Format is used for L1 control information in the DL direction from gNB to UE. DCI Format (i.e., L1 control information) can be single stage/part control information or two stage/part control information. In one example, the DCI format can be carried on a physical downlink control channel (PDCCH). In one example, DCI format can be carried on a physical downlink shared channel (PDSCH). In one example, DCI can be split between PDCCH (e.g., for a first part) and PDSCH (e.g. for a second part). In one example, DCI can be split between a first PDCCH (e.g., for a first part) and a second PDCCH (e.g. for a second part).

In this disclosure, a time unit, for example, can be a symbol or a slot or a sub-frame or a frame. In one example, a time-unit can be multiple symbols, or multiple slots or multiple sub-frames or multiple frames. In one example, a time-unit can be a sub-slot (e.g., part of a slot). In one example, a time-unit can be specified in units of time, e.g., microseconds, or milliseconds or seconds, etc.

In this disclosure, for example, a frequency-unit can be a sub-carrier or a resource block (RB) or a sub-channel, wherein a sub-channel is a group of RBs, or a bandwidth part (BWP). In one example, a frequency-unit can be multiple sub-carriers, or multiple RBs or multiple sub-channels. In one example, a frequency-unit can be a sub-RB (e.g., part of a RB). A frequency-unit can be specified in units of frequency, e.g., Hz, or kHz or MHz, etc.

In this disclosure, a higher layer message (e.g., SIB-based or RRC-based or MAC CE-based) can be carried by a physical downlink shared channel (PDSCH). In one example, the PDSCH can be scheduled by a DCI format.

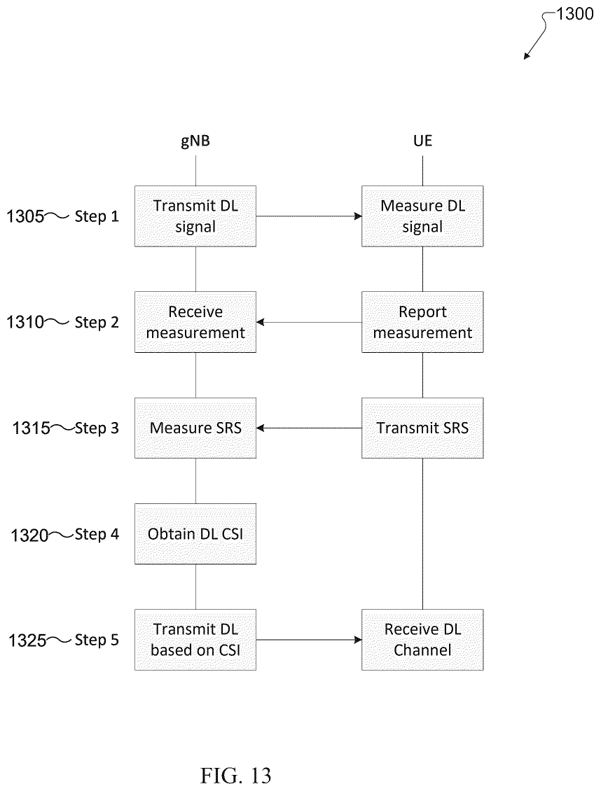

FIG. 13 illustrates a signal flow of an example procedure 1300 for measurement and reporting for UE calibration according to embodiments of the present disclosure. For example, procedure 1300 can be performed by the UE 111 and the gNB 102 and/or network 130 in the wireless network 100 of FIG. 1. This example is for illustration only and other embodiments can be used without departing from the scope of the present disclosure.

In a first embodiment of this disclosure as illustrated in a FIG. 13:
In 1305 (step 1): The gNB transmits a downlink signal (e.g., CSI-RS or SSB), and the UE measures the downlink signal. In one example, the downlink signal is measured separately on each UE antenna.
In 1310 (step 2): The UE reports the downlink measurements of step 1 to the gNB.
In 1315 (step 3): The UE transmits an uplink signal, e.g., sounding reference signal (SRS) from each antenna of UE. The gNB measures the SRS, e.g., to estimate uplink channel quality and/or state information between gNB and UE.
In 1320 (step 4): The gNB uses the downlink measurements reported from the UE in step 2, along with the uplink (e.g., SRS) measurements of step 3 to estimate the downlink channel quality and/or state information between the gNB and UE.
In 1325 (step 5): Using the channel quality and/or state information of step 4, the gNB can determine downlink transmission parameters and transmit downlink channels accordingly.

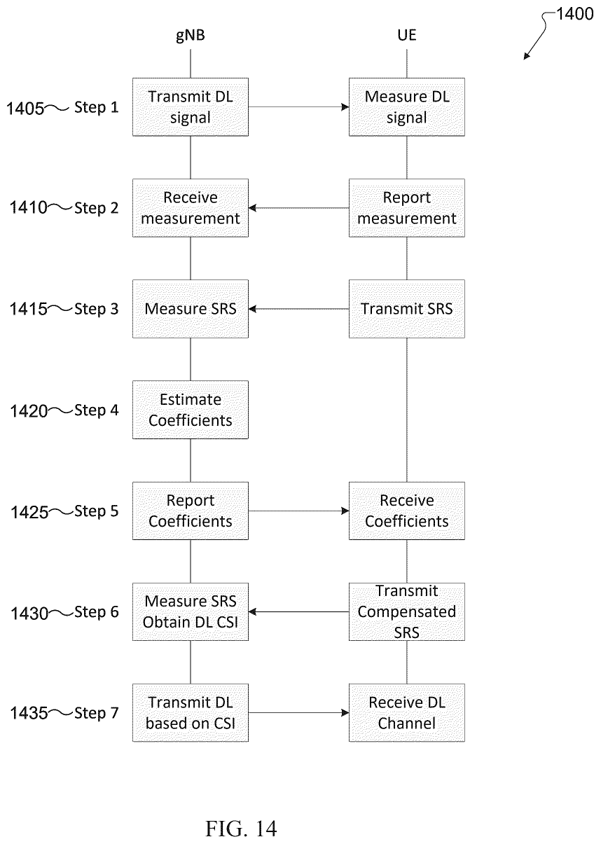

FIG. 14 illustrates a signal flow of an example procedure 1400 for measurement and reporting for UE calibration according to embodiments of the present disclosure. For example, procedure 1400 can be performed by the UE 112 and the gNB 102 and/or network 130 in the wireless network 100 of FIG. 1. This example is for illustration only and other embodiments can be used without departing from the scope of the present disclosure.

In a variant of the first embodiment of this disclosure as illustrated in a FIG. 14:
In 1405 (step 1): The gNB transmits a downlink signal (e.g., CSI-RS or SSB), and the UE measures the downlink signal. In one example, the downlink signal is measured separately on each UE antenna.
In 1410 (step 2): The UE reports the downlink measurements of step 1 to the gNB.
In 1415 (step 3): The UE transmits a first uplink signal, e.g., sounding reference signal (SRS), from each antenna of UE. The gNB measures the first SRS, e.g., to estimate uplink channel quality and/or state information between gNB and UE.
In 1420 (step 4): The gNB uses the downlink measurements reported from the UE in step 2, along with the uplink signal (e.g., SRS) measurements of step 3 to determine coefficients to apply to the transmit antennas to compensate/mitigate antenna mismatch
In 1425 (step 5): The gNB reports mismatch coefficients of step 4 to the UE.
In 1430 (step 6): The UE transmits a second uplink signal, e.g., sounding reference signal (SRS), from each antenna of UE after applying the coefficients received from gNB in step 5. The gNB measures the second uplink signal, e.g., SRS, and estimates the downlink channel quality and/or state information between the gNB and UE.
In 1435 (step 7): Using the channel quality and/or state information of step 4, the gNB can determine downlink transmission parameters and transmit downlink channels accordingly.

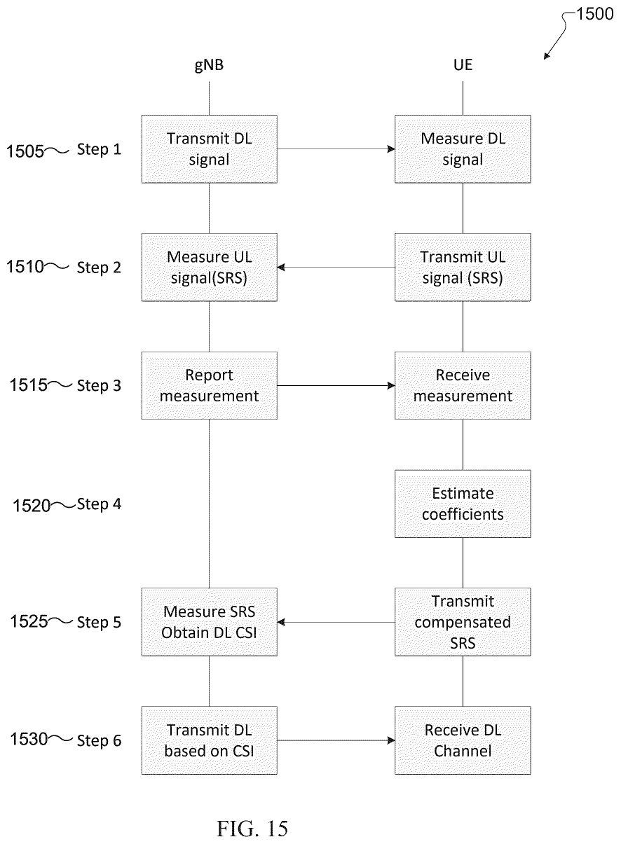

FIG. 15 illustrates a signal flow of an example procedure 1500 for measurement and reporting for UE calibration according to embodiments of the present disclosure. For example, procedure 1500 can be performed by the UE 113 and the gNB 102 and/or network 130 in the wireless network 100 of FIG. 1. This example is for illustration only and other embodiments can be used without departing from the scope of the present disclosure.

In a second embodiment of this disclosure as illustrated in a FIG. 15:
In 1505 (step 1): The gNB transmits a downlink signal (e.g., CSI-RS or SSB), and the UE measures the downlink signal. In one example, the downlink signal is measured separately on each UE antenna.
In 1510 (step 2): The UE transmits an uplink signal (e.g., sounding reference signal (SRS)) from each antenna of UE. The gNB measures the uplink signal (e.g., SRS) from each UE antenna.
In 1515 (step 3): The gNB reports the uplink measurements of step 2 to the UE.
In 1520 (step 4): The UE uses the downlink measurements of step 1, along with the uplink measurements report from the gNB in step 3 to determine coefficients to apply to the transmit antennas to compensate/mitigate antenna mismatch.
In 1525 (step 5): The UE transmits a second uplink signal, e.g., sounding reference signal (SRS) from each antenna of UE after applying the coefficients determined in step 4. The gNB measures the second uplink signal, e.g., SRS and estimates the downlink channel quality and/or state information between the gNB and UE.
In 1530 (step 6): Using the channel quality and/or state information of step 5, the gNB can determine downlink transmission parameters and transmit downlink channels accordingly.

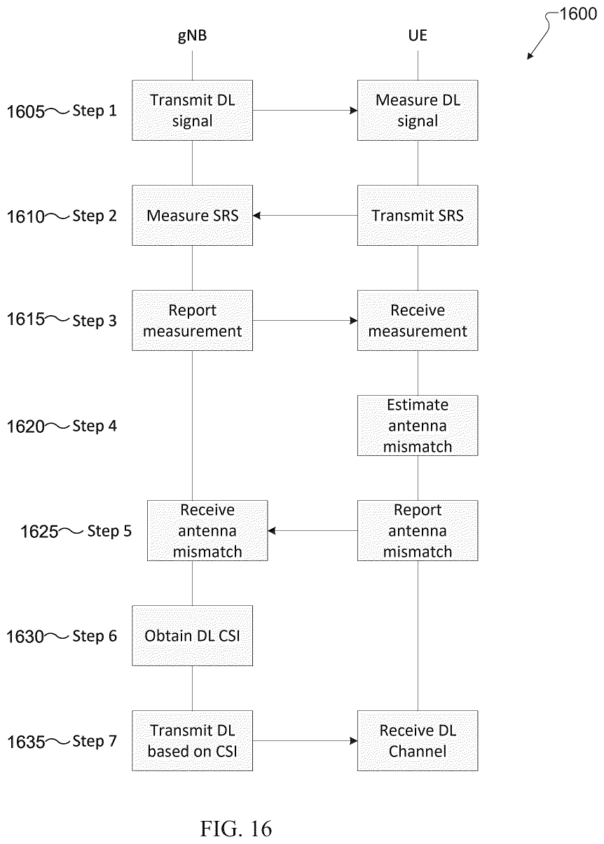

FIG. 16 illustrates a signal flow of an example procedure 1600 for measurement and reporting for UE calibration according to embodiments of the present disclosure. For example, procedure 1600 can be performed by the UE 114 and the gNB 102 and/or network 130 in the wireless network 100 of FIG. 1. This example is for illustration only and other embodiments can be used without departing from the scope of the present disclosure.

In a third embodiment of this disclosure as illustrated in a FIG. 16:
In 1605 (step 1): The gNB transmits a downlink signal (e.g., CSI-RS or SSB), and the UE measures the downlink signal. In one example, the downlink signal is measured separately on each UE antenna.
In 1610 (step 2): The UE transmits an uplink signal, e.g., sounding reference signal (SRS) from each antenna of UE. The gNB measures the uplink signal, e.g., SRS from each UE antenna.
In 1615 (step 3): The gNB reports the uplink measurements of step 2 to the UE.
In 1620 (step 4): The UE uses the downlink measurements of step 1, along with the uplink measurements report from the gNB in step 3 to determine mismatch between UE antennas.
In 1625 (step 5): The UE reports the mismatch coefficients of step 4 to gNB.
In 1630 (step 6): The gNB uses the report from the UE in step 5, along with the uplink signal, e.g., SRS, measurements of step 2 to estimate the downlink channel quality and/or state information between the gNB and UE.
In 1635 (step 7): Using the channel quality and/or state information of step 5, the gNB can determine downlink transmission parameters and transmit downlink channels accordingly.

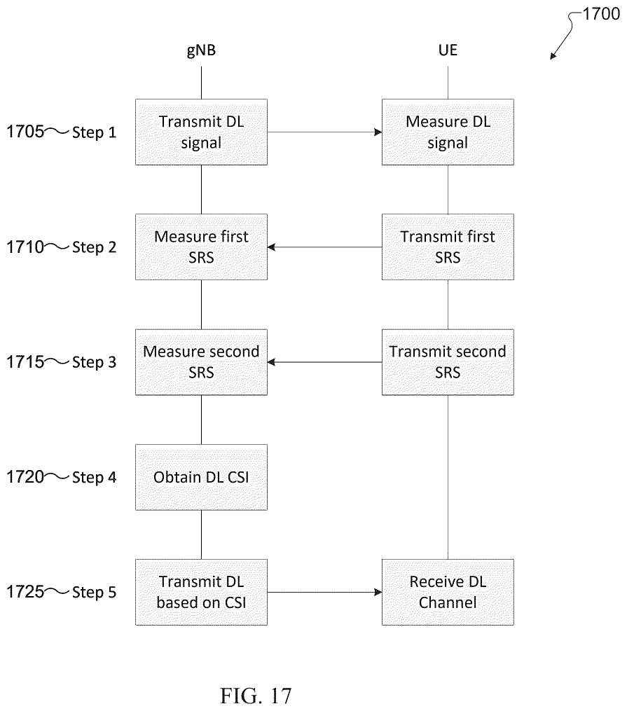

FIG. 17 illustrates a signal flow of an example procedure 1700 for measurement and reporting for UE calibration according to embodiments of the present disclosure. For example, procedure 1700 can be performed by the UE 115 and the gNB 102 and/or network 130 in the wireless network 100 of FIG. 1. This example is for illustration only and other embodiments can be used without departing from the scope of the present disclosure.

In a variant embodiment as illustrated in FIG. 17:
In 1705 (step 1): The gNB transmits a downlink signal (e.g., CSI-RS or SSB), and the UE measures the downlink signal. In one example, the downlink signal is measured separately on each UE antenna. In one example, the DL signal is transmitted from antenna i of the gNB, and received by the transceiver through antennas j, wherein j=0, 1, . . . , M−1. The UE can estimate the channel for each antenna, i.e., hᵢⱼ, wherein hⱼᵣ=1
In 1710 (step 2): The UE transmits a first uplink signal, e.g., first SRS, from each antenna pre-coded based on measurement in step 1, e.g., by

$$\frac{{h}_{ij}^{*}}{{abs}^{2} ( {h}_{ij} )} .$$

In one example, the gNB estimates the signal as

$$\frac{{h}_{ij}^{*}}{{abs}^{2} ( {h}_{ij} )} {h}_{ij} {h}_{tj} = {h}_{tj} .$$

In 1715 (step 3): The UE transmits a second uplink signal, e.g., second SRS, from each antenna un-pre-coded. In one example, the gNB estimates the signal as hᵢⱼhₜⱼ.
In 1720 (step 4): The gNB using the measurements in steps 2 and 3, can estimate the DL channel state information.
In 1725 (step 5): Using the channel quality and/or state information of step 4, the gNB can determine downlink transmission parameters and transmit downlink channels accordingly.

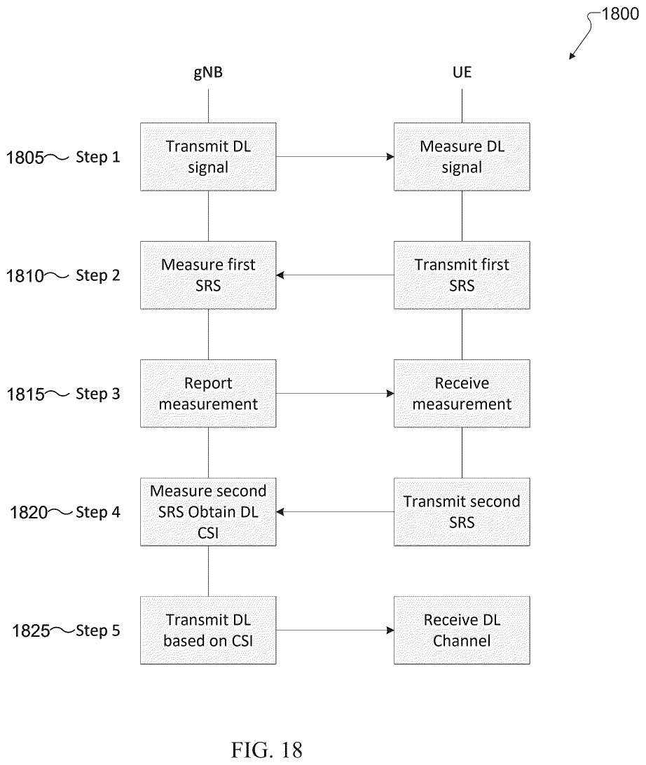

FIG. 18 illustrates a signal flow of an example procedure 1800 for measurement and reporting for UE calibration according to embodiments of the present disclosure. For example, procedure 1800 can be performed by the UE 116 and the gNB 102 and/or network 130 in the wireless network 100 of FIG. 1. This example is for illustration only and other embodiments can be used without departing from the scope of the present disclosure.

In a variant embodiment as illustrated in FIG. 18:
In 1805 (step 1): The gNB transmits a downlink signal (e.g., CSI-RS or SSB), and the UE measures the downlink signal. In one example, the downlink signal is measured separately on each UE antenna. In one example, the DL signal is transmitted from antenna i of the gNB, and received by the transceiver through antennas j, wherein j=0, 1, . . . , M−1. The UE can estimate the channel for each antenna, i.e., hᵢⱼ, wherein hⱼᵣ=1
In 1810 (step 2): The UE transmits a first uplink signal, e.g., a first SRS, from each antenna pre-coded based on measurement in step 1, e.g., by

$$\frac{{h}_{ij}^{*}}{{abs}^{2} ( {h}_{ij} )} .$$

In one example, the gNB estimates the signal as

$$\frac{{h}_{ij}^{*}}{{abs}^{2} ( {h}_{ij} )} {h}_{ij} {h}_{tj} = {h}_{tj} .$$

In 1815 (step 3): The gNB reports the measurement of step 2 to the UE.
In 1820 (step 4): The UE transmits a second uplink signal, e.g., a second SRS, from each antenna pre-coded, based on the measurement reported from the UE in step 3, e.g., pre-coded by

$$\frac{{h}_{ij}^{*}}{{abs}^{2} ( {h}_{ij} )} .$$

In one example, the gNB estimates the signal as

$$\frac{{h}_{ij}^{*}}{{abs}^{2} ( {h}_{ij} )} {h}_{ij} {h}_{tj} = {h}_{tj} .$$

Hence, we gNB can estimated the DL channel state information.
In 1820 (step 4): The gNB using the measurements in steps 2 and 3, can estimate the DL channel state information.
In 1825 (step 5): Using the channel quality and/or state information of step 4, the gNB can determine downlink transmission parameters and transmit downlink channels accordingly.

In one example, the gNB (e.g., the BS 102) transmits a downlink signal as described in step 1 of FIG. 13, or step 1 of FIG. 14 or step 1 of FIG. 15 or step 1 of FIG. 16. In one example, the DL signal is SS/PBCH block (SSB). In one example, the DL signal is channel state information reference signal (CSI-RS). In one example, the CSI-RS is transmitted on a single antenna port. In one example, the CSI-RS transmitted on multiple (e.g., 2) antenna ports. In one example, the SSB or CSI-RS is transmitted from a single gNB antenna. In one example, the SSB or CSI-RS is transmitted from a single antenna panel. In one example, the DL signal is low-power synchronization signal (e.g., LP-SS).

In one example, the CSI-RS is a periodic reference signal, configured with a periodicity and an offset within the periodicity. In one example, the periodicity can be long, the periodicity can depend on the rate at which the mismatch between antennas of the UEs changes. In one example, the CSI-RS is a semi-persistent reference signal, configured with a periodicity and an offset within the periodicity. In one example, the CSI-RS is an aperiodic reference signal.

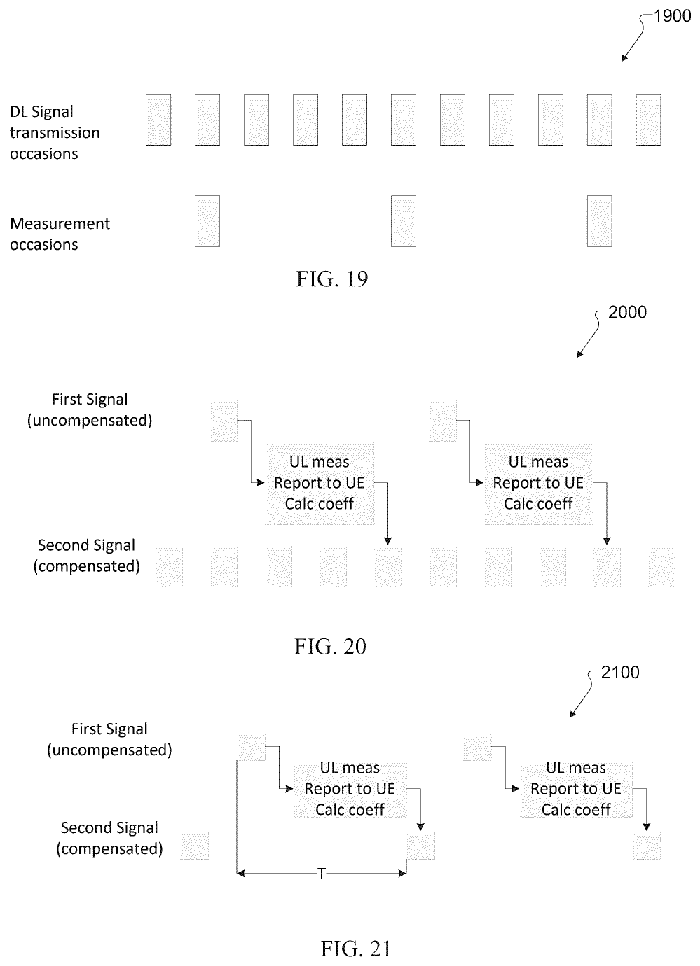

FIG. 19 illustrates example transmission occasion measurements 1900 according to embodiments of the present disclosure. For example, transmission occasion measurements 1900 can be measured by the UE 116 of FIG. 3. This example is for illustration only and other embodiments can be used without departing from the scope of the present disclosure.

In one example, the UE is configured to measure the downlink (DL) signal. The UE is provided a report configuration, wherein the report configuration can include:
Signal to measure
Quantity to measure
Measurement report to report the measurement.

In one example, the signal to measure can include:
SS/PBCH block (SSB), wherein the SSB is identified by SSB-index.
SS/PBCH block (SSB) associated with additional PCI, wherein the SSB is identified by the SSB-index and additional PCI.
In one example, an SSB is cell-defining SSB (CD-SSB).
In one example, an SSB is a non-cell-defining SSB (NCD-SSB).
CSI-RS, wherein the CSI-RS can be identified by a CSI-RS resource set ID and/or a CSI-RS ID.
Pre-coded CSI-RS, wherein, the pre-coded CSI-RS is pre-coded based on the SRS transmitted from the UE.
Non-pre-coded CSI-RS.
Low-power synchronization signal (LP-SS).

In one example, the UE can be configured a measurement time or measurement occasion to measure the DL signal. In one example, the measurement time or measurement occasion is the time of transmission of the measurement signal. In one example, the measurement time or measurement occasion is a subset of the transmission time or transmission occasion of the DL signal. For example, the UE can be configured to measure every Nth transmission time or transmission occasion of the DL signal. FIG. 19 illustrates an example, where the UE is configured to measure the 4^{th} occasion of the DL signal. In one example, a UE is configured a measurement period. In one example, the UE is configured N, the number of DL signal occasions for which a UE provides or performs a measurement. In one example, the UE is configured an offset within the measurement period. In one example, the transmission of the DL signal is triggered, the triggering can be by L1 control (e.g., DCI Format) signaling or MAC CE signaling or RRC signaling. In one example, measurement can be triggered the triggering can be by L1 control (e.g., DCI Format) signaling or MAC CE signaling or RRC signaling.

In one example, the quantity to measure, can be per antenna or per branch quantity of the DL signal (e.g., signal to be measured)
In one example, the quality to measure can be reference signal received power (RSRP) of each branch or antenna.
   In one example, the first branch or antenna is a reference, and the RSRP of the remaining branches or antennas is measured relative (e.g., differential RSRP) to the first branch or antenna e.g., differential RSRP relative to the RSRP of the first antenna, wherein the differential RSRP is expressed in units of Δ dB. In one example, Δ=2 dB.
   In one example, the branch or antenna with largest RSRP is a reference, and the RSRP of the remaining branches or antennas is measured relative (e.g., differential RSRP) to the branch or antenna with largest RSRP e.g., differential RSRP relative to the RSRP of the first antenna, wherein the differential RSRP is expressed in units of Δ dB. In one example, Δ=2 dB.
   In one example, the measurement of RSRP or relative (e.g., differential) RSRP can be in dB or in dBm.
   In one example, the measurement of RSRP or relative (e.g., differential) RSRP can be an absolute value (not in dB).
In one example, the quality to measure can be reference signal received amplitude of each branch or antenna.
   In one example, the first branch or antenna is a reference, and the reference signal received amplitude of the remaining branches or antennas is measured relative (e.g., differential) to the first branch or antenna.
   In one example, the branch or antenna with largest RSRP or amplitude is a reference, and the reference signal received amplitude of the remaining branches or antennas is measured relative (e.g., differential) to the branch or antenna with largest RSRP or amplitude.
   In one example, the measurement of amplitude or relative (e.g., differential) amplitude can be in dB or in dBm.
   In one example, the measurement of amplitude or relative (e.g., differential) amplitude can be an absolute value (not in dB).
In one example, the quality to measure can be reference signal received phase of each branch or antenna, wherein phase is measured after correlating the received signal with the complex conjugate of the reference signal.
   In one example, the first branch or antenna is a reference, and the reference signal received phase of the remaining branches or antennas is measured relative (e.g., differential) to the first branch or antenna.
   In one example, the branch or antenna with largest RSRP or amplitude is a reference, and the reference signal received phase of the remaining branches or antennas is measured relative (e.g., differential) to the branch or antenna with largest RSRP or amplitude.
   In one example, the measurement of phase or relative (e.g., differential) phase can be in degrees.
   In one example, the measurement of phase or relative (e.g., differential) phase can be in radians.
In one example, the quality to measure can be reference signal received amplitude and phase of each branch or antenna, wherein amplitude-phase is measured after correlating the received signal with the complex conjugate of the reference signal.
   In one example, the first branch or antenna is a reference, and the reference signal received amplitude and phase of the remaining branches or antennas is measured relative (e.g., differential) to the first branch or antenna.
   In one example, the branch or antenna with largest RSRP or amplitude is a reference, and the reference signal received amplitude phase of the remaining branches or antennas is measured relative (e.g., differential) to the branch or antenna with largest RSRP or amplitude.
   In one example, a first measurement is provided for the amplitude (e.g., in dB or absolute value), and a second measurement is provided for the phase (e.g., in degrees or in radians).
   In one example, a complex value is provided, wherein the complex value has a real component and a complex component.

In one example, the quantity to be reported is a single measurement instance.

In one example, the quantity to be reported is an average of K measurement instances, wherein K can be configured and/or updated by RRC signaling and/or MAC CE signaling and/or L1 control (e.g., DCI Format) signaling. In one example, K is specified in the system specifications.

In one example, the quantity to be report is an exponential average, e.g., if the average measurement in instance n is Q(n), and the average measurement in instance n−1 is Q(n−1) and measured quality in instance n is Qᵢₙₛ(n); Q(n)=αQ(n−1)+(1−α)Qᵢₙₛ(n) or Q(n)=(1−α)Q(n−1)+αQᵢₙₛ(n) wherein α, the exponential averaging coefficient, can be configured and/or updated by RRC signaling and/or MAC CE signaling and/or L1 control (e.g., DCI Format) signaling.

In one example, whether the quantity to be reported is from a single instance or from multiple instances is up to UE implementation.

In one example, the UE is configured a measurement report to report the measurement of the DL signal, e.g., as in step 2 of FIG. 13 or step 2 of FIG. 14.
In one example, the measurement report is in uplink control information (UCI) on PUCCH. In one example, if the PUCCH overlaps a PUSCH, the UCI is transmitted in the PUSCH.
In one example, the measurement report is in uplink control information (UCI) on PUSCH.
In one example, the measurement report is in MAC CE message.
In one example, the measurement report is in RRC message.

In one example, the measurement report includes a measurement quantity of each branch or antenna. In one example, if the UE has M branches or antennas, the measurement report has M quantities. In one example, M is determined based on xTyR configuration of the UE, for example, M=y.

In one example, a first branch or antenna is a reference, and the measurement report includes a measurement quantity of the remaining branches or antennas relative (e.g., differential) to the first branch or antenna. In one example, if the UE has M branches or antennas, the measurement report has M−1 quantities. In one example, M is determined based on xTyR configuration of the UE, for example, M=y.

In one example, a branch or antenna or port with largest RSRP or amplitude is a reference, and the measurement report includes a measurement quantity of the remaining branches or antennas or ports relative (e.g., differential) to the branch or antenna or port with largest RSRP or amplitude. In one example, if the UE has M branches or antennas or ports, the measurement report has M−1 quantities. In one example, M is determined based on xTyR configuration of the UE, for example, M=y. In one example, a measurement report includes an index of the branch or antenna or port with largest RSRP or amplitude. In one example, the size of the field reporting the index of the branch or antenna or port is ceil(log 2(M)), where log 2 is log to the base 2, and ceil in ceiling (rounding-up) operator.

In one example, the M or M−1 measurement quantities in the measurement report are in order of index of branch or antenna (e.g., in one example, in ascending order or in another example, in descending order).

In one example, K measurements for K antennas or antenna ports are reported (e.g., K is configured by network and/or the K measurements with RSRP above a threshold). In one example, K≤M. In one example, K<M. In one example, K≤M−1. In one example, K<M−1. In one example, the K measurements are in order of RSRP, e.g., in descending order from largest to smallest. In one example, the K measurements are in order of antenna index. In one example, a measurement is pair of antenna (or antenna port) index and corresponding measurement quantity e.g., differential or absolute (RSRP and/or amplitude, and/or phase).

In one example, a measurement report includes an index or ID of a downlink signal over which the measurement was performed.

In one example, if the measurement quantity is RSRP, the measurement quantity can be reported in dB. For example, if the RSRP is relative to the strongest antenna, the measurement can be one of:
{0, 1, 2, 3, 4, 5, 6, 7} dB below the strongest antenna, i.e., step size Δ is 1 dB.
{1, 2, 3, 4, 5, 6, 7, 8} dB below the strongest antenna, i.e., step size Δ is 1 dB.
{0, 2, 4, 6, 8, 10, 12, 14} dB below the strongest antenna, i.e., step size Δ is 2 dB.
{2, 4, 6, 8, 10, 12, 14, 16} dB below the strongest antenna, i.e., step size Δ is 2 dB.

In one example, if the measurement quantity is phase, then measurement quantity can be reported as one of:
In degrees in increments of 1 degree, e.g., {0, 1, . . . , 358, 359}
In degrees in increments of 0.1 degree, e.g., as index {0, 1, . . . , 3598, 3599}
As X-PSK alphabet, where X=2N, N=3, 4, 5, 6 . . . . For example, index i corresponds to phase

$$\frac{i}{{2}^{N}} \cdot 360 degrees , or \frac{i}{{2}^{N}} \cdot 2 π radians .$$

In one example, the report from the UE is wideband report across the bandwidth of the DL signal.

In one example, the report from the UE includes multiple sub-band reports. In one example, the size of the sub-band is S. In one example, the number of sub-bands is L. Wherein S and/or L can be specified in the system specifications and/or configured and/or updated by RRC signaling and/or MAC CE signaling and/or L1 control (e.g., DCI Format) signaling. In one example, the value of S depends on the bandwidth of the DL BWP. In one example, the value of S depends on the bandwidth of the DL signal.

In one example, UE is configured to transmit an UL signal (e.g., SRS) from each of its transmit branches or antennas, e.g., as described in step 2 of FIG. 15 or in step 2 of FIG. 16.

In one example, the UL signal (e.g., SRS) on each branch or antenna can be in a different symbol and/or slot and/or comb offset and/or RB. In one example, the UE is provided a configuration for the UL signal (e.g., SRS) of each branch or antenna at the UE.

In one example, the gNB measures the UL signal (e.g., SRS) from each branch or antenna of the UE and provides a report of the UE, e.g., as described in step 3 of FIG. 15.

In one example, the quantity to measure, can be per UE-antenna or per UE antenna-port or per UE-branch quantity of the UL signal (e.g., SRS) measured at the gNB:
In one example, the quality to measure can be reference signal received power (RSRP) of each UE-branch or UE-antenna.
   In one example, the first branch or antenna is a reference, and the RSRP of the remaining branches or antennas is measured relative (e.g., differential) to the first branch or antenna e.g., differential RSRP relative to the RSRP of the first antenna, wherein the differential RSRP is expressed in units of Δ dB. In one example, Δ=2 dB.
   In one example, the branch or antenna with largest RSRP is a reference, and the RSRP of the remaining branches or antennas is measured relative (e.g., differential) to the branch or antenna with largest RSRP, e.g., differential RSRP relative to the RSRP of the first antenna, wherein the differential RSRP is expressed in units of Δ dB. In one example, Δ=2 dB.
   In one example, the measurement of RSRP or relative (e.g., differential) RSRP can be in dB or in dBm.
   In one example, the measurement of RSRP or relative (e.g., differential) RSRP can be an absolute value (not in dB).
In one example, the quality to measure can be reference signal received amplitude of each UE-branch or UE-antenna.
   In one example, the first branch or antenna is a reference, and the reference signal received amplitude of the remaining branches or antennas is measured relative (e.g., differential) to the first branch or antenna.
   In one example, the branch or antenna with largest RSRP or amplitude is a reference, and the reference signal received amplitude of the remaining branches or antennas is measured relative (e.g., differential) to the branch or antenna with largest RSRP or amplitude.
   In one example, the measurement of amplitude or relative (e.g., differential) amplitude can be in dB or in dBm.
   In one example, the measurement of amplitude or relative (e.g., differential) amplitude can be an absolute value (not in dB).
In one example, the quality to measure can be reference signal received phase of each UE-branch or UE-antenna, wherein phase is measured after correlating the received signal with the complex conjugate of the reference signal.
   In one example, the first branch or antenna is a reference, and the reference signal received phase of the remaining branches or antennas is measured relative (e.g., differential) to the first branch or antenna.
   In one example, the branch or antenna with largest RSRP or amplitude is a reference, and the reference signal received phase of the remaining branches or antennas is measured relative (e.g., differential) to the branch or antenna with largest RSRP or amplitude.
   In one example, the measurement of phase or relative (e.g., differential) phase can be in degrees.
   In one example, the measurement of phase or relative (e.g., differential) phase can be in radians.
In one example, the quality to measure can be reference signal received amplitude and phase of each UE-branch or UE-antenna, wherein amplitude-phase is measured after correlating the received signal with the complex conjugate of the reference signal.
   In one example, the first branch or antenna is a reference, and the reference signal received amplitude and phase of the remaining branches or antennas is measured relative (e.g., differential) to the first branch or antenna.
   In one example, the branch or antenna with largest RSRP or amplitude is a reference, and the reference signal received amplitude phase of the remaining branches or antennas is measured relative (e.g., differential) to the branch or antenna with largest RSRP or amplitude.
   In one example, a first measurement is provided for the amplitude (e.g., in dB or absolute value), and a second measurement is provided for the phase (e.g., in degrees or in radians).
   In one example, a complex value is provided, wherein the complex value has a real component and a complex component.

In one example, the quantity to be reported is a single measurement instance.

In one example, the quantity to be reported is an average of K measurement instances, wherein K can be configured and/or updated by RRC signaling and/or MAC CE signaling and/or L1 control (e.g., DCI Format) signaling. In one example, K is specified in the system specifications.

In one example, the quantity to be report is an exponential average, e.g., if the average measurement in instance n is Q(n), and the average measurement in instance n−1 is Q(n−1) and measured quality in instance n is Qᵢₙₛ(n); Q(n)=αQ(n−1)+(1−α)Qᵢₙₛ(n) or Q(n)=(1−α)Q(n−1)+αQᵢₙₛ(n) wherein α, the exponential averaging coefficient, can be configured and/or updated by RRC signaling and/or MAC CE signaling and/or L1 control (e.g., DCI Format) signaling.

In one example, whether the quantity to be reported is from a single instance or from multiple instances is up to gNB implementation.

In one example, a measurement report is configured for the reporting of the measurement of the UL signal (e.g., SRS), e.g., as in step 2 of FIG. 15.
In one example, the measurement report is in downlink control information (DCI) on PDCCH.
In one example, the measurement report is in downlink control information (DCI) on PDSCH.
In one example, the measurement report is in MAC CE message.
In one example, the measurement report is in RRC message.

In one example, the measurement report includes a measurement quantity of each branch or antenna. In one example, if the UE (e.g., the UE 116) has M branches or antennas, the measurement report has M quantities. In one example, M is determined based on xTyR configuration of the UE, for example, M=y.

In one example, a first branch or antenna is a reference, and the measurement report includes a measurement quantity of the remaining branches or antennas relative (e.g., differential) to the first UE-branch or UE-antenna. In one example, if the UE has M branches or antennas, the measurement report has M−1 quantities. In one example, M is determined based on xTyR configuration of the UE, for example, M=y.

In one example, a branch or antenna or port with largest RSRP or amplitude is a reference, and the measurement report includes a measurement quantity of the remaining UE-branches or UE-antennas or UE-ports relative (e.g., differential) to the UE-branch or UE-antenna or UE-port with largest RSRP or amplitude. In one example, if the UE has M branches or antennas or ports, the measurement report has M−1 quantities. In one example, M is determined based on xTyR configuration of the UE, for example, M=y. In one example, a measurement report includes an index of the UE-branch or UE-antenna or UE-port with largest RSRP or amplitude. In one example, the size of the field reporting the index of the UE-branch or UE-antenna or UE-port is ceil(log 2(M)), where log 2 is log to the base 2. In one example, a measurement report includes an index of the UL signal (e.g., SRS) resource with largest RSRP or amplitude.

In one example, the M or M−1 measurement quantities in the measurement report are in order of index of UE-branch or UE-antenna (e.g., in one example, in ascending order or in another example, in descending order).

In one example, K measurements for K antennas or antenna ports or branches are reported (e.g., K is configured by network and/or the K measurements with RSRP above a threshold). In one example, K≤M. In one example, K<M. In one example, K≤M−1. In one example, K<M−1. In one example, the K measurements are in order of RSRP, e.g., in descending order from largest to smallest. In one example, the K measurements are in order of antenna index. In one example, a measurement is pair of antenna (or antenna port or branch) index and corresponding measurement quantity e.g., differential or absolute (RSRP and/or amplitude, and/or phase).

In one example, a measurement report includes an index or ID of an uplink signal (e.g., SRS) over which the measurement was performed.

In one example, if the measurement quantity is RSRP, the measurement quantity can be reported in dB. For example, if the RSRP is relative to the strongest antenna, the measurement can be one of:
{0, 1, 2, 3, 4, 5, 6, 7} dB below the strongest antenna, i.e., step size Δ is 1 dB.
{1, 2, 3, 4, 5, 6, 7, 8} dB below the strongest antenna, i.e., step size Δ is 1 dB.
{0, 2, 4, 6, 8, 10, 12, 14} dB below the strongest antenna, i.e., step size Δ is 2 dB.
{2, 4, 6, 8, 10, 12, 14, 16} dB below the strongest antenna, i.e., step size Δ is 2 dB.

In one example, if the measurement quantity is phase, then measurement quantity can be reported as one of:
In degrees in increments of 1 degree, e.g., {0, 1, . . . , 358, 359}
In degrees in increments of 0.1 degree, e.g., as index {0, 1, . . . , 3598, 3599}
As X-PSK alphabet, where X=2^{N}, N=3, 4, 5, 6 . . . . For example, index i corresponds to phase

$$\frac{i}{{2}^{N}} \cdot 360 degrees , or \frac{i}{{2}^{N}} \cdot 2 π radians .$$

In one example, the UE measures a quantity for UE-branch or UE-antenna k mentioned herein based on DL signal. Let this quantity be h_{dk}e^{jφ}^{_{dk}}. In one example, this quantity is relative to a first or strongest (RSRP or amplitude) UE-branch or UE-antenna, the quantity for the first or strongest (RSRP or amplitude) UE-branch or UE-antenna is 1, i.e., h_{dm}=1 and φ_{dm}=0, where m is the index of the corresponding branch.

In one example, the UE receives a quantity for UE-branch or UE-antenna k mentioned herein based on UL signal (e.g., SRS) measurement at gNB. Let this quantity be hᵤₖe^{jφ}^{ᵤₖ}. In one example, this quantity is relative to a first or strongest (RSRP or amplitude) UE-branch or UE-antenna, the quantity for the first or strongest (RSRP or amplitude) UE-branch or UE-antenna is 1, i.e., hᵤₘ=1 and φᵤₘ=0, where m is the index of the corresponding branch.

In one example, the UE can calculate a mismatch coefficient or compensation coefficient as the ratio between the two measurements mentioned herein for each UE-branch or UE-antenna, e.g., hᵤₖe^{jφ}^{ᵤₖ}/h_{dk}e^{jφ}^{_{dk}} or h_{dk}e^{jφ}^{_{dk}}/hᵤₖe^{jφ}^{ᵤₖ}.
In one example, if measurement is performed based on amplitude, the mismatch coefficient or compensation coefficient is hᵤₖ/h_{dk} or h_{dk}/hᵤₖ.
In one example, if measurement is performed based on phase, the mismatch coefficient or compensation coefficient is e^{j(φ}^{ᵤₖ}^{-φ}^{_{dk}}⁾ or e^{j(φ}^{_{dk}}^{-φ}^{ᵤₖ}⁾

In one example, the UE measures a quantity for UE-branch or UE-antenna k mentioned herein based on DL signal. Let this quantity be RSRP_{dk} dB. In one example, this quantity is relative to a first or strongest (RSRP or amplitude) UE-branch or UE-antenna, the quantity for the first or strongest (RSRP or amplitude) UE-branch or UE-antenna is 0 dB, i.e., RSRP_{dm}=0 dB, where m is the index of the corresponding branch.

In one example, the UE receives a quantity for UE-branch or UE-antenna k mentioned herein based on UL signal (e.g., SRS) measurement at gNB. Let this quantity be RSRPᵤₖ dB. In one example, this quantity is relative to a first or strongest (RSRP or amplitude) UE-branch or UE-antenna, the quantity for the first or strongest (RSRP or amplitude) UE-branch or UE-antenna is 0 dB, i.e., RSRPᵤₘ=0 dB, where m is the index of the corresponding branch.

In one example, the UE can calculate a mismatch coefficient or compensation coefficient as the ratio (difference in dB) between the two measurements mentioned herein for each UE-branch or UE-antenna, e.g., RSRPᵤₖ−RSRP_{dk} dB or RSRP_{dk}−RSRPᵤₖ dB.

In one example, the UE pre-compensates, the uplink signal, e.g., SRS signal for each UE-branch or UE-antenna k before transmission, as described in step 5 of FIG. 15. Let SRS_{uncomp}(n) be the uncompensated SRS signal transmitted in occasion n, and let SRS_{comp}(n) be the compensated SRS signal transmitted in occasion n:
In one example,

$${SRS}_{comp} ( n ) = {SRS}_{uncomp} ( n ) \frac{{h}_{dk} {e}^{j {φ}_{dk}}}{{h}_{uk} {e}^{j {φ}_{uk}}}$$

In one example, SRS_{comp}(n) in dB=SRS_{uncomp}(n) in dB+(RSRP_{dk}−RSRPᵤₖ)
In one example,

$${SRS}_{comp} ( n ) = {SRS}_{uncomp} ( n ) {10}^{\frac{{RSRP}_{d k} - {RSRP}_{u k}}{20}}$$

In one example, the UE reports the mismatch coefficients or compensation coefficients mentioned herein for each UE-branch or UE-antenna k to the gNB as described in step 5 of FIG. 16. Wherein, k=0, 1, . . . . M−1, and M is the number of UE branches or antennas.
In one example, for each UE branch or UE antenna, the UE reports: RSRPᵤₖ−RSRP_{dk}.
In one example, for each UE branch or UE antenna, the UE reports: RSRP_{dk}−RSRPᵤₖ.
In one example, for each UE branch or UE antenna, the UE reports:

$$\frac{{h}_{uk} {e}^{j {φ}_{uk}}}{{h}_{dk} {e}^{j {φ}_{dk}}} .$$

In one example, for each UE branch or UE antenna, the UE reports:

$$\frac{{h}_{uk} {e}^{j {φ}_{uk}}}{{h}_{dk} {e}^{j {φ}_{dk}}} .$$

In one example, for each UE branch or UE antenna, the UE reports:

$$\frac{{h}_{u k}}{{h}_{d k}} .$$

In one example, for each UE branch or UE antenna, the UE reports:

$$\frac{{h}_{dk}}{{h}_{u k}}$$

In one example, for each UE branch or UE antenna, the UE reports: φᵤₖ−φ_{dk}.
In one example, for each UE branch or UE antenna, the UE reports: φ_{dk}−φᵤₖ.
In one example, the report is in uplink control information (UCI) on PUCCH. In one example, if the PUCCH overlaps a PUSCH, the UCI is transmitted in the PUSCH.
In one example, the report is in uplink control information (UCI) on PUSCH.
In one example, the report is in MAC CE message.
In one example, the report is in RRC message

In one example, a UE transmits a first UL signal (or uncompensated SRS resource) from each UE-branch or UE-antenna as described in step 2 of FIG. 15. The gNB (e.g., the BS 102) measures the first UL signal (or uncompensated SRS resource) associated with each UE-branch or UE-antenna. The gNB reports the measurement to UE as described in step 3 of FIG. 15. The UE calculates the compensation coefficients as described in step 4 of FIG. 15. The UE transmits a second UL signal, e.g., a second SRS resources, from each UE-branch or UE-antenna, after applying the compensation coefficients as described in step 5 of FIG. 15. The gNB uses the second compensated uplink signal, e.g., SRS resource to estimate the DL channel quality and/or state information and apply the estimated DL CSI to the DL transmissions to the UE.

FIG. 20 illustrates example transmissions 2000 of first and second signals according to embodiments of the present disclosure. For example, transmissions 2000 can be transmitted by any of the UEs 111-116 of FIG. 1. This example is for illustration only and other embodiments can be used without departing from the scope of the present disclosure.

In one example, the first UL signal (or uncompensated SRS resource) is periodic or semi-persistent and the second uplink signal (e.g., compensated SRS resource) is periodic or semi-persistent. In one example, the periodicities of the two signals are different, as illustrated in FIG. 20. For example, the first signal can have a larger period than the second signal, when the time scale of changes in the UE's antenna mismatch is larger than the time scale for changes in the RF channel between the gNB and the UE. As the UE gets measurement reports from the gNB the UE calculates the compensation coefficients and updates the compensated SRS transmission as illustrated in FIG. 20.

FIG. 21 illustrates an example timeline 2100 for transmissions of first and second signals according to embodiments of the present disclosure. For example, timeline 2100 can be followed by any of the UEs 111-116 of FIG. 1, such as the UE 111. This example is for illustration only and other embodiments can be used without departing from the scope of the present disclosure.

In a variant example, the first UL signal (or uncompensated SRS resource) and the second uplink signal (e.g., compensated SRS resource), have the same periodicity with an offset as illustrated in FIG. 21. For transmission occasion n of the first UL signal (or uncompensated SRS resource), the gNB performs UL measurements and reports measurements to the UE, the UE calculates the compensation coefficients and applies the compensation coefficients for transmission occasion n of the second uplink signal (e.g. compensated SRS resource) occurring after an offset T from transmission occasion n of the first UL signal (or uncompensated SRS resource) as illustrated in FIG. 21.

In one example, the UE can transmit an indicator when it updates the second uplink signal (e.g., compensated SRS resource):
In one example, the indicator is included in uplink control information (UCI), e.g., one-bit indicator on PUCCH or PUSCH.
In one example, the indicator is included in MAC CE.
In one example, two (or more) resources or resource sets are configured for the second compensated SRS resource, the UE can use these resources alternatively every time it updates compensation coefficients of the second compensated SRS resource.

In one example, the first UL signal (or uncompensated SRS resource) is aperiodic and the second UL signal (e.g., compensated SRS resource) is periodic or semi-persistent. For example, the first UL signal (or uncompensated SRS resource) can be triggered when there is a perceived change in the mismatch of the UE-branches or UE-antennas.

In one example, the first UL signal (or uncompensated SRS resource) is periodic or semi-persistent and the second UL signal (e.g., compensated SRS resource) is aperiodic. For example, the first UL signal (or uncompensated SRS resource) can be transmitted with a period corresponding to the time scale of changes in mismatch of the UE-branches or UE-antennas, while the second compensated SRS resource is transmitted when there is a perceived change in channel conditions or there is data to transmit.

In one example, the first UL signal (or uncompensated SRS resource) is aperiodic and the second UL signal (e.g., compensated SRS resource) is aperiodic. For example, the first UL signal (or uncompensated SRS resource) can be triggered when there is a perceived change in the mismatch of the UE-branches or UE-antennas, while the second compensated SRS resource is transmitted when there is a perceived change in channel conditions or there is data to transmit.

In one example, the UE transmits SRS resources from each UE-branch or UE-antenna, after applying compensation coefficients as described in step 5 of FIG. 15. The SRS resources are also used to assisted with the calculation of the compensation coefficients are described in step 2 of FIG. 15.

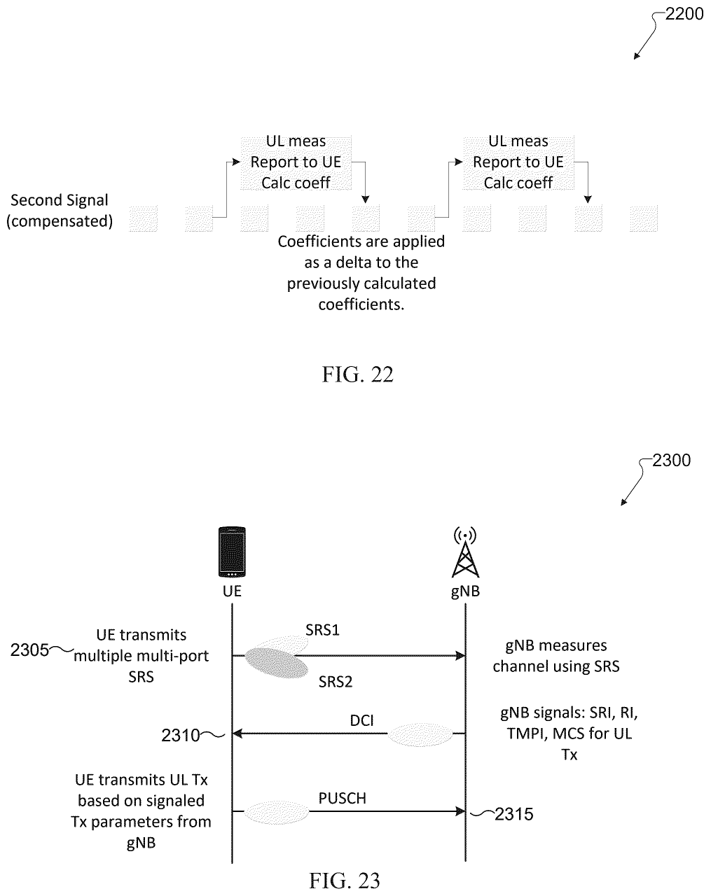

FIG. 22 illustrates example transmissions 2200 of second signals according to embodiments of the present disclosure. For example, transmissions 2200 can be transmitted by any of the UEs 111-116 of FIG. 1, such as the UE 112. This example is for illustration only and other embodiments can be used without departing from the scope of the present disclosure.

In the example of FIG. 22, the UE transmits the compensated UL signal (e.g., SRS signal) (initially for the first transmission or few transmission, the SRS is uncompensated until the UE gets UL measurements from the gNB, calculates and applies these compensation coefficients) from each UE-branch or UE-antenna. The gNB performs UL measurements on compensated SRS signal as described in step 2 of FIG. 15. The gNB reports the UL measurements as described in step 3 of FIG. 15. The UE calculates the compensation coefficients as described in step 4 of FIG. 15. The compensation coefficients are relative to the current compensation coefficients, when compensation coefficients are applied in step 5 of FIG. 15, they are applied as a delta to the current compensation coefficients.

In one example, a UE can report its capability to apply an offset to SRS transmission between the UE-branches or UE-antennas. The offset can be applied as described in step 5 of FIG. 15. In one example, the offset is amplitude or power. In one example the offset is amplitude and/or phase. In one example, a UE can report its capability to transmit compensated SRS.

In one example, a UE can report is capability to measure and report offset between UE-branches or UE-antennas. The measurement and reporting can be as described in step 1 and step 2 of FIG. 13, or the measurement can be as described in step 1 of FIG. 15 and step 1 of FIG. 16. In one example, the measurement includes amplitude or power offsets. In one example, the measurements include amplitude and/or phase offsets.

A time unit for DL signaling, for UL signaling, or for SL signaling on a cell is one symbol. A symbol belongs to a slot that includes a number of symbols such as 14 symbols. A slot can also be used as a time unit. A bandwidth (BW) unit is referred to as a resource block (RB). One RB includes a number of sub-carriers (SCs). For example, a slot can have duration of one millisecond and an RB can have a bandwidth of 180 kHz and include 12 SCs with inter-SC spacing of 15 kHz. As another example, a slot can have a duration of 0.25 milliseconds and include 14 symbols, and an RB can have a BW of 720 kHz and include 12 SCs with SC spacing of 60 kHz. An RB in one symbol of a slot is referred to as physical RB (PRB) and includes a number of resource elements (REs). A slot can be either full DL slot, full UL slot, or hybrid slot similar to a special subframe in time division duplex (TDD) systems (see also REF 1). In addition, a slot can have symbols for SL communications. A UE can be configured one or more bandwidth parts (BWPs) of a system BW for transmissions or receptions of signals or channels.

DL signals include data signals conveying information content, control signals conveying DL control information (DCI), and reference signals (RS) that are also known as pilot signals. A gNB transmits data information or DCI through respective physical DL shared channels (PDSCHs) or physical DL control channels (PDCCHs). A PDSCH or a PDCCH can be transmitted over a variable number of slot symbols including one slot symbol. For brevity, a DCI format scheduling a PDSCH reception by a UE is referred to as a DL DCI format and a DCI format scheduling a physical uplink shared channel (PUSCH) transmission from a UE is referred to as an UL DCI format. A DCI format scheduling PDSCH reception or PUSCH transmission for a single UE, such as a DCI format with CRC scrambled by C-RNTI/CS-RNTI/MCS-C-RNTI as described in [REF 2], are referred for brevity as a unicast DCI format. A DCI format scheduling PDSCH reception for multicast communication, such as a DCI format with CRC scrambled by G-RNTI/G-CS-RNTI as described in [REF 2], are referred to as multicast DCI format. DCI formats providing various control information to at least a subset of UEs in a serving cell, such as DCI format 2_0 in [REF 2], are referred to as group-common (GC) DCI formats.

The downlink physical-layer processing of transport channels on PDSCH can include the following steps: (1) Transport block CRC attachment; (2) Code block segmentation and code block CRC attachment; (3) Channel coding: LDPC coding; (4) Physical-layer hybrid-automatic repeat request (ARQ) processing; (5) Rate matching; (6) Scrambling; (7) Modulation: QPSK, 16QAM, 64QAM, 256QAM, and 1024QAM; (8) Layer mapping; and (9) Mapping to assigned resources and antenna ports.

As mentioned herein, the Physical Downlink Control Channel (PDCCH) can be used to schedule DL transmissions on PDSCH and UL transmissions on PUSCH, where the Downlink Control Information (DCI) on PDCCH includes: (1) Downlink assignments containing at least modulation and coding format, resource allocation, and hybrid-ARQ information related to DL-SCH; and (2) Uplink scheduling grants containing at least modulation and coding format, resource allocation, and hybrid-ARQ information related to UL-SCH. In addition to scheduling, PDCCH can be used to for: (1) Activation and deactivation of configured PUSCH transmission with configured grant; (2) Activation and deactivation of PDSCH semi-persistent transmission; (3) Notifying one or more UEs of the slot format; (4) Notifying one or more UEs of the PRB(s) and OFDM symbol(s) where the UE may expect no transmission is intended for the UE; (5) Transmission of transmit power control (TPC) commands for PUCCH and PUSCH; (6) Transmission of one or more TPC commands for SRS transmissions by one or more UEs; (7) Switching a UE's active bandwidth part; (8) Initiating a random access procedure; (9) Indicating the UE(s) to monitor the PDCCH during the next occurrence of the discontinuous reception (DRX) on-duration; (10) In integrated access and backhaul (IAB) context, indicating the availability for soft symbols of an IAB-DU; (11) Triggering one shot HARQ-ACK codebook feedback; and (11) For operation with shared spectrum channel access: (11a) Triggering search space set group switching; (11b) Indicating one or more UEs about the available RB sets and channel occupancy time duration; and (11c) Indicating downlink feedback information for configured grant PUSCH (CG-DFI). Polar coding is used for PDCCH. QPSK modulation is used for PDCCH.

A gNB (such as BS 102) transmits one or more of multiple types of RS including channel state information RS (CSI-RS) and demodulation RS (DMRS). A CSI-RS is primarily intended for UEs to perform measurements and provide channel state information (CSI) to a gNB. For channel measurement, non-zero power CSI-RS (NZP CSI-RS) resources are used. For interference measurement reports (IMRs), CSI interference measurement (CSI-IM) resources associated with a zero power CSI-RS (ZP CSI-RS) configuration are used. A CSI process includes NZP CSI-RS and CSI-IM resources. A UE (such as UE 116) can determine CSI-RS transmission parameters through DL control signaling or higher layer signaling, such as radio resource control (RRC) signaling from a gNB. Transmission instances of a CSI-RS can be indicated by DL control signaling or configured by higher layer signaling. A DMRS is transmitted only in the BW of a respective PDCCH or PDSCH and a UE can use the DMRS to demodulate data or control information.

UL signals also include data signals conveying information content, control signals conveying UL control information (UCI), DMRS associated with data or UCI demodulation, sounding RS (SRS) enabling a gNB to perform UL channel measurement, and a random access (RA) preamble enabling a UE to perform random access. A UE transmits data information or UCI through a respective physical UL shared channel (PUSCH) or a physical UL control channel (PUCCH). A PUSCH or a PUCCH can be transmitted over a variable number of slot symbols including one slot symbol. The gNB can configure the UE to transmit signals on a cell within an UL BWP of the cell UL BW.

UCI includes hybrid automatic repeat request acknowledgement (HARQ-ACK) information, indicating correct or incorrect detection of data transport blocks (TBs) in a PDSCH, scheduling request (SR) indicating whether a UE has data in the buffer of UE, link recovery request (LRR) for beam failure recovery, CSI reports enabling a gNB to select appropriate parameters for PDSCH or PDCCH transmissions to a UE, and UE initiated resource indicator (UEI-RI) indicating a request to transmit a UE initiated measurement report. HARQ-ACK information can be configured to be with a smaller granularity than per TB and can be per data code block (CB) or per group of data CBs where a data TB includes a number of data.

A CSI report from a UE can include a channel quality indicator (CQI) informing a gNB of a largest modulation and coding scheme (MCS) for the UE to detect a data TB with a predetermined block error rate (BLER), such as a 10% BLER, of a precoding matrix indicator (PMI) informing a gNB how to combine signals from multiple transmitter antennas in accordance with a multiple input multiple output (MIMO) transmission principle, and of a rank indicator (RI) indicating a transmission rank for a PDSCH. UL RS includes DMRS and SRS. DMRS is transmitted only in a BW of a respective PUSCH or PUCCH transmission. A gNB can use a DMRS to demodulate information in a respective PUSCH or PUCCH. SRS is transmitted by a UE to provide a gNB with an UL CSI and, for a TDD system, an SRS transmission can also provide a PMI for DL transmission. Additionally, in order to establish synchronization or an initial higher layer connection with a gNB, a UE can transmit a physical random-access channel (PRACH).

An antenna port is defined such that the channel over which a symbol on the antenna port is conveyed can be inferred from the channel over which another symbol on the same antenna port is conveyed.

Two antenna ports are said to be quasi co-located if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and spatial Rx parameters.

The UE (such as the UE 116) may expect that synchronization signal (SS)/PBCH block (also denoted as SSBs) transmitted with the same block index on the same center frequency location are quasi co-located with respect to Doppler spread, Doppler shift, average gain, average delay, delay spread, and, when applicable, spatial Rx parameters. The UE may not expect quasi co-location for any other synchronization signal SS/PBCH block transmissions.

In absence of CSI-RS configuration, and unless otherwise configured, the UE may expect PDSCH DM-RS and SSB to be quasi co-located with respect to Doppler shift, Doppler spread, average delay, delay spread, and, when applicable, spatial Rx parameters. The UE may expect that the PDSCH DM-RS within the same code division multiplexing (CDM) group is quasi co-located with respect to Doppler shift, Doppler spread, average delay, delay spread, and spatial Rx. The UE may also expect that DM-RS ports associated with a PDSCH are QCL with QCL type A, type D (when applicable) and average gain. The UE may further expect that no DM-RS collides with the SS/PBCH block.

In this disclosure, [DEF1] a beam is determined by either of;
A TCI state, that establishes a quasi-colocation (QCL) relationship or spatial relation between a source reference signal (e.g. SSB and/or CSI-RS) and a target reference signal
A spatial relation information that establishes an association to a source reference signal, such as SSB or CSI-RS or SRS.

Alternatively, [DEF2] a beam can be determined by any of:
A port with a static/fixed (e.g. for FR1) or dynamic virtualization (e.g. FR2, FR3), or
A port group (PG) comprising multiple ports, with a dynamic indication/assignment of one (or two) ports from the multiple ports and associated QCL property=QCL TypeD or spatial relation.

In either case, the ID of the source reference signal or the one (or two) port(s) or the TCI state ID or the spatial relation ID identifies the beam.

Alternatively, [DEF3] a beam can be determined by a pair [A, B], which is any of:

$$[ A , B ] = [ TCI state , port ]$$

$$[ A , B ] = [ TCI state , PG ]$$

$$[ A , B ] = [ Spatial relation information , port ]$$

$$[ A , B ] = [ Spatial relation information , PG ]$$

Where TCI state, Spatial relation information, port and PG are as described herein. In this case, a pair of IDs for [A, B] identifies the beam.

According to [DEF1], the TCI state and/or the spatial relation reference RS can determine a spatial Rx filter for reception of downlink channels at the UE, or a spatial Tx filter for transmission of uplink channels from the UE. The TCI state and/or the spatial relation reference RS can also determine a spatial Tx filter for transmission of downlink channels from the gNB, or a spatial Rx filter for reception of uplink channels at the gNB.

Likewise, for [DEF2], the port with dynamic virtualization and/or the PG with dynamic indication of one (or two) ports can determine a spatial Rx filter or port or PG for reception of downlink channels at the UE, or a spatial Tx filter or port or PG for transmission of uplink channels from the UE. The port with dynamic virtualization and/or the PG with dynamic indication of one (or two) ports can also determine a spatial Tx filter or a port or a PG for transmission of downlink channels from the gNB, or a spatial Rx filter or a port or a PG for reception of uplink channels at the gNB. In one example, a port can be associated with or indicated by a TCI state.

Likewise, for [DEF3], A and B together can determine a spatial Rx filter for reception of downlink channels at the UE, or a spatial Tx filter for transmission of uplink channels from the UE. They can also determine a spatial Tx filter for transmission of downlink channels from the gNB, or a spatial Rx filter for reception of uplink channels at the gNB.

In this disclosure signaling aspects are evaluated for UE (e.g., the UE 116) reporting of a measurement (e.g., RSRP) determined or obtained using a downlink signal (e.g., NZP CSI-RS) or a quantity derived from that measurement such as UL SINR or transmission channel quality indicator (TCQI) or UL modulation coding scheme (MCS) that can be used to determine the transmission parameters of an UL transmission.

FIG. 23 illustrates a signal flow of an example procedure 2300 for UL transmission according to embodiments of the present disclosure. For example, procedure 2300 can be performed by the UE 116 and the gNB 102 and/or network 130 in the wireless network 100 of FIG. 1. This example is for illustration only and other embodiments can be used without departing from the scope of the present disclosure.

The procedure begins in 2305, a UE transmits multiple multi-port SRS to a gNB and the gNB measures the channel using SRS. In 2310, the gNB signals: SRS resource indicator (SRI), RI, transmitted precoding matrix indicator (TMPI), and/or MCS for UL Tx to the UE. In 2315, the UE transmits UL Tx to the gNB based on signaled Tx parameters from gNB.

In UL, SRS can be used by the base station to measure the channel and determine the transmission parameters of UL transmissions from the UE to network (e.g., transmission parameters of PUSCH). Transmission parameters include modulation coding scheme (MCS), precoder matrix and rank.

For example, for codebook-based UL transmission in NR, as illustrated in FIG. 23, the UE is configured to transmit multiple (e.g., 2) multi-port SRS (e.g., 4-port SRS). The network measures the multiple multi-port SRS transmitted by the UE and based on the measurement determines the UL transmission parameters for UL transmissions from UE (e.g., PUSCH). This information can be signaled to the UE using a UL-related DCI Format (e.g., DCI Format 0_1 or DCI Format 0_2) that schedules the UL transmission (e.g., PUSCH). The UL-related DCI Format includes a SRS resource indicator (SRI), a rank indicator (RI), a transmission precoding matrix indicator (TMPI), and a modulation coding scheme (MCS). The TPMI is selected from a codebook. The MCS is determined based on the measurement of the SINR of the SRS. The UE transmits the UL transmission (e.g., PUSCH) using the indicated parameters.

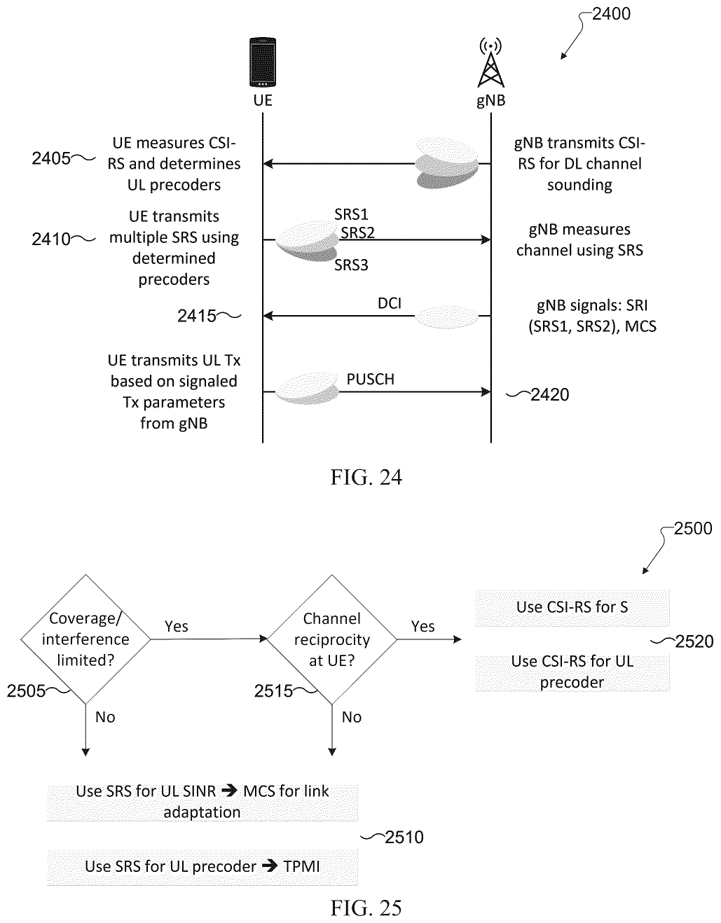

FIG. 24 illustrates a signal flow of an example procedure 2400 for UL transmission according to embodiments of the present disclosure. For example, procedure 2400 can be performed by the UE 116 and the gNB 103 and/or network 130 in the wireless network 100 of FIG. 1. This example is for illustration only and other embodiments can be used without departing from the scope of the present disclosure.

The procedure begins in 2405, a gNB transmits CSI-RS for DL channel sounding to a UE, and the UE measures CSI-RS and determines UL precoders, e.g., based on reciprocity. In 2410, the UE transmits multiple SRS using determined precoders to the gNB, and the gNB measures the channel using SRS. In 2415, the gNB signals: SRI (SRS1, SRS2), and/or MCS to the UE. In 2420, the UE transmits UL Tx to the gNB based on signaled Tx parameters from gNB.

In another example, for non-codebook-based UL transmission in NR, as illustrated in FIG. 24, the UE relies on reciprocity between its transmitter and receiver. The procedure starts with the sounding (measurement) of the DL channel using a DL signal (e.g., CSI-RS). Based on the DL measurement and channel reciprocity, the UE determines UL precoders for L layers (or beams) and transmits SRS using the selected precoders. The UE transmits L SRS (e.g., L=4) using the determined precoders. The network measures the L SRS transmitted by the UE and based on the measurement, selects a subset of the L precoders (e.g., L layers) to use for UL transmission, through a SRI bitmap signaled to the UE in a UL-related DCI format. Based on the SRS measurements, the network also determines the MCS and signals the MCS to the UE in the UL-related DCI Format. The UE transmits the UL transmission (e.g., PUSCH) using the indicated parameters.

A critical issue for NR is UL performance in coverage/interference-limited scenarios. At cell edge, performance of UL transmissions degrades more than performance of DL transmissions. Hence, measurements performed using UL signals (e.g., SRS), have a worse quality than measurements performed using DL signals (e.g., CSI-RS). The UE uses the SRS to determine the UL precoders for codebook-based UL transmission, and to determine the UL SINR, and hence the MCS, for codebook-based and non-codebook-based UL transmission. Hence, relying on SRS for coverage/interference-limited UEs leads to a poor selection of UL transmission parameters and consequently degraded performance.

To better understand the reason for the degraded performance, the UL SINR is provided. The UL SINR is given by:

$$U L S I N R = \frac{S}{I + N}$$

At cell edge or in interference or coverage limited scenarios, the signal strength, S, is much weaker than the interference and noise, I+U, making it difficult to estimate S, hence leading to an inaccurate measurement of the UL SINR and consequently the MCS used for the UL transmission. While the sum of noise and interference can be accurately measured at the gNB receiver, the signal component, S, is not accurately measured, and it would seem reasonable to determine the S using alternative methods.

One approach to increase S is to increase the UE's transmission power, however, UEs are power limited for a variety of reasons including regulations and battery life. An alternative approach is to limit the noise and interference by limiting the bandwidth of the SRS transmission, e.g., using narrow-band SRS, in this case the power spectral density of SRS increases. However, with frequency selective fading, this would require multiple narrowband SRS transmissions to measure the channel across the entire bandwidth, which increases latency and complicates network scheduling.

FIG. 25 illustrates a flow diagram of an example procedure 2500 for determining SRS/CSI-RS use according to embodiments of the present disclosure. For example, procedure 2500 can be performed by the UE 116 and/or the gNB 102 and/or network 130 in the wireless network 100 of FIG. 1. This example is for illustration only and other embodiments can be used without departing from the scope of the present disclosure.

The procedure begins in 2505, it is determined whether coverage/interference is limited. If coverage/interference is not limited, then in 2510, SRS is used for UL SINR, MCS is used for link adaptation, and SRS is used for UL precoder via TMPI. If coverage is limited, then in 2515, it is determined whether channel reciprocity is present at the UE. If channel reciprocity is not present at the UE, then 2510 is performed. If channel reciprocity is present at the UE, then in 2520, CSI-RS is used for S and CSI is used for UL precoder.

An alternative approach, when channel reciprocity holds, is to use a downlink signal (e.g., CSI-RS) to determine the S component. Unlike uplink signals (e.g., SRS), downlink signals (e.g., CSI-RS) don't suffer from the same interference issues, and the gNB can have a larger transmission power for the downlink signals than the UE for UL signals. Hence, for interference and/or coverage limited scenarios and when the UE has channel reciprocity, as illustrated in FIG. 25, the UE measures and reports the signal S, while the gNB measures the interference and noise.

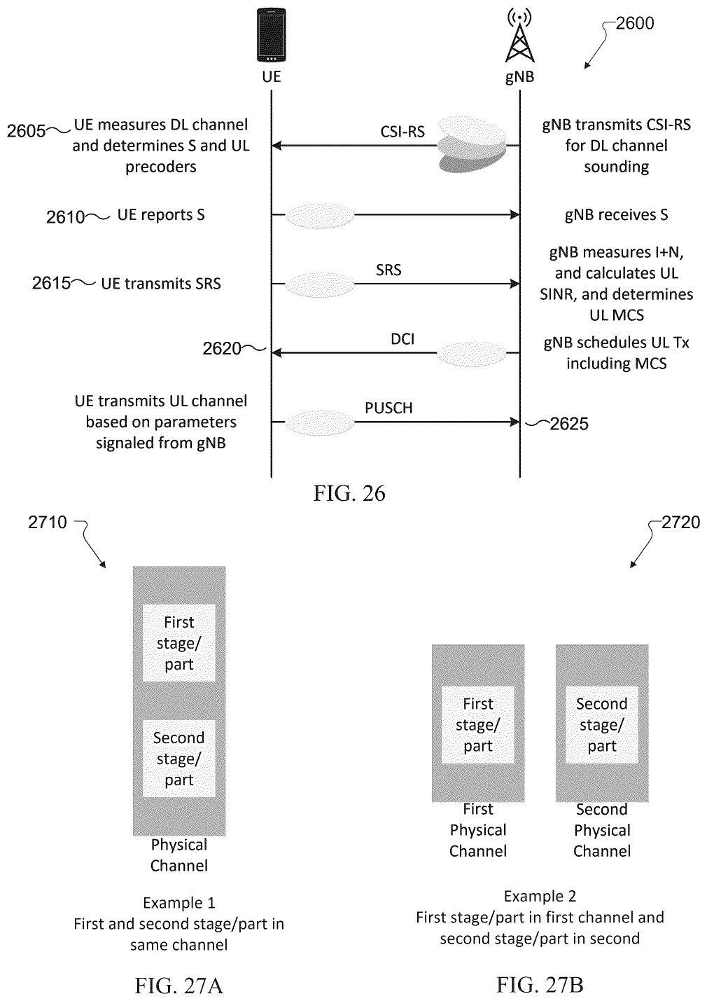

FIG. 26 illustrates a signal flow of an example procedure 2600 for UL transmission according to embodiments of the present disclosure. For example, procedure 2600 can be performed by the UE 116 and the gNB 102 and/or network 130 in the wireless network 100 of FIG. 1. This example is for illustration only and other embodiments can be used without departing from the scope of the present disclosure.

The procedure begins in 2605, a gNB transmits CSI-RS for DL channel sounding to a UE and the UE measures DL channel and determines S and UL precoders. In 2610, the UE reports S to the gNB and the gNB receives S. In 2615 the UE transmits SRS to the gNB and the gNB measures I+N, calculates UL SINR, and determines UL MCS. In 2620, the gNB transmits UL Tx including MCS to the UE. In 2625, the UE transmits an UL channel to the gNB based on parameters signaled from the gNB.

With reference to FIG. 26, an example procedure of using DL signal (e.g., CSI-RS) to assist with UL transmissions is shown. The example of FIG. 26 can be used when channel reciprocity holds at the UE and in coverage and/or interference limited scenario. The procedure of FIG. 26 starts with the gNB (e.g., the BS 102) transmitting a DL signal (e.g., CSI-RS), the UE measures the DL signal and determines (1) the signal strength S for the UL channel (based on reciprocity between UL and DL), and (2) the UL precoders for L layers (or beams) (based on reciprocity between UL and DL). The UE reports S to the gNB. The UE can transmit SRS to the gNB. The gNB measures the noise and interference, and determines the UL SINR using the measured noise and interference and the reported signal level, S, from the UE. Based on the UL-SINR, the gNB determines the MCS and signals the MCS to the UE (e.g., in an UL-related DCI Format, e.g., DCI Format 0_1 or DCI Format 0_2). The UE uses the signaled MCS and UL precoder the UE determined for its UL transmission.

In this disclosure signaling aspects are evaluated for UE reporting of a measurement (e.g., RSRP) determined or obtained using a downlink signal (e.g., NZP CSI-RS) or a quantity derived from that measurement such as UL SINR or transmission channel quality indicator (TCQI) or UL modulation coding scheme (MCS) that can be used to determine the transmission parameters of an UL transmission.

The present disclosure relates to a 5G/NR and/or 6G communication system.

This disclosure provides aspects related to UE reporting of a measurement of a DL signal (or a quantity derived from that measurement) that can be used to determine UL transmission parameters.

The following aspects are provided:
Container of UE report
Content of UE report
Timing behavior of UE report

In the following, both FDD and TDD are regarded as a duplex method for DL and UL signaling. In addition, full duplex (XDD) operation is feasible, e.g., sub-band full duplex (SBFD) or single frequency full duplex (SFFD).

Although exemplary descriptions and embodiments to follow expect orthogonal frequency division multiplexing (OFDM) or orthogonal frequency division multiple access (OFDMA), this disclosure can be extended to other OFDM-based transmission waveforms or multiple access schemes such as filtered OFDM (F-OFDM).

This disclosure provides several components that can be used in conjunction or in combination with one another, or can operate as standalone schemes.

In this disclosure, RRC signaling (e.g., configuration by RRC signaling) includes (1) common information provided by common signaling, e.g., this can be system information block (SIB)-based RRC signaling (e.g., SIB1 or other SIB) or (2) RRC dedicated signaling that is sent to a specific UE wherein the information can be common/cell-specific information or dedicated/UE-specific information or (3) UE-group RRC signaling.

In this disclosure MAC CE signaling can be UE-specific e.g., to one UE or can be UE common (e.g., to a group of UEs or to all UEs in a cell). MAC CE signaling can be DL MAC CE signaling or UL MAC CE signaling.

In this disclosure L1 control signaling includes: (1) DL control information (e.g., DCI on PDCCH or DL control information on PDSCH) and/or (2) UL control information (e.g., UCI on PUCCH or PUSCH). L1 control signaling can be UE-specific e.g., to one UE or can be UE common (e.g., to a group of UEs or all UEs in a cell).

In this disclosure, configuration can refer to configuration by semi-static signaling (e.g., RRC or SIB signaling). In one example, a configuration can be applicable to multiple transmission instances, until a configuration is received and applied.

In this disclosure, indication can refer to indication by dynamic signaling (e.g., L1 control (e.g., DCI Format) or MAC CE signaling). In one example, an indication can be for an associated occasion(s) (e.g., an occasion or multiple occasions associated with the indication).

In this disclosure a list with N elements can be denoted as L(i), where i can take N values, and L(i) can correspond to the element or entry associated with index i. In one example, i can take N arbitrary values. In one example, i=0, 1, . . . , N−1. In one example, i=1, 2, . . . , N. In one example, i is an identity of an element in the list.

In the present disclosure, the term “activation” describes an operation wherein a UE receives and decodes first information provided by a first signal from the network (or gNB) and based on the first information, the UE determines a starting point in time. The starting point can be a present or a future slot/subframe or symbol and the exact location is either implicitly or explicitly indicated, or is otherwise defined in the system operation or is configured by higher layers. Upon successfully decoding the first information, the UE responds according to an indication provided by the first information. The term “deactivation” describes an operation wherein a UE receives and decodes second information provided by a second signal from the network (or gNB) and based on the second information from the signal, the UE determines a stopping point in time. The stopping point can be a present or a future slot/subframe or symbol and the exact location is either implicitly or explicitly indicated, or is otherwise defined in the system operation or is configured by higher layers. Upon successfully decoding the second information, the UE responds according to an indication provided by the second information. The first signal can be same as the second signal or the first information can be same as the second information, wherein a first part of the information can be associated with an “activation” operation and with first UEs or with first parameters for transmissions/receptions by a UE, and a second part of the information can be associated with a “deactivation” operation and with second UEs or with second parameters for transmissions/receptions by the UE. For example, the second information can be absent, and deactivation can be implicitly derived. For example, when a UE has received an activation information in a previous indication, and is not included among UEs with activation information in a next indication, the UE can determine the latter indication as an implicit deactivation indication.

In this disclosure, a time unit, for example, can be a symbol or a slot or sub-frame or a frame. In one example, a time-unit can be multiple symbols, or multiple slots or multiple sub-frames or multiple frames. In one example, a time-unit can be a sub-slot (e.g., part of a slot). In one example, a time-unit can be specified in units of time, e.g., microseconds, or milliseconds or seconds, etc.

In this disclosure, a frequency-unit, for example, can be a sub-carrier or a resource block (RB) or a sub-channel, wherein a sub-channel is a group or RBs, or a bandwidth part (BWP). In one example, a frequency-unit can be multiple sub-carriers, or multiple RBs or multiple sub-channels. In one example, a frequency-unit can be a sub-RB (e.g., part of a RB). A frequency-unit can be specified in units of frequency, e.g., Hz, or kHz or MHz, etc.

Terminology such as TCI, TCI states, SpatialRelationInfo, target RS, reference RS, and other terms is used for illustrative purposes and is therefore not normative. Other terms that refer to same functions can also be used.

A “reference RS” (e.g., reference source RS) corresponds to a set of characteristics of a DL beam or an UL TX beam, such as a direction, a precoding/beamforming, a number of ports, and so on. For instance, the UE can receive a source RS index/ID in a TCI state assigned to (or associated with) a DL transmission (and/or UL transmission), the UE applies the known characteristics of the source RS to the assigned DL transmission (and/or UL transmission). The source RS can be received and measured by the UE (in this case, the source RS is a downlink measurement signal such as NZP CSI-RS and/or SSB) with the result of the measurement used for calculating a beam report (e.g., including at least one L1-RSRP/L1-SINR accompanied by at least one CRI or SSBRI). As the NW/gNB receives the beam report, the NW can be better equipped with information to assign a particular DL (and/or UL) TX beam to the UE. Optionally or alternatively, the source RS can be transmitted by the UE (in this case, the source RS is an uplink measurement signal such as SRS). As the NW/gNB receives the source RS, the NW/gNB can measure and calculate the needed information to assign a particular DL (or/and UL) TX beam to the UE.

In one example, when selecting K elements from set S1 with N elements, there are

$$( \begin{matrix}N \\ K\end{matrix} )$$

choices. A unique combinatorial index can be found for subset S2 {a₀, a₁, . . . , a_{K-1}}, where aₖ for k=0, 1, . . . , K−1, corresponds to an element of set S1 (e.g., an index of an element in set S1 in the range 0, 1, . . . , N−1). If a₀, a₁, . . . , a_{K-1} are arrange in subset S2 such that a₀>a₁> . . . >a_{K2-1}, the index of subset S2 is given by:

$${\sum }_{k = 0}^{K - 1} 〈 \begin{matrix}{a}_{k} \\ K - k\end{matrix} 〉 ,$$

where

$$〈 \begin{matrix}x \\ y\end{matrix} 〉 = \{ \begin{matrix}( \begin{matrix}x \\ y\end{matrix} ) & x \geq y \\ 0 & otherwise\end{matrix}$$

$$( \begin{matrix}x \\ y\end{matrix} ) = \frac{x !}{( x - y ) ! y !}$$

In one example, the device selecting K elements out of N elements, can indicate the number K and a combinatorial index for the selection of K out N elements. In one example, K can be determined by configuration and the device selecting K elements out of N elements indicates the combinatorial index for the selection of K out N elements.

In one example, the UE report containing signal level (or strength) S can be transmitted on PUSCH. In one example, the PUSCH can be a dynamically scheduled PUSCH (e.g., scheduled by a UL-related DCI Format, e.g., DCI Format 0_0 or DCI Format 0_1 or DCI Format 0_2 in NR, or DCI Format X in general where X is a format number that is used to schedule PUSCH). In one example, the PUSCH can be a configured grant (CG) PUSCH (e.g., Type 1 configured grant and/or Type 2 configured grant in NR, or Type Y configured grant in general where Y is a type of the configured grant PUSCH). For example, Type-1 CG PUSCH is configured by RRC and becomes activated when configured. For example, Type-2 CG PUSCH is configured by RRC but is de-activated when configured, dynamical signaling (e.g., MAC CE or DCI Format) can activate or deactivate Type-2 CG PUSCH.

In one example, the UE report containing signal level (or strength) S can be transmitted on PUCCH.

In one example, the UE report containing signal level (or strength) S can be transmitted on RACH, wherein e.g. RACH can be Type 1 RACH and/or Type 2 RACH in NR or Type Z RACH in general where Z is a type of the RACH. Furthermore, RACH can be contention based random access (CBRA) and/or contention free random access (CFRA). Furthermore, RACH can be triggered by higher layers or triggered by a PDCCH order.

In one example, the UE report containing signal level (or strength) S can be a one-part (or one stage).

In one example, the UE report containing signal level (or strength) S can be a one-part (or one stage) where the one-part is part 1 of a multi-stage UCI (e.g. two-stage UCI with part 1 and part 2).

In one example, the UE report containing signal level (or strength) S can be a two-part (or two-stage) report, for example the first part can have a fixed size, and it can provide information about the size and/or content of the second part. In one example, the first part includes an indicator/parameter indicating a number (Y) of reported value(s) for S, and the second part includes indicator(s) indicating the Y value(s). In one example, the value of Y can be 0, indicating that there is no report to transmit. In one example, the min value of Y is 1.

In one example, the first part includes (1) indicator(s) indicating Y₁ value(s) for S, and an indicator/parameter indicating a remaining number (Y₂) of reported value(s) for S, and the second part includes indicator(s) indicating the Y₂ value(s). In one example, the value of Y₂ can be 0, indicating that there is no remaining report to transmit. In one example, the min value of Y₂ is 1. In one example, the value of Y₁ is fixed, e.g. 1, or configured, e.g. from {0, 1, . . . }, or reported by the UE.

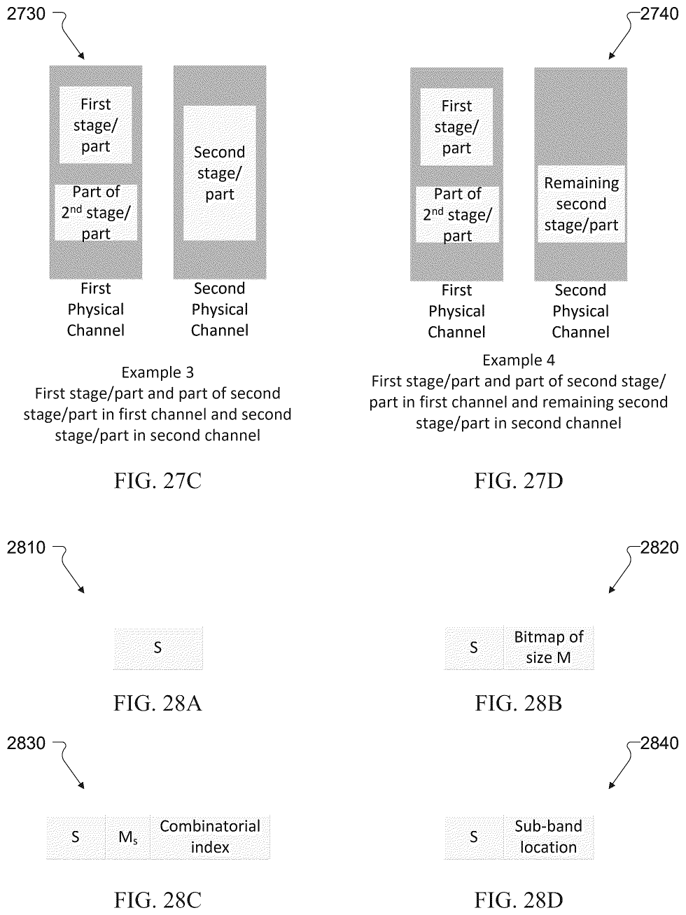

FIGS. 27A, 27B, 27C, and 27D illustrate example two-part UE reports 2710, 2720, 2730, and 2740, respectively, according to embodiments of the present disclosure. For example, two-part UE reports 2710, 2720, 2730, and 2740 can be reported by any of the UEs 111-116 of FIG. 1. This example is for illustration only and other embodiments can be used without departing from the scope of the present disclosure.

In one example, the first part/stage and the second part/stage are transmitted in same channel, e.g., PUSCH or PUCCH or RACH, as illustrated in FIG. 27(A). In one example, the first part/stage is transmitted in a first channel, e.g., PUSCH or PUCCH or RACH, and the second part/stage is transmitted in a second channel, e.g., PUSCH or PUCCH or RACH, as illustrated in FIG. 27(B). In one example, the first part/stage and part of the second part/stage is transmitted in a first channel, e.g., PUSCH or PUCCH or RACH, and the second part/stage (or the remaining part of the second part/stage) is transmitted in a second channel, e.g., PUSCH or PUCCH or RACH, as illustrated in FIG. 27(C) and FIG. 27(D).

In one example, the UE report containing signal level (or strength) S can be included in a medium access control-control element (MAC CE). In one example, the UE report containing signal level (or strength) S can be included in a uplink control information (UCI). In one example, the UE report containing signal level (or strength) S is a two-part or two-stage report, wherein the first part or the first stage is included in a (first-stage) MAC CE and the second stage, or second part is included in a (second-stage) MAC CE. In one example, the UE report containing signal level (or strength) S is a two-part or two-stage report, wherein the first part or the first stage is included in a (first-stage) UCI and the second stage, or second part is included in a (second-stage) UCI. In one example, the UE report containing signal level (or strength) S is a two-part or two-stage report, wherein the first part or the first stage is included in a UCI and the second stage, or second part is included in a MAC CE. In one example, the UE report containing signal level (or strength) S is a two-part or two-stage report, wherein the first part or the first stage is included in a MAC CE and the second stage, or second part is included in a UCI.

In one example, the UE report containing signal level (or strength) S can be combined with other CSI or UCI parameters. In one example, the UE report containing signal level (or strength) S can be combined with UL-SCH data.

In one example, the report from the UE can include the signal level measured by the UE (e.g., reference signal received power (RSRP) represented as signal level S). In one example, the signal level can be the signal level of the NZP CSI-RS received by the UE to measure the channel. In one example, the network can indicate the UL interference/to the UE, or the sum of the UL interference and noise (I+N) to the UE, based on the measurement of the signal level of the NZP CSI-RS and the indicated interference (or interference+noise), the UE can calculate the UL SINR and report the UL SINR to the gNB.

In one example, the network can indicate the UL interference/to the UE, or the sum of the UL interference and noise (I+N) to the UE, based on the measurement of the signal level of the NZP CSI-RS and the indicated interference (or interference+noise), the UE can calculate the UL SINR, based on the UL SINR the UE can calculate the Transmit Channel Quality Information (TCQI) and report the TCQI to the gNB.

In one example, the network (e.g., the network 130) can indicate the UL interference/to the UE, or the sum of the UL interference and noise (I+N) to the UE, based on the measurement of the signal level of the NZP CSI-RS and the indicated interference (or interference+noise), the UE can calculate the UL SINR, based on the UL SINR the UE can calculate the UL modulation coding scheme (MCS) and report the UL MCS to the gNB.

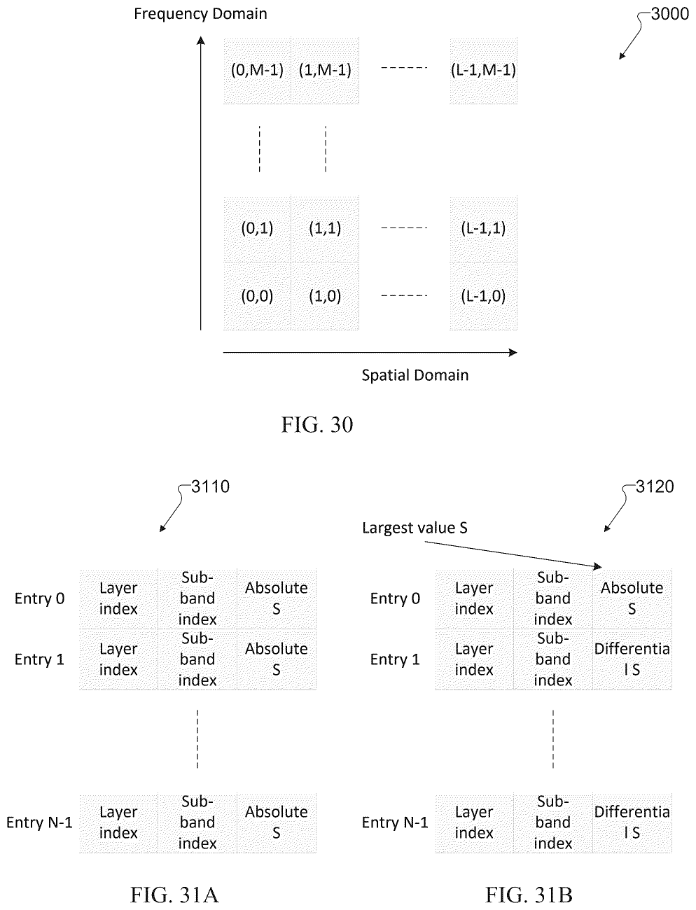

In one example, the UE can measure/determine the signal S of the NZP CSI-RS per spatial layer and per sub-band as described later in this disclosure and illustrated in FIG. 30. The UE can report the value of S per spatial layer/sub-band pair as described later in this disclosure. In one example, the UE can report UL SINR per spatial layer/sub-band pair. In one example, the UE can report TCQI per spatial layer/sub-band pair. In one example, the UE can report UL MCS per spatial layer/sub-band pair.

In one example, the UE can measure/determine the signal S of the NZP CSI-RS per spatial layer. The UE can report the value of S per spatial layer as described later in this disclosure. In one example, the UE can report UL SINR per spatial layer. In one example, the UE can report TCQI per spatial layer. In one example, the UE can report UL MCS per spatial layer. In one example, the UE can indicate Mₛ sub-bands of the M sub-bands preferred for a spatial layer. As described later in this disclosure.

In one example, the UE can measure/determine the signal S of the NZP CSI-RS per sub-band. The UE can report the value of S per sub-band. In one example, the UE can report UL SINR per sub-band. In one example, the UE can report TCQI per sub-band. In one example, the UE can report UL MCS per sub-band. In one example, the UE can indicate Lₛ layers of the L layers preferred for a sub-band. For example, the indication can be by a bitmap or by a combinatorial index indicating Lₛ out of L.

In the following examples, the signal level S, or UL SINR or TCQI or UL MCS can be represented as an absolute value. In the following examples, the signal level S, or UL SINR or TCQI or UL MCS can be represented as a differentiation value, e.g., relative to the value of the first entry (e.g., entry with the largest value of the quality), or relative to the value of the previous entry in the list. For signal level S (e.g., RSRP) or UL SINR, the differential value can be in steps of d dB (for example d=2 dB). For TCQI or UL MCS, the differential value can be in relative index, e.g., in steps of d index (for example, d=2 or d=1), as an example, if the first entry has index (for TCQI or UL MCS) 14, and a second entry has a differential value of 3, the index (for TCQI or UL MCS) of the second entry is 14−3×2=8, when d=2.

In the following examples, signal S can be replaced by RSRP or UL SINR or TCQI or UL MCS or any combination of RSRP or UL SINR or TCQI or UL MCS. For brevity only signal S is used.

In one example, based on the measurement on the DL signal (e.g. NZP CSI-RS), the UE (e.g., the UE 116) determines the UL precoder vectors for L layers. In one example, L=1, e.g., for rank 1 operation/uplink transmissions. In one example, L can be larger than 1, e.g., for rank greater than 1.

In the following examples, the value of S can be reported in dB or in dBm. In one example, the range of S [−140, −44] dBm, with a step size of 1 dB. In one example, S is represented by 7 bits.

FIGS. 28A, 28B, 28C, and 28D illustrate example UE reports 2810, 2820, 2830, and 2840, respectively, according to embodiments of the present disclosure. For example, UE reports 2810, 2820, 2830, and 2840 can be reported by the UE 116 of FIG. 3. This example is for illustration only and other embodiments can be used without departing from the scope of the present disclosure.

In one example, with L=1, the UE measures and reports a single value for S. In one example, the reported value for S is across (or common for) sub-bands, the UE report includes S as illustrated in FIG. 28(A). In one example, the reported value for S is (common) across Mₛ sub-bands of M sub-bands. In one example, the UE can indicate the Mₛ sub-bands using a bitmap of size M, the UE report includes S and bitmap as illustrated in FIG. 28(B). In one example, the UE can indicate the Mₛ sub-bands as a combinatorial index mentioned herein. In one example, the UE report can include S, field of size ┌log₂ M┐ or ┌log₂(M+1)┐ to indicate Mₛ and a combinatorial index as illustrated in FIG. 28(C). In one example, the UE can indicate the Mₛ sub-bands as a combinatorial index, as aforementioned, wherein the number the number of sub-bands is determined based on a rule (e.g., specified in the specifications), or configured by higher layers. In one example, Mₛ=1. In one example, Mₛ=1, and the UE indicates the sub-band location using a bit-field of size ┌log₂ M┐. In one example, the UE report can include S, field of size ┌log₂ M┐ for the sub-band location as illustrated in FIG. 28(D). In one example, for each of

$$k = \frac{M}{{M}_{s}}$$

(groups of) SBs, (i.e. one value for each (groups of) SB of size Mₛ sub-bands (e.g., consecutive or non-consecutive sub-bands)), the UE measures and reports a value (S={s₁ . . . sₖ}). Hence, there is no need for any additional indication of sub-band(s).

In one example, with L>1, the UE measures and reports a single value for S. In one example, the reported value for S is (common) across layers and across sub-bands, the UE report includes S as illustrated in FIG. 28(A). In one example, the reported value for S is (common) across layers and across Mₛ sub-bands of M sub-band. In one example, the UE can indicate the Mₛ sub-bands using a bitmap of size M, the UE report includes S and bitmap as illustrated in FIG. 28(B). In one example, the UE can indicate the Mₛ sub-bands as a combinatorial index, mentioned herein. In one example, the UE report can include S, field of size ┌log₂ M┐ or ┌log₂(M+1)┐ to indicate Mₛ and a combinatorial index as illustrated in FIG. 28(C). In one example, the UE can indicate the Mₛ sub-bands as a combinatorial index, as aforementioned, wherein the number the number of sub-bands is determined based on a rule (e.g., specified in the specifications), or configured by higher layers. In one example, Mₛ=1. In one example, Mₛ=1, and the UE indicates the sub-band location using a bit-field of size ┌log₂ M┐. In one example, the UE report can include S, field of size ┌log₂ M┐ for the sub-band location as illustrated in FIG. 28(D). In one example, for each of

$$k = \frac{M}{{M}_{s}}$$

(groups of) SBs of size Mₛ sub-bands (e.g., consecutive or non-consecutive sub-bands), (i.e. one value for each (groups of) SB), the UE measures and reports a value (S={s₁ . . . sₖ}). Hence, there is no need for any additional indication of sub-band(s).

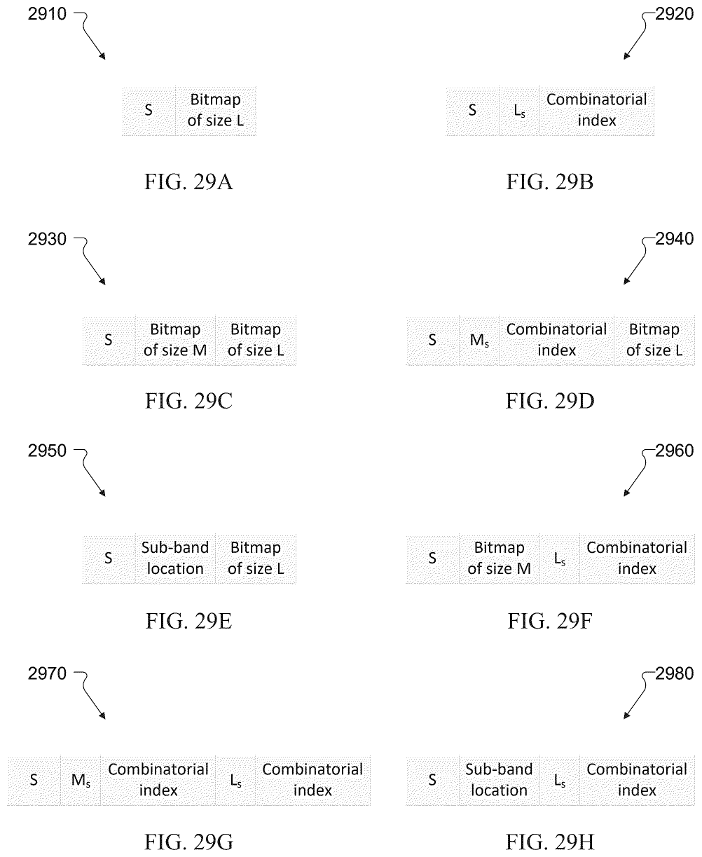

FIGS. 29A, 29B, 29C, 29D, 29E, 29F, 29G, and 29H illustrate example UE reports 2910, 2920, 2930, 2940, 2950, 2960, 2970, and 2980, respectively, according to embodiments of the present disclosure. For example, UE reports 2910, 2920, 2930, 2940, 2950, 2960, 2970, and 2980 can be reported by any of the UEs 111-116 of FIG. 1, such as the UE 116. This example is for illustration only and other embodiments can be used without departing from the scope of the present disclosure.

In one example, with L>1, the UE measures and reports a single value for S. In one example, the reported value for S is across Lₛ layers, wherein the Lₛ layers are the first Lₛ layers of the L layers, and across sub-bands, the UE report includes S as illustrated in FIG. 28(A). In one example, the reported value for S is across Lₛ layers, wherein the Lₛ layers are provided by a bitmap of size L, the UE report includes S and a bitmap of size L as illustrated in FIG. 29(A). In one example, the reported value for S is across Lₛ layers, wherein the Lₛ layers are provided by a combinatorial index, the UE report includes S, a field of size ┌log₂ L┐ or ┌log₂(L+1)┐ to indicate Lₛ and a combinatorial index as illustrated in FIG. 29(B). In one example, Lₛ=1. In one example, the number of Lₛ is determined based on a rule (e.g., specified in the specifications), or configured by higher layers.

In one example, for each of

$$z = \frac{L}{{L}_{s}}$$

(groups of) layers of size Lₛ layers (e.g., consecutive or non-consecutive layers), (i.e. one value for each (groups of) layers), the UE measures and reports a value (S={s₁ . . . s_{z}}). Hence, there is no need for any additional indication of layer(s).

In one example, the reported value for S is across Lₛ layers, wherein the Lₛ layers are the first Lₛ layers of the L layers, and across Mₛ sub-bands of M sub-band. In one example, the UE can indicate the Mₛ sub-bands using a bitmap of size M, the UE report includes S and bitmap as illustrated in FIG. 28(B). In one example, the UE can indicate the Mₛ sub-bands as a combinatorial index, mentioned herein. In one example, the UE report can include S, field of size ┌log₂ M┐ or ┌log₂(M+1)┐ to indicate Mₛ and a combinatorial index as illustrated in FIG. 28(C). In one example, the number of Mₛ is determined based on a rule (e.g., specified in the specifications), or configured by higher layers. In one example, Mₛ=1. In one example, Mₛ=1, and the UE indicates the sub-band location using a bit-field of size ┌log₂ M┐. In one example, the UE report can include S, field of size ┌log₂ M┐ for the sub-band location as illustrated in FIG. 28(D). In one example, Lₛ=1. In one example, for each of

$$k = \frac{M}{{M}_{s}}$$

(groups of) SBs, (i.e. one value for each (groups of) SB of size Mₛ sub-bands (e.g., consecutive or non-consecutive sub-bands)), the UE measures and reports a value (S={s₁ . . . sₖ}). Hence, there is no need for any additional indication of sub-band(s). In one example, for each of

$$z = \frac{L}{{L}_{s}}$$

(groups of) layers, (i.e. one value for each (groups of) layers of size Lₛ layers (e.g., consecutive or non-consecutive layers)), the UE measures and reports a value (S={s₁ . . . s_{z}}). Hence, there is no need for any additional indication of layer(s).

In one example, the reported value for S is across Lₛ layers, wherein the Lₛ layers wherein the Lₛ layers are provided by a bitmap of size L, and across Mₛ sub-bands of M sub-band. In one example, the UE can indicate the Mₛ sub-bands using a bitmap of size M, the UE report includes S and a bitmap of size M for the sub-bands and a bitmap of size L for the layers as illustrated in FIG. 29(C). In one example, the UE can indicate the Mₛ sub-bands as a combinatorial index, mentioned herein. In one example, the UE report can include S, field of size ┌log₂ M┐ or ┌log₂(M+1)┐ to indicate Mₛ and a combinatorial index for the sub-bands and a bitmap of size L for the layers as illustrated in FIG. 29(D). In one example, the number of Mₛ is determined based on a rule (e.g., specified in the specifications), or configured by higher layers. In one example, Mₛ=1. In one example, Mₛ=1, and the UE indicates the sub-band location using a bit-field of size ┌log₂ M┐. In one example, the UE report can include S, field of size ┌log₂ M┐ for the sub-band location and a bitmap of size L for the layers as illustrated in FIG. 29(E). In one example, Lₛ=1. In one example, for each of

$$k = \frac{M}{{M}_{s}}$$

(groups of) SBs, (i.e. one value for each (groups of) SB of size Mₛ sub-bands (e.g., consecutive or non-consecutive sub-bands)), the UE measures and reports a value (S={s₁ . . . sₖ}). Hence, there is no need for any additional indication for sub-band(s). In one example, for each of

$$z = \frac{L}{{L}_{s}}$$

(groups of) layers, (i.e. one value for each (groups of) layers of size Lₛ layers (e.g., consecutive or non-consecutive layers)), the UE measures and reports a value (S={s₁ . . . s_{z}}). Hence, there is no need for any additional indication for layer(s).

In one example, the reported value for S is across Lₛ layers, wherein the Lₛ layers wherein the Lₛ layers are provided by a combinatorial index, and across Mₛ sub-bands of M sub-band. In one example, the UE can indicate the Mₛ sub-bands using a bitmap of size M, the UE report includes S and a bitmap of size M for the sub-bands and a field of size ┌log₂ L┐ or ┌log₂(L+1)┐ to indicate Lₛ and a combinatorial index for the layers as illustrated in FIG. 29(F). In one example, the number of Lₛ is determined based on a rule (e.g., specified in the specifications), or configured by higher layers. In one example, the UE can indicate the Mₛ sub-bands as a combinatorial index, mentioned herein. In one example, the UE report can include S, field of size ┌log₂ M┐ or ┌log₂(M+1)┐ to indicate Mₛ and a combinatorial index for the sub-bands and a field of size ┌log₂ L┐ or ┌log₂(L+1)┐ to indicate Lₛ and a combinatorial index for the layers as illustrated in FIG. 29(G). In one example, the number of Mₛ is determined based on a rule (e.g., specified in the specifications), or configured by higher layers. In one example, the number of Lₛ is determined based on a rule (e.g., specified in the specifications), or configured by higher layers. In one example, Mₛ=1. In one example, Mₛ=1, and the UE indicates the sub-band location using a bit-field of size ┌log₂ M┐. In one example, the UE report can include S, field of size ┌log₂ M┐ for the sub-band location and a field of size ┌log₂ L┐ or ┌log₂(L+1)┐ to indicate Lₛ and a combinatorial index for the layers as illustrated in FIG. 29(H). In one example, the number of Lₛ is determined based on a rule (e.g., specified in the specifications), or configured by higher layers. In one example, Lₛ=1. In one example, for each of

$$k = \frac{M}{{M}_{s}}$$

(groups of) SBs, (i.e. one value for each (groups of) SB of size Mₛ sub-bands (e.g., consecutive or non-consecutive sub-bands)), the UE measures and reports a value (S={s₁ . . . sₖ}). Hence, there is no need for any additional indication for sub-band(s). In one example, for each of

$$z = \frac{L}{{L}_{s}}$$

(groups of) layers, (i.e. one value for each (groups of) layers of size Lₛ layers (e.g., consecutive or non-consecutive layers)), the UE measures and reports a value (S={s₁ . . . s_{z}}). Hence, there is no need for any additional indication for layer(s).

FIG. 30 illustrates example spatial layers and sub-bands 3000 according to embodiments of the present disclosure. For example, spatial layers 3000 can be utilized by any of the UEs 111-116 of FIG. 1, such as the UE 115. This example is for illustration only and other embodiments can be used without departing from the scope of the present disclosure.

FIGS. 31A and 31B illustrate example entries 3110 and 3120 according to embodiments of the present disclosure. For example, entries 3110 and 3120 can be utilized by any of the UEs 111-116 of FIG. 1, such as the UE 114. This example is for illustration only and other embodiments can be used without departing from the scope of the present disclosure.

With reference to FIG. 30, an example of layers in the spatial domain and sub-bands in the frequency domain is shown. In one example, the UE can measure S for layer/sub-band pairs.

In one example, the UE reports S for N or for up to N layer/sub-band pairs. In one example, each of the N or up to N entries includes layer index as a field of size ┌log₂ L┐, sub-band index as a field of size ┌log₂ M┐ and S e.g., as field of size 7 bits for absolute value of S, as illustrated in FIG. 31(A). In one example, the first entry corresponds to the layer/sub-band pair with the largest value of S, the first entry includes layer index as a field of size ┌log₂ L┐, sub-band index as a field of size ┌log₂ M┐ and S e.g., as field of size b₁ e.g., 7 bits for absolute value of S, the remaining N−1 entries include layer index as a field of size ┌log₂ L┐, sub-band index as a field of size ┌log₂ M┐ and S e.g., as field of size b₂, e.g. 4 bits for differential signal of that entry compared to the first entry that has largest signal level in step of d dB, e.g., 2 dB as illustrate in FIG. 31(B). In a variant example, the differential signal for entry i can be relative to the signal of entry i−1.

In one example, the mapping order of the fields in the report can be: Layer Index (0), Layer Index (1), . . . , Layer Index (N−1), Sub-band Index (0), Sub-band Index (1), . . . , Sub-band Index (N−1), S(0), S(1), . . . , S(N−1). Wherein, S(0), S(1), . . . , S(N−1) can be differential or absolute mentioned herein.

In one example, the mapping order of the fields in the report can be: Sub-band Index (0), Sub-band Index (1), . . . , Sub-band Index (N−1), Layer Index (0), Layer Index (1), . . . , Layer Index (N−1), S(0), S(1), . . . , S(N−1). Wherein, S(0), S(1), . . . , S(N−1) can be differential or absolute mentioned herein.

In one example, the mapping order of the fields in the report can be: Layer Index (0), Sub-band Index (0), Layer Index (1), Sub-band Index (1), . . . , Layer Index (N−1), Sub-band Index (N−1), S(0), S(1), . . . , S(N−1). Wherein, S(0), S(1), . . . , S(N−1) can be differential or absolute mentioned herein.

In one example, the mapping order of the fields in the report can be: Sub-band Index (0), Layer Index (0), Sub-band Index (1), Layer Index (1), . . . , Sub-band Index (N−1), Layer Index (N−1), S(0), S(1), . . . , S(N−1). Wherein, S(0), S(1), . . . , S(N−1) can be differential or absolute mentioned herein.

In one example, the mapping order of the fields in the report can be: Layer Index (0), Sub-band Index (0), S(0), Layer Index (1), Sub-band Index (1), S(1) . . . , Layer Index (N−1), Sub-band Index (N−1), S(N−1). Wherein, S(0), S(1), . . . , S(N−1) can be differential or absolute mentioned herein.

In one example, the mapping order of the fields in the report can be: Sub-band Index (0), Layer Index (0), S(0), Sub-band Index (1), Layer Index (1), S(1), . . . , Sub-band Index (N−1), Layer Index (N−1), S(N−1). Wherein, S(0), S(1), . . . , S(N−1) can be differential or absolute mentioned herein.

In the examples mentioned herein, the Layer Index can have a value from 0 to L−1, can be indicated by a field of size ┌log₂ L┐.

In the examples mentioned herein, the Sub-band Index can have a value from 0 to M−1, can be indicated by a field of size ┌log₂ M┐.

In a variant example, a combined index can be used for Layer and sub-band, with a value from 0 to L×M−1, and can be indicated by a field of size ┌log₂(L×M)┐. In one example, the combined index for layer and sub-band is obtained by first counting over sub-bands, then counting over layers. In an alternative example, the combined index for layer and sub-band is obtained by first counting over layers, then counting over sub-bands.

In one example, the mapping order of the fields in the report can be: Sub-band-Layer Index (0), Sub-band-Layer Index (1), . . . , Sub-band-Layer Index (N−1), S(0), S(1), . . . , S(N−1). Wherein, S(0), S(1), . . . , S(N−1) can be differential or absolute mentioned herein.

In one example, the mapping order of the fields in the report can be: Sub-band-Layer Index (0), S(0), Sub-band-Layer Index (1), S(1) . . . , Sub-band-Layer Index (N−1), S(N−1). Wherein, S(0), S(1), . . . , S(N−1) can be differential or absolute mentioned herein.

In the examples mentioned herein, N can be specified in the system specifications, or configured or updated by SIB and/or RRC and/or MAC CE and/or L1 control (e.g., DCI Format) signaling.

In the examples mentioned herein, the value of N can be included in the report. In one example, N can be included or signaled in a first part/stage report. In one example, the first part/stage includes information to determine the size of the second part/stage of the report. In one example, the first part/stage report includes the value N and N₁ of the N entries, wherein N₁ can be specified in the system specifications, or configured or updated by SIB and/or RRC and/or MAC CE and/or L1 control (e.g., DCI Format) signaling. In one example, the second part/stage report includes the remaining entries (e.g., N−N₁ entries). In one example, the second part/stage report includes N entries. In one example, N₁=0. In one example, N₁=1 (e.g., the entry with the largest value of S).

Other mapping order of the fields are also feasible through various permutations of the ordering of the fields.

In a variant example, the UE can report the signal S for Lₛ (or up to Lₛ) layers and Mₛ (or up to Mₛ) sub-band of each of the Lₛ or up to Lₛ layers. The report can include N or up to N entries where N=Lₛ×Mₛ.
In one example, the entries N are order over the Mₛ sub-bands first followed by ordering over the Lₛ layers, for example: Mₛ sub-bands for a first layer followed by Mₛ sub-bands for a second layer and so on. In one example, the first layer and first sub-band of a reported pair has the largest S. In one example, the first reported sub-band of a layer has the largest S of that layer.
In one example, the entries N are order over the Lₛ layers first followed by ordering over the Mₛ sub-bands, for example: Lₛ layers for a first sub-band followed by Lₛ layers for a second sub-band and so on. In one example, the first layer and first sub-band pair has the largest S. In one example, the first layer and first sub-band of a reported pair has the largest S. In one example, the first reported layer of a sub-band has the largest S of that sub-band.

Signal S can be according to the following examples:
In one example, the signal S for each Layer Index/Sub-band Index pair or Sub-band-Layer Index is an absolute value.
In one example, the signal S for the first Layer Index (Index 0) and the first Sub-Band Index (Index 0) is an absolute value. The signal S for the remaining entries is a differential value. In one example, the differential value is relative to the first entry with Layer Index 0 and Sub-band Index 0. In one example, the differential value is relative to previous entry based on the ordering of entries.

In one example, the signal S of the first entry of each layer (e.g., with Sub-band Index 0) is an absolute value, the signal S for the remaining entries for each layer are differential values. In one example, the differential value is relative to the first entry of that layer (e.g., entry with Sub-band Index=0 for that layer). In one example, the differential value is relative to previous entry (e.g., previous sub-band index) in that layer.
In one example, the signal S for the first Layer Index (Index 0) and the first Sub-Band Index (Index 0) is an absolute value. The first entry of the remaining layers (e.g., with Sub-band Index 0 for the corresponding layer) is a differential value. In one example, the differential value is relative to the first entry with Layer Index 0 and Sub-band Index 0. In one example, the differential value is relative to the first entry (e.g., with Sub-band Index 0) of the previous layer. In one example, the signal S for the remaining entries for each layer are differential values. In one example, the differential value is relative to the first entry of that layer (e.g., entry with Sub-band Index=0 for that layer). In one example, the differential value is relative to previous entry (e.g., previous Sub-band Index) in that layer.
In one example, the signal S of the first entry of each sub-band (e.g., with Layer Index 0) is an absolute value, the signal S for the remaining entries for each sub-band are differential values. In one example, the differential value is relative to the first entry of that sub-band (e.g., entry with Layer Index=0 for that sub-band). In one example, the differential value is relative to previous entry (e.g., previous layer index) in that sub-band.
In one example, the signal S for the first Layer Index (Index 0) and the first Sub-band Index (Index 0) is an absolute value. The first entry of the remaining sub-band (e.g., with Layer Index 0 for the corresponding sub-band) is a differential value. In one example, the differential value is relative to the first entry with Layer Index 0 and Sub-band Index 0. In one example, the differential value is relative to the first entry (e.g., with Layer Index 0) of the previous sub-band. In one example, the signal S for the remaining entries for each sub-band are differential values. In one example, the differential value is relative to the first entry of that sub-band (e.g., entry with Layer Index=0 for that sub-band). In one example, the differential value is relative to previous entry (e.g., previous Layer Index) in that sub-band.

In one example, the UE can report the signal for Ls (or up to Ls) layers and Ms (or up to Ms) sub-band of each of the Ls or up to Ls layers, wherein N=Lₛ×Mₛ, and the content of the report is mentioned herein for a report with N entries.

In one example, the mapping order of the fields in the report can be:
Layer Index (0), Sub-band Index (0), Sub-band Index (1), . . . , Sub-band Index (Mₛ−1) for Layer Index (0).
Layer Index (1), Sub-band Index (0), Sub-band Index (1), . . . , Sub-band Index (Mₛ−1) for Layer Index (1).
. . .
Layer Index (Lₛ−1), Sub-band Index (0), Sub-band Index (1), . . . , Sub-band Index (Mₛ−1) for Layer Index (Lₛ−1).
S(0), S(1), . . . , S(N−1) according to the order of respective signaled sub-band indices in layer indices. Wherein, S(0), S(1), . . . , S(N−1) can be differential or absolute mentioned herein.

In one example, the mapping order of the fields in the report can be:
Layer Index (0), Layer Index (1), . . . , Layer Index (Lₛ−1)
Sub-band Index (0), Sub-band Index (1), . . . , Sub-band Index (Mₛ−1) for Layer Index (0).
Sub-band Index (0), Sub-band Index (1), . . . , Sub-band Index (Mₛ−1) for Layer Index (1).
. . .
Sub-band Index (0), Sub-band Index (1), . . . , Sub-band Index (Mₛ−1) for Layer Index (Lₛ−1).
S(0), S(1), . . . , S(N−1) according to the order of respective signaled sub-band indices in layer indices. Wherein, S(0), S(1), . . . , S(N−1) can be differential or absolute mentioned herein.

In one example, the mapping order of the fields in the report can be:
Layer Index (0), Sub-band Index (0), Sub-band Index (1), . . . , Sub-band Index (Mₛ−1), S(0), S(1), . . . , S(Mₛ−1) for Layer Index (0).
Layer Index (1), Sub-band Index (0), Sub-band Index (1), . . . , Sub-band Index (Mₛ−1), S(0), S(1), . . . , S(Mₛ−1) for Layer Index (1).
. . .
Layer Index (Lₛ−1), Sub-band Index (0), Sub-band Index (1), . . . , Sub-band Index (Mₛ−1), S(0), S(1), . . . , S(Mₛ−1) for Layer Index (Lₛ−1).
Wherein, S(0), S(1), . . . , S(N−1) can be differential or absolute mentioned herein.

In one example, the mapping order of the fields in the report can be:
Sub-band Index (0), Layer Index (0), Layer Index (1), . . . , Layer Index (Lₛ−1) for Sub-band Index (0).
Sub-band Index (1), Layer Index (0), Layer d Index (1), . . . , Layer Index (Lₛ−1) for Sub-band Index (1).
. . .
Sub-band Index (Mₛ−1), Layer Index (0), Layer Index (1), . . . , Layer Index (Lₛ−1) for Sub-band Index (Mₛ−1).

S(0), S(1), . . . , S(N−1) according to the order of respective signaled layer indices in sub-band indices. Wherein, S(0), S(1), . . . , S(N−1) can be differential or absolute mentioned herein.

In one example, the mapping order of the fields in the report can be:
Sub-band Index (0), Sub-band Index (1), . . . , Sub-band Index (Mₛ−1)
Layer Index (0), Layer Index (1), . . . , Layer Index (Lₛ−1) for Sub-band Index (0).
Layer Index (0), Layer Index (1), . . . , Layer Index (Lₛ−1) for Sub-band Index (1).
. . .
Layer Index (0), Layer Index (1), . . . , Layer Index (Lₛ−1) for Sub-band Index (Mₛ−1).
S(0), S(1), . . . , S(N−1) according to the order of respective signaled layer indices in sub-band indices. Wherein, S(0), S(1), . . . , S(N−1) can be differential or absolute mentioned herein.

In one example, the mapping order of the fields in the report can be:
Sub-band Index (0), Layer Index (0), Layer Index (1), . . . , Layer Index (Lₛ−1), S(0), S(1), . . . , S(Lₛ−1) for Sub-band Index (0).
Sub-band Index (1), Layer Index (0), Layer Index (1), . . . , Layer Index (Lₛ−1), S(0), S(1), . . . , S(Lₛ−1) for Sub-band Index (1).
. . .
Sub-band Index (Mₛ−1), Layer Index (0), Layer Index (1), . . . , Layer Index (Lₛ−1), S(0), S(1), . . . , S(Lₛ−1) for Sub-band Index (Mₛ−1).
Wherein, S(0), S(1), . . . , S(N−1) can be differential or absolute mentioned herein.

In the examples mentioned herein, Lₛ and/or Mₛ and/or N can be specified in the system specifications, or configured or updated by SIB and/or RRC and/or MAC CE and/or L1 control (e.g., DCI Format) signaling.

In the examples mentioned herein, the value of Lₛ and/or Mₛ and/or N can be included in the report. In one example, Lₛ and/or Mₛ and/or N can be included or signaled in a first part/stage report. In one example, the first part/stage includes information to determine the size of the second part/stage of the report. In one example, the first part/stage report includes the value Lₛ and/or Mₛ and/or N and N₁ of the N entries, wherein N₁ can be specified in the system specifications, or configured or updated by SIB and/or RRC and/or MAC CE and/or L1 control (e.g., DCI Format) signaling. In one example, the second part/stage report includes the remaining entries (e.g., N−N₁ entries). In one example, the second part/stage report includes N entries. In one example, N₁=0. In one example, N₁=1 (e.g., the entry with the largest value of S).

In one example, the first part/stage report includes the values Lₛ and/or Mₛ and/or N and Lₛ₁×Mₛ₁ of the N entries, wherein Lₛ₁ and/or Mₛ₁ can be specified in the system specifications, or configured or updated by SIB and/or RRC and/or MAC CE and/or L1 control (e.g., DCI Format) signaling. In one example, the second part/stage report includes the remaining entries (e.g., N−Lₛ₁×Mₛ₁ entries). In one example, the second part/stage report includes N entries. In one example, N=Lₛ×Mₛ.

In one example, the number of Sub-bands Mₛ reported for each layer can be different, e.g., Mₛ(l) depends on the layer index, l, where l=0, 1, . . . . Lₛ−1. In one example, the total number of S values reported can be given by

$$N = {\sum }_{l = 0}^{{L}_{s} - 1} {M}_{s} ( l ) .$$

In one example, the first part/stage includes the values Lₛ and N. In one example, the first part/stage includes information to determine the size of the second part/stage of the report. In one example, first part/stage can include Lₛ and Mₛ(l) for l=0, 1, . . . , Lₛ−1. In one example, first part/stage can include values Lₛ, N and Mₛ(l) for l=0, 1, . . . , Lₛ₁−1, and second part/stage includes the remaining Mₛ(l) values, or the Mₛ(l) values. Wherein Lₛ₁ can be specified in the system specifications, or configured or updated by SIB and/or RRC and/or MAC CE and/or L1 control (e.g., DCI Format) signaling. In one example, the first part/stage can include N₁ of the N entries, wherein N₁ can be specified in the system specifications, or configured or updated by SIB and/or RRC and/or MAC CE and/or L1 control (e.g., DCI Format) signaling. In one example, the second part/stage report includes the remaining entries (e.g., N−N₁ entries). In one example, the second part/stage report includes N entries. In one example, N₁=0. In one example, N₁=1 (e.g., the entry with the largest value of S).

In one example, the number of Layers Lₛ reported for each sub-band can be different, e.g., Lₛ(m) depends on the sub-band index, m, where m=0, 1, . . . . Mₛ−1. In one example, the total number of S values reported can be given by

$$N = {\sum }_{m = 0}^{{M}_{s} - 1} {L}_{s} ( m ) .$$

In one example, the first part/stage includes the values Mₛ and N. In one example, the first part/stage includes information to determine the size of the second part/stage of the report. In one example, first part/stage can include Mₛ and Lₛ(m) for m=0, 1, . . . , Mₛ−1. In one example, first part/stage can include values Mₛ, N and Lₛ(m) for m=0, 1, . . . , Mₛ₁−1, and second part/stage includes the remaining Lₛ(m) values, or the Lₛ(m) values. Wherein Mₛ₁ can be specified in the system specifications, or configured or updated by SIB and/or RRC and/or MAC CE and/or L1 control (e.g., DCI Format) signaling. In one example, the first part/stage can include N₁ of the N entries, wherein N₁ can be specified in the system specifications, or configured or updated by SIB and/or RRC and/or MAC CE and/or L1 control (e.g., DCI Format) signaling. In one example, the second part/stage report includes the remaining entries (e.g., N−N₁ entries). In one example, the second part/stage report includes N entries. In one example, N₁=0. In one example, N₁=1 (e.g., the entry with the largest value of S).

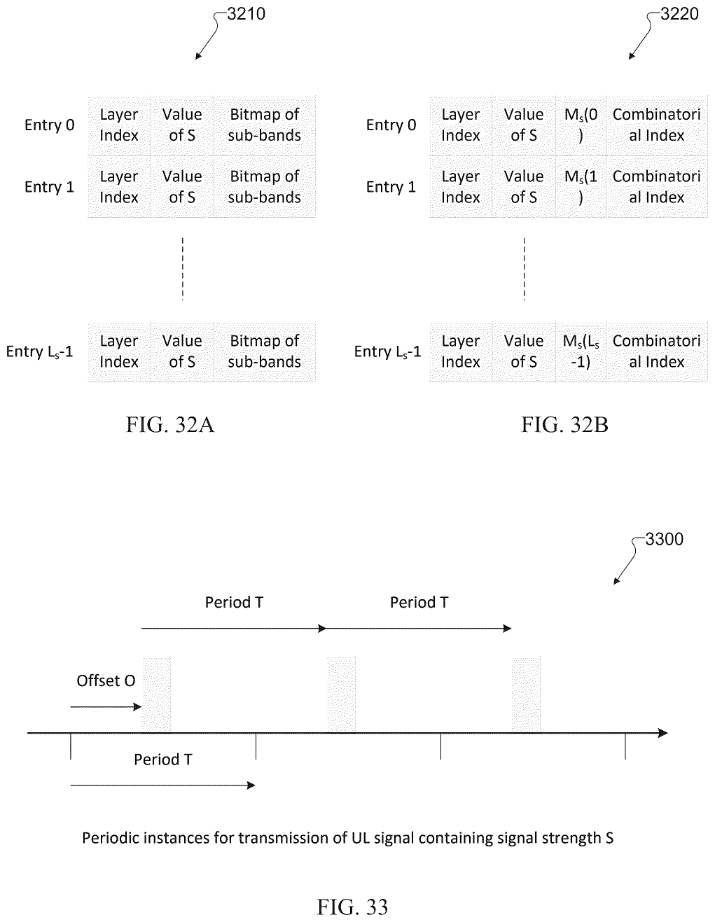

FIGS. 32A and 32B illustrate diagrams of example entries 3210 and 3220 according to embodiments of the present disclosure. For example, entries 3210 and 3220 can be utilized by any of the UEs 111-116 of FIG. 1, such as the UE 114. This example is for illustration only and other embodiments can be used without departing from the scope of the present disclosure.

In a variant example, the UE (e.g., the UE 116) can report the signal S for Lₛ (or up to Lₛ) layers, and indicates the best Mₛ sub-bands for each layer. In one example, the number of Mₛ sub-bands are the same across layers. In one example, the number of Mₛ(l) sub-bands depend on the layer (can change from one layer to the next), wherein l=0, 1, . . . , Lₛ−1. In one example, the indication of the Mₛ sub-bands is by a bitmap of size M as illustrated in FIG. 32(A), wherein the UE report can include a Layer Index, a value for signal S, and a bitmap for the Mₛ sub-bands per layer. In one example, the indication of the Mₛ(l) sub-bands is by a combinatorial index as illustrated in FIG. 32 (B), wherein the UE report can include a Layer Index, a value for signal S, and a value of Mₛ(l) and a combinatorial index to indicate Mₛ(l) sub-bands out of M sub-bands, wherein l=0, 1, . . . , Lₛ−1. In one example, the indication of the Mₛ sub-bands (the same number across Lₛ layers) is by a combinatorial index, wherein the UE report can include a value of Mₛ (common across layers) and a Layer Index and a value for signal S, and a combinatorial index to indicate Mₛ sub-bands out of M sub-bands for each layer. In one example, the Mₛ sub-bands are the same across Lₛ layers, and the indication is by a common bitmap for layers wherein the UE report can include a bitmap for the Mₛ sub-bands common to layers and layer index and a value for signal S per layer. In one example, the indication of the Mₛ sub-bands (the same across Lₛ layers) is by a combinatorial index, wherein the UE report can include a value of Mₛ and a combinatorial index to indicate Mₛ sub-bands out of M sub-bands (common across layers) and a layer index and a value for signal S per layer. In one example, the number of sub-bands Mₛ, is not indicated, rather, it is determined based on a rule (e.g., specified in the specifications), or configured by higher layers. In one example, the number of sub-bands Mₛ is configured or indicated to the UE, or is in a separate message from the UE, the report from the UE can include: combinatorial index (per layer or common across all layers) to indicate Mₛ sub-bands out of M sub-bands (common across layers) and a layer index and a value for signal S per layer. In one example, the number of layers in the report, Lₛ, can be specified in the system specifications, or configured or updated by SIB and/or RRC and/or MAC CE and/or L1 control (e.g., DCI Format) signaling.

Signal S can be according to the following examples:
In one example, the signal S for each Layer Index is an absolute value.
In one example, the signal S for the first Layer Index (Index 0) is an absolute value. The signal S for the remaining layers is a differential value. In one example, the differential value is relative to the first layer with Layer Index 0. In one example, the differential value is relative to previous layer. In one example, the differential value is in steps of d dB, as aforementioned, for example, d=2 dB.

In one example, the mapping order of the fields in the report can be: Layer Index (0), Layer Index (1), . . . , Layer Index (Lₛ−1), S(0), S(1), . . . , S(Lₛ−1), bitmap(0), bitmap(1), . . . , bitmap(Lₛ−1). Wherein, S(0), S(1), . . . , S(Lₛ−1) can be differential or absolute mentioned herein.

In one example, the mapping order of the fields in the report can be: Layer Index (0), S(0), bitmap(0), Layer Index (1), S(1), bitmap(1), S(1) . . . , Layer Index (Lₛ−1), S(Lₛ−1), bitmap(Lₛ−1). Wherein, S(0), S(1), . . . , S(Lₛ−1) can be differential or absolute mentioned herein.

In one example, the mapping order of the fields in the report can be: Layer Index (0), Layer Index (1), . . . , Layer Index (Lₛ−1), S(0), S(1), . . . , S(Lₛ−1), value of Mₛ(0), Combinatorial Index (0), value of Mₛ(1), Combinatorial Index (1), . . . , value of Mₛ(Lₛ−1), Combinatorial Index (Lₛ−1). Wherein, S(0), S(1), . . . , S(Lₛ−1) can be differential or absolute mentioned herein.

In one example, the mapping order of the fields in the report can be: Layer Index (0), S(0), value of Mₛ(0), Combinatorial Index (0), Layer Index (1), S(1), value of Mₛ(1), Combinatorial Index (1), . . . , Layer Index (Lₛ−1), S(Lₛ−1), value of Mₛ(Lₛ−1), Combinatorial Index (Lₛ−1). Wherein, S(0), S(1), . . . , S(Lₛ−1) can be differential or absolute as mentioned herein.

In one example, the mapping order of the fields in the report can be: value of Mₛ, Layer Index (0), Layer Index (1), . . . , Layer Index (Lₛ−1), S(0), S(1), . . . , S(Lₛ−1), Combinatorial Index (0), Combinatorial Index (1), . . . , Combinatorial Index (Lₛ−1). Wherein, S(0), S(1), . . . , S(Lₛ−1) can be differential or absolute as mentioned herein. In one example, Mₛ is not included in the report, but is included in a separate message from UE, or is configured or indicated to the UE.

In one example, the mapping order of the fields in the report can be: value of Mₛ, Layer Index (0), S(0), Combinatorial Index (0), Layer Index (1), S(1), Combinatorial Index (1), . . . , Layer Index (Lₛ−1), S(Lₛ−1), Combinatorial Index (Lₛ−1). Wherein, S(0), S(1), . . . , S(Lₛ−1) can be differential or absolute as mentioned herein. In one example, Mₛ is not included in the report, but is included in a separate message from UE, or is configured or indicated to the UE.

In one example, the mapping order of the fields in the report can be: bitmap indicating Mₛ of the M sub-bands common to layers, Layer Index (0), Layer Index (1), . . . , Layer Index (Lₛ−1), S(0), S(1), . . . , S(Lₛ−1). Wherein, S(0), S(1), . . . , S(Lₛ−1) can be differential or absolute as mentioned herein.

In one example, the mapping order of the fields in the report can be: bitmap indicating Mₛ of the M sub-bands common to layers, Layer Index (0), S(0), Layer Index (1), S(1), . . . , Layer Index (Lₛ−1), S(Lₛ−1). Wherein, S(0), S(1), . . . , S(Lₛ−1) can be differential or absolute as mentioned herein.

In one example, the mapping order of the fields in the report can be: value of Mₛ combinatorial index indicating Mₛ of the M sub-bands common to layers, Layer Index (0), Layer Index (1), . . . , Layer Index (Lₛ−1), S(0), S(1), . . . , S(Lₛ−1). Wherein, S(0), S(1), . . . , S(Lₛ−1) can be differential or absolute mentioned herein. In one example, Mₛ is not included in the report, but is included in a separate message from UE, or is configured or indicated to the UE.

In one example, the mapping order of the fields in the report can be: value of Mₛ, combinatorial index indicating Mₛ of the M sub-bands common to layers, Layer Index (0), S(0), Layer Index (1), S(1), . . . , Layer Index (Lₛ−1), S(Lₛ−1). Wherein, S(0), S(1), . . . , S(Lₛ−1) can be differential or absolute mentioned herein. In one example, Mₛ is not included in the report, but is included in a separate message from UE, or is configured or indicated to the UE.

In another example, a second set of sub-bands (e.g., Mₛ₂, or Mₛ₂(l)) can be indicated, wherein the second set of sub-bands has a quality Δ worse than the first set of sub-bands. The indication of the second set of sub-bands can be by a bitmap or a combinatorial index. The quality Δ can be indicated in the report or can be configured and/or updated by SIB and/or RRC and MAC CE and/or L1 control (e.g., DCI Format) signal. This can be extended to a third, fourth, . . . sets of sub-bands.

In another example, a second set of sub-bands (e.g., Mₛ₂, or Mₛ₂(l)) and a corresponding second signal level S₂ per layer can be indicated, wherein the second set of sub-bands is associated with the second signal levels S₂. The indication of the second set of sub-bands can be by a bitmap or a combinatorial index. In one example the second signal level is an absolute value. In one example, the second signal levels is a differential value relative to the signal levels S per layer. This can be extended to a third, fourth, . . . sets of sub-bands and corresponding third, fourth signal levels.

FIG. 33 illustrates a timeline 3300 for UL transmission(s) according to embodiments of the present disclosure. For example, timeline 3300 can be followed by any of the UEs 111-116 of FIG. 1, such as the UE 113. This example is for illustration only and other embodiments can be used without departing from the scope of the present disclosure.

In one example, the UE report containing signal level (or strength) S is a periodic report as illustrated in FIG. 33. The network (e.g., the network 130) can configure the UE with periodic resources, e.g., periodic resources for PUSCH or for PUCCH. For example, the configuration can include:
Time and frequency domain resources. Wherein, the time and frequency resources can include:
   A RB allocation. In one example, the RB allocation can be a bitmap of RBs or groups of RBs (RB groups) used for PUSCH or PUCCH. In one example, the RB allocation can be determined by a starting RB and/or ending RB and/or length (number) of RBs. In one example, the RB allocation can be provided by a resource indication value (RIV) providing a starting RB and a length (or number) of RBs.
   Periodicity and offset, wherein the period can be in number of time units (e.g., slots or sub-frames or frames), and the offset is an offset of a time-unit (e.g., slot or sub-frame or frame) within the period. The offset can be provided by time-units (e.g., slots or sub-frames or frames). The periodicity and offset determine the allocation of multiple instances repeated periodically. In one example, the time-unit for periodicity and offset at the same. In one example, the time-unit for periodicity and offset can be different.
   Allocation within a time-unit (e.g., slot or sub-frame or frame). In one example, the allocation can be a bitmap of symbols or groups of symbols (symbol groups) used for PUSCH or PUCCH in the time unit. In one example, the allocation can be determined by a starting symbol and/or ending symbol and/or length (number) of symbols within the time unit. In one example, the allocation can be provided by a start length indicator value (SLIV) providing a starting symbol and a length (or number) of symbols.
   In one example, the UE can be configured multiple time-frequency resources for each instance, the UE selects a resource from the multiple resources based on the amount of data the UE has to transmit.
Channel coding parameters. Wherein, the channel coding parameters can include:
   Modulation coding scheme (MCS)
   Number of layers. In one example, the number of layers is one. In one example, the number of layers can be more than one.

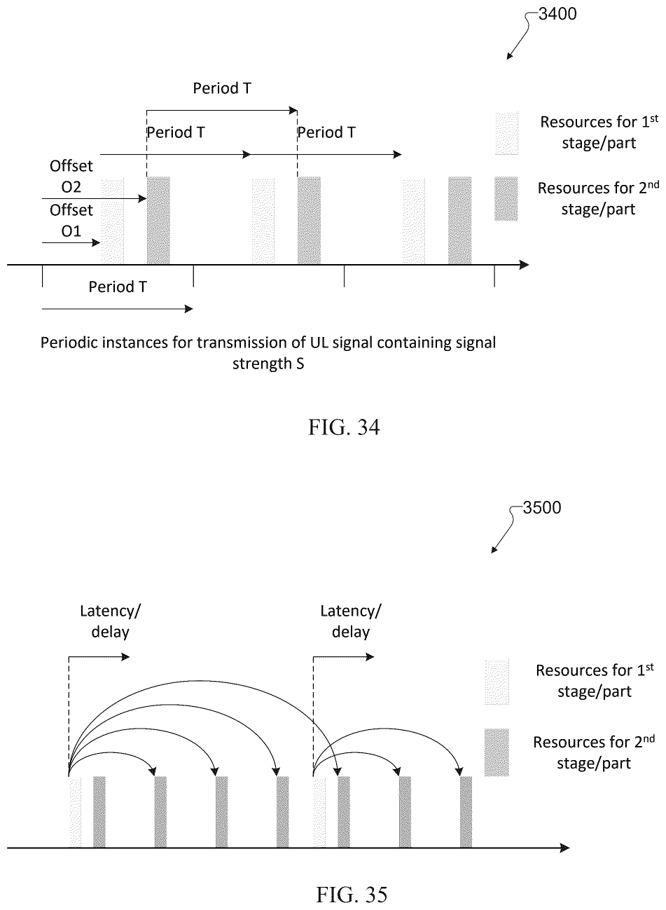

FIG. 34 illustrates a timeline 3400 for UL transmission(s) according to embodiments of the present disclosure. For example, timeline 3400 can be followed by any of the UEs 111-116 of FIG. 1, such as the UE 112. This example is for illustration only and other embodiments can be used without departing from the scope of the present disclosure.

In one example, the UE report containing signal level (or strength) S is a periodic report as illustrated in FIG. 34. In one example, if the UE has a report to send in an instance, the UE sends the report. In one example, if the UE has no report to send in an instance, the instance is not used by the UE. In one example, the availability of a report to send is determined based on the change in S. In one example, if S has changed since the last transmitted value, or if S has changed since the last transmitted value by a value greater than or greater than or equal to a threshold, a report is generated, else if there is no change in S, or a small change in S less than or less than or equal to a threshold, no report is generated. In one example, if S is more or less than a threshold the report can be sent.

FIG. 35 illustrates example resource periodicities for first stage/part resource and for second stage/part resource 3500 according to embodiments of the present disclosure. For example, any of the UEs 111-116 of FIG. 1 can be configured with resource periodicities 3500. This example is for illustration only and other embodiments can be used without departing from the scope of the present disclosure.

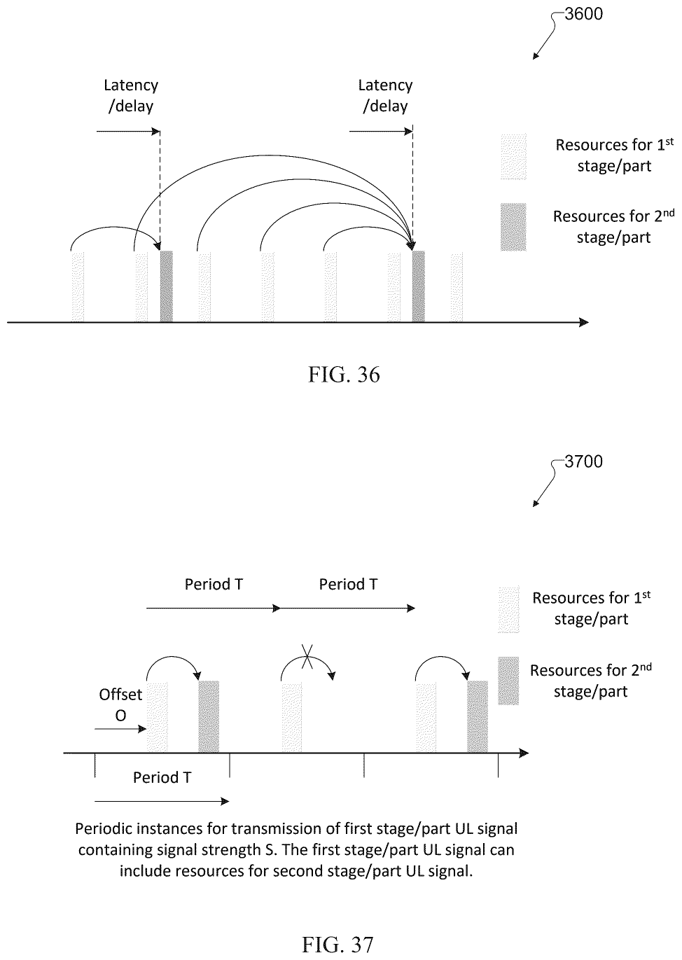

FIG. 36 illustrates example resource periodicities for first stage/part resource and for second stage/part resource 3600 according to embodiments of the present disclosure. For example, any of the UEs 111-116 of FIG. 1, such as the UE 116, can be configured with resource periodicities 3600. This example is for illustration only and other embodiments can be used without departing from the scope of the present disclosure.

In one example, the UE report containing signal level (or strength) S is a periodic report and is a two-stage or two-part report. In one example, network can configure the UE with two sets of a periodic resources, wherein the first set of periodic resources is for the first stage or first part, and the second set of periodic resources is for the second stage or second part. In one example, the periodicity of the first stage/part and second stage/part are equal as illustrated in FIG. 34. In one example, the periodicity of the first stage/part and second stage/part can be different. In one example, the period of the first stage/part is an integer multiple of the period of the second stage/part as illustrated in FIG. 35, in one example an instance of a second stage/part is associated with an instance of a first stage part subject to a minimum latency or delay (e.g., for processing), in one example, there is no minimum latency or delay, e.g., minimum latency of delay is zero. In one example, the period of the second stage/part is an integer multiple of the period of the first stage/part as illustrated in FIG. 36, in one example an instance of a second stage/part is associated with an instance of a first stage part subject to a minimum latency or delay (e.g., for processing), in one example, there is no minimum latency or delay, e.g., minimum latency of delay is zero. In one example, multiple resources for each instance are configured for the second stage/part and the first stage/part indicates which resource of the multiple resources is used for the second stage/part.

FIG. 37 illustrates a timeline 3700 for UL transmission(s) according to embodiments of the present disclosure. For example, timeline 3700 can be followed by any of the UEs 111-116 of FIG. 1, such as the UE 111. This example is for illustration only and other embodiments can be used without departing from the scope of the present disclosure.

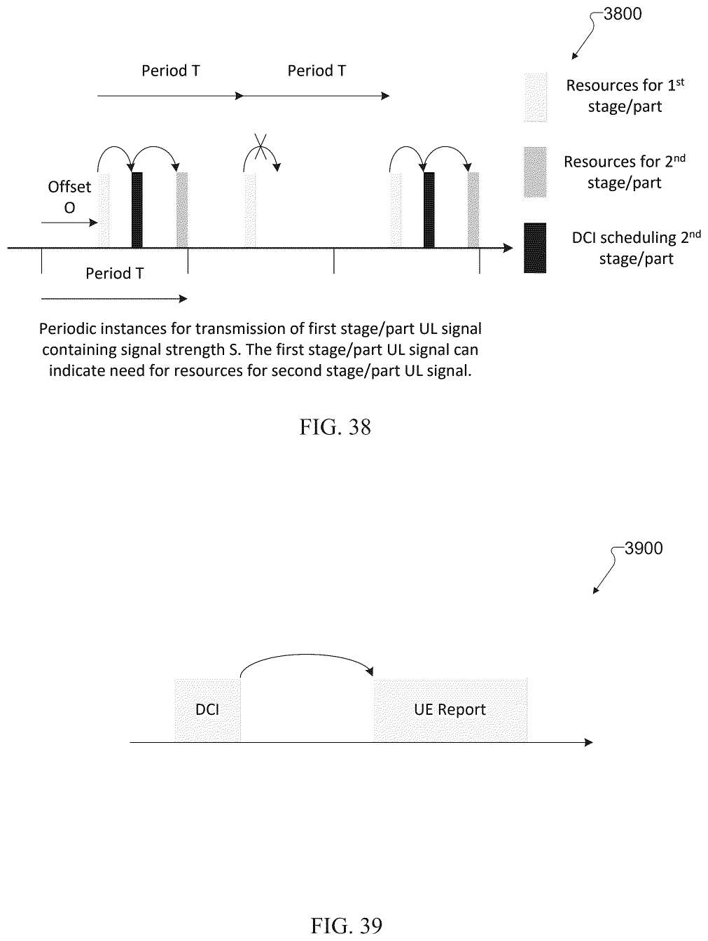

FIG. 38 illustrates a timeline 3800 for UL transmission(s) according to embodiments of the present disclosure. For example, timeline 3800 can be followed by the UE 116 of FIG. 3. This example is for illustration only and other embodiments can be used without departing from the scope of the present disclosure.

In one example, the UE report containing signal level (or strength) S is a periodic report and is a two-stage or two-part report. In one example, network can configure the UE with periodic resources for the first stage or first part. In one example, the first stage/part indicates the resource used for a corresponding second stage/part as illustrate in FIG. 37, in one example, some instances of the first stage/part can indicate no second stage/part as illustrated in FIG. 37. In one example, in response to the first stage/part, the network can schedule or indicate a resource for the second stage part (e.g., through a DCI format) as illustrated in FIG. 38, in one example, some instances of the first stage/part can indicate no second stage/part as illustrated in FIG. 38, in one example, in response to some instances of the first stage/part, the network can determine not to schedule resources for second stage/part. In one example, the first stage/part is an indicator (e.g., one-bit) for the second stage/part. In one example, the first stage/part provides information about the size of the second stage/part (e.g., multi-bit).

In one example, the UE report containing signal level (or strength) S is a semi-persistent report. The network can activate or deactivate a semi-persistent report. Before activation or after deactivation and before next activation of the semi-persistent report by the network, there is no transmission from of the UE report containing signal level (or strength) S from the UE. After activation and before deactivation of the semi-persistent report by the network, the UE can transmit a periodic report. The examples mentioned herein of periodic report apply to the semi-persistent report after activation of the semi-persistent report.

In one example, for semi-persistent report, the activation or deactivation of the semi-persistent report can be by MAC CE signaling. In one example, for semi-persistent report, the activation or deactivation of the semi-persistent report can be by L1 control (e.g., DCI Format) signaling.

In one example, for semi-persistent report, the periodicity of the UE report and/or the periodicity of the first part/stage UE report and/or the periodicity of the second part/stage UE report can be configured or updated by higher layer (e.g., RRC or SIB) signaling. In one example, for semi-persistent report, the periodicity of the UE report and/or the periodicity of the first part/stage UE report and/or the periodicity of the second part/stage UE report can be configured or updated by the activation message. In one example, for semi-persistent report, the periodicity of the UE report and/or the periodicity of the first part/stage UE report and/or the periodicity of the second part/stage UE report can be configured or updated by the deactivation message.

In one example, for semi-persistent report, the offset of the UE report and/or the offset of the first part/stage UE report and/or the offset of the second part/stage UE report can be configured or updated by higher layer (e.g., RRC or SIB) signaling. In one example, for semi-persistent report, the offset of the UE report and/or the offset of the first part/stage UE report and/or the offset of the second part/stage UE report can be configured or updated by the activation message. In one example, for semi-persistent report, the offset of the UE report and/or the offset of the first part/stage UE report and/or the offset of the second part/stage UE report can be configured or updated by the deactivation message.

FIG. 39 illustrates an example UE report 3900 according to embodiments of the present disclosure. For example, report 3900 can be reported by any of the UEs 111-116 of FIG. 1. This example is for illustration only and other embodiments can be used without departing from the scope of the present disclosure.

In one example, the UE report containing signal level (or strength) S is an aperiodic report as illustrated in FIG. 39. The network can schedule or indicate, e.g., by DCI Format, e.g., DCI Format 0_0 or DCI Format 0_1 or DCI Format 0_2 in NR, or DCI Format X in general where X is a format number that is used to schedule PUSCH, to the UE to transmit the UE report.

In one example, the DCI Format can indicate information for transmitting the UE report such as:
Time and frequency resource allocation. Wherein, the time and frequency resource allocation can include:
   A RB allocation. In one example, the RB allocation can be a bitmap of RBs or groups of RBs (RB groups) used for UL transmission. In one example, the RB allocation can be determined by a starting RB and/or ending RB and/or length (number) of RBs. In one example, the RB allocation can be provided by a resource indication value (RIV) providing a starting RB and a length (or number) of RBs.
   Offset between DCI and unit-time (e.g., slot or sub-frame or frame) used for UL transmission with UL report.
   Allocation within a time-unit (e.g., slot or sub-frame or frame). In one example, the allocation can be a bitmap of symbols or groups of symbols (symbol groups) used for UL transmission in the time unit. In one example, the allocation can be determined by a starting symbol and/or ending symbol and/or length (number) of symbols within the time unit. In one example, the allocation can be provided by a start length indicator value (SLIV) providing a starting symbol and a length (or number) of symbols.
   In one example, the UE can be configured multiple time-frequency resources, the UE selects a resource from the multiple resources based on the amount of data the UE has to transmit.
Channel coding parameters. Wherein, the channel coding parameters can include:
   Modulation coding scheme (MCS)
   Number of layers. In one example, the number of layers is one. In one example, the number of layers can be more than one.

In one example, the UE report containing signal S is included in one channel as shown in FIG. 39. In one example, the UE report containing signal S is included in one channel and includes one part or stage. In one example, the UE report containing signal S is included in one channel and includes two parts or stage, a first part/stage and a second part/stage and the first and second parts/stages are in a same channel. In one example, the DCI Format can include a flag indicting whether or not to transmit the UE report containing signal S. In one example, the DCI Format schedules UL transmission from UE (e.g., for UL shared channel) and can include a flag indicting whether or not to transmit the UE report containing signal S with the UL transmission.

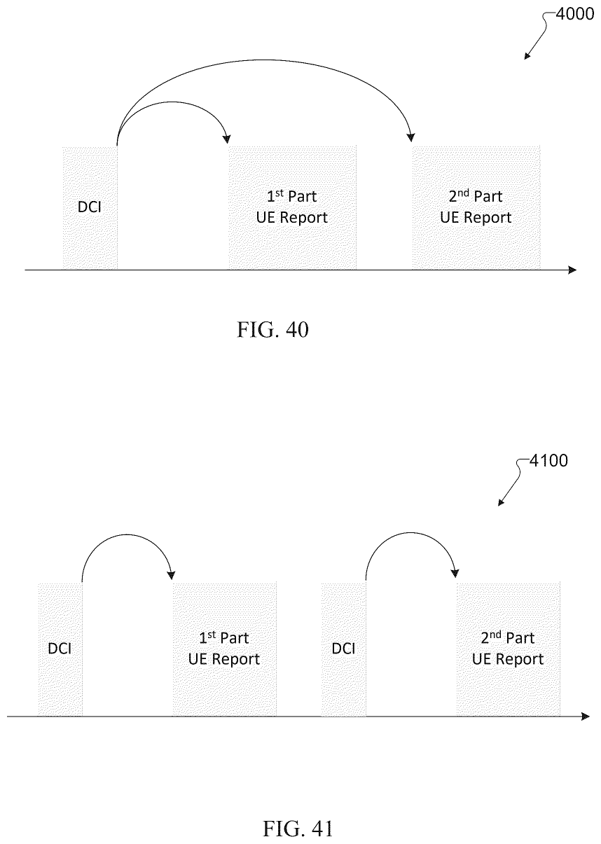

FIG. 40 illustrates an example two-part UE report 4000 according to embodiments of the present disclosure. For example, report 4000 can be reported by any of the UEs 111-116 of FIG. 1, such as the UE 111. This example is for illustration only and other embodiments can be used without departing from the scope of the present disclosure.

In one example, a DCI Format can schedule or allocate resources for two UL transmissions (e.g., two channels) as illustrated in FIG. 40. A first channel can include a first part/stage of UE report. A second channel can include a second part/stage of a UE report. In one example, the first channel can additionally include UL-SCH. In one example, the second channel can additionally include UL-SCH. In one example, the DCI Format can include a flag indicting whether or not to transmit the UE report containing signal S. In one example, the DCI Format can include a flag indicting whether to transmit the UE report using one channel or using two channels.

In one example, the DCI Format can indicate information for transmitting the UE report such as:
Time and frequency resource allocation for first channel and second channel. Wherein, the time and frequency resource allocation can include:
   A RB allocation for first channel and for second channel. In one example, the RB allocation is the same for the first channel and the second channel and one RB allocation is used for first channel and second channel. In one example, the RB allocation can be different for the first channel and the second channel, and two RB allocations are used for first channel and second channel respectively. In one example, the RB allocation can be a bitmap of RBs or groups of RBs (RB groups) used for UL transmission. In one example, the RB allocation can be determined by a starting RB and/or ending RB and/or length (number) of RBs. In one example, the RB allocation can be provided by a resource indication value (RIV) providing a starting RB and a length (or number) of RBs.
   Offset between DCI and unit-time (e.g., symbol or slot or sub-frame or frame) used for UL transmission with UL report for first channel and for second channel.
   Allocation within a time-unit (e.g., slot or sub-frame or frame) for first channel and for second channel. In one example, the time allocation is the same for the first channel and the second channel and one time allocation is used for first channel and second channel. In one example, the time allocation can be different for the first channel and the second channel, and two time allocations are used for first channel and second channel respectively. In one example, the allocation can be a bitmap of symbols or groups of symbols (symbol groups) used for UL transmission in the time unit. In one example, the allocation can be determined by a starting symbol and/or ending symbol and/or length (number) of symbols within the time unit. In one example, the allocation can be provided by a start length indicator value (SLIV) providing a starting symbol and a length (or number) of symbols.
   In one example, the UE can be configured multiple time-frequency resources (e.g., for second channel), the UE selects a resource from the multiple resources based on the amount of data the UE has to transmit. In one example, the UE can indicate the resource used for the second channel in the first channel.
Channel coding parameters for first channel and for second channel. In one example, the channel coding parameters are the same for the first channel and the second channel and channel coding parameters are used for first channel and second channel. In one example, the channel coding parameters can be different for the first channel and the second channel, and two channel coding parameters are used for first channel and second channel respectively. Wherein, the channel coding parameters can include:
   Modulation coding scheme (MCS)
   Number of layers. In one example, the number of layers is one. In one example, the number of layers can be more than one.

FIG. 41 illustrates an example two-part UE report 4100 according to embodiments of the present disclosure. For example, report 4100 can be reported by any of the UEs 111-116 of FIG. 1, such as the UE 113. This example is for illustration only and other embodiments can be used without departing from the scope of the present disclosure.

In one example, two DCI formats for used for the transmission of a first channel and a second channel respectively as illustrated in FIG. 41. In one example, a gNB (e.g., the BS 102) transmits a first DCI format indicating a first part/stage of a UE report. After receiving the first part/stage UE report, the gNB sends a second DCI Format indicating a second part/stage UE report.

In one example, a first channel including the first part/stage UE report can additionally include UL-SCH. In one example, a second channel including a second part/stage UE report can additionally include UL-SCH. In one example, the DCI Format can include a flag indicting whether or not to transmit the UE report containing signal S. In one example, the DCI Format can include a flag indicting whether to transmit a first part/stage UE report or a second part stage UE report. In one example, the DCI Format can include a flag indicting whether to transmit no UE report or a first part/stage UE report or a second part stage UE report. In one example, the DCI Format can include a flag indicting whether to transmit no UE report or a single part/stage UE report or a first part/stage UE report (of a two-part/stage UE report) or a second part stage UE report (of a two-part/stage UE report).

Any of the above variation embodiments can be utilized independently or in combination with at least one other variation embodiment. The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE), comprising:
a transceiver configured to receive a configuration related to:
a channel state information reference signal (CSI-RS), and
a first measurement report; and
a processor operably coupled to the transceiver, the processor configured to:
measure the CSI-RS across N sub-bands, where N is a positive integer,
identify one or more layers for communication, and
determine the first measurement report, wherein:
the first measurement report includes at least one entry, and
an entry in the at least one entry includes (i) a layer index corresponding to a first reference signal received power (RSRP), (ii) a first set of sub-bands corresponding to the first RSRP, and (iii) the first RSRP, and
wherein the transceiver is further configured to transmit the first measurement report.

2. The UE of claim 1, wherein:
the first set of sub-bands are indicated as a bitmap,
each bit in the bitmap corresponds to each of the N sub-bands, and
the processor is further configured to, for a sub-band from the first set of sub-bands belonging to a first set, set on a bit corresponding to the sub-band to “1”.

3. The UE of claim 1, wherein the first set of sub-bands is encoded using a combinatorial index that represents a selection of M sub-bands from the N sub-bands.

4. The UE of claim 1, wherein:
the transceiver is further configured to receive a number of layers (Ls) to include in the first measurement report,
the first measurement report includes Ls entries,
a first entry has a largest RSRP, and
a RSRP of subsequent entries is a differential RSRP relative to the first RSRP of the first entry in steps of Δ decibel (dBs).

5. The UE of claim 1, wherein the entry for the layer index includes a second RSRP and a corresponding second set of sub-bands.

6. The UE of claim 1, wherein:
the transceiver is further configured to
transmit a first sounding reference signal (SRS) on K antenna ports, and
receive a second measurement report corresponding to the first SRS,
the processor is further configured to determine compensation coefficients for a second SRS based on the measurement of the CSI-RS and the second measurement report, and
the transceiver is further configured to transmit the second SRS on the K antenna ports after applying the compensation coefficients.

7. The UE of claim 6, wherein:
the second measurement report includes a list of K RSRPs corresponding to K SRS antenna ports,
a first RSRP in the second measurement report is a largest of the K RSRPs, and
remaining RSRPs are differential RSRPs relative to the first RSRP in steps of Δ decibels (dBs).

8. A base station (BS), comprising:
a processor; and
a transceiver operably coupled to the transceiver, the processor configured to:
transmit a configuration related to:
a channel state information reference signal (CSI-RS), and
a first measurement report, and
receive the first measurement report,
wherein the first measurement report includes at least one entry based on measurement of CSI-RS across N sub-bands, where N is a positive integer, and
wherein an entry in the at least one entry includes (i) a layer index corresponding to a first reference signal received power (RSRP), (ii) a first set of sub-bands corresponding to the first RSRP, and (iii) the first RSRP.

9. The BS of claim 8, wherein:
the first set of sub-bands are indicated as a bitmap,
each bit in the bitmap corresponds to each of the N sub-bands, and
a processor is further configured to determine that a sub-band from the first set of sub-bands belong to a first set based on a bit corresponding to the sub-band having a value of “1”.

10. The BS of claim 8, wherein the first set of sub-bands is encoded using a combinatorial index that represents a selection of M sub-bands from the N sub-bands.

11. The BS of claim 8, wherein:
the transceiver is further configured to transmit a number of layers (Ls) to include in the first measurement report,
the first measurement report includes Ls entries,
a first entry has a largest RSRP, and
a RSRP of subsequent entries is a differential RSRP relative to the first RSRP of the first entry in steps of Δ decibels (dBs).

12. The BS of claim 8, wherein the entry for the layer index includes a second RSRP and a corresponding second set of sub-bands.

13. The BS of claim 8, wherein the transceiver is further configured to:
receive a first sounding reference signal (SRS) transmitted on K antenna ports,
transmit a second measurement report corresponding to the first SRS for determining compensation coefficients for a second SRS, and
receive the second SRS transmitted on the K antenna ports.

14. The BS of claim 13, wherein:
the second measurement report includes a list of K RSRPs corresponding to K SRS antenna ports,
a first RSRP in the second measurement report is a largest of the K RSRPs, and
a remaining RSRPs are differential RSRPs relative to the first RSRP in steps of Δ decibels (dBs).

15. A method of operating a user equipment (UE), the method comprising:
receiving a configuration related to:
a channel state information reference signal (CSI-RS), and
a first measurement report;
measuring the CSI-RS across N sub-bands, where N is a positive integer;
identifying one or more layers for communication;
determining the first measurement report, wherein:
the first measurement report includes at least one entry, and
an entry in the at least one entry includes (i) a layer index corresponding to a first reference signal received power (RSRP), (ii) a first set of sub-bands corresponding to the first RSRP, and (iii) the first RSRP; and
transmitting the first measurement report.

16. The method of claim 15, wherein:
the first set of sub-bands are indicated as a bitmap,
each bit in the bitmap corresponds to each of the N sub-bands, and
the method further comprises, for a sub-band from the first set of sub-bands belonging to a first set based, setting a bit corresponding to the sub-band to “1”.

17. The method of claim 15, wherein the first set of sub-bands is encoded using a combinatorial index that represents a selection of M sub-bands from the N sub-bands.

18. The method of claim 15, further comprising:
receiving a number of layers (Ls) to include in the first measurement report,
wherein the first measurement report includes Ls entries,
wherein a first entry has a largest RSRP, and
wherein a RSRP of subsequent entries is a differential RSRP relative to the first RSRP of the first entry in steps of Δ decibels (dBs).

19. The method of claim 15, wherein the entry for the layer index includes a second RSRP and a corresponding second set of sub-bands.

20. The method of claim 15, further comprising:
transmitting a first sounding reference signal (SRS) on K antenna ports;
receiving a second measurement report corresponding to the first SRS;
determining compensation coefficients for a second SRS based on the measurement of the CSI-RS and the second measurement report; and
transmitting the second SRS on the K antenna ports after applying the compensation coefficients,
wherein the second measurement report includes a list of K RSRPs correspond to K SRS antenna ports,
wherein a first RSRP in the second measurement report is a largest of the K RSRPs, and
wherein remaining RSRPs are differential RSRPs relative to the first RSRP in steps of A decibels (dBs).
